(19) United States
(12) Patent Application Publication
(10) Pub. No.: US 2022/0010134 A1
(43) Pub. Date: Jan. 13, 2022

(54) COLORIZED ARTICLES FOR USE WITH 5G RADIO WAVES

(71) Applicant: INV Nylon Chemicals Americas, LLC, Wilmington, DE (US)

(72) Inventors: Nancy Elizabeth Allen, Columbia, SC (US); John F. Buzinkai, Chattanooga, TN (US); Alexander L. Gulledge, Columbia, SC (US); Benjamin D. Herzog, Wichita, KS (US); Isaac K. Iverson, Wichita, KS (US); Chee Sern Lim, Kennesaw, GA (US); James M. Shurish, Casco, MI (US)

(21) Appl. No.: 17/469,753

(22) Filed: Sep. 8, 2021

Related U.S. Application Data
(63) Continuation-in-part of application No. 17/221,519, filed on Apr. 2, 2021.
Application No. 17/221,519 is a continuation of application No. PCT/IB2021/052093, filed on Mar. 12, 2021.
(60) Provisional application No. 63/142,081, filed on Jan. 27, 2021.
(60) Provisional application No. 63/154,035, filed on Feb. 26, 2021.
(60) Provisional application No. 62/989,105, filed on Mar. 13, 2020.

(51) Int. Cl. C08L 77/06; H04B 7/145; C08L 77/02; C08J 5/04; C09D 177/02; C09D 177/06; C09D 7/41

(52) U.S. Cl. CPC C08L 77/06; H04B 7/145; C08L 77/02; C08J 5/043; C09D 177/02; C08J 2377/06; C09D 7/41; C08L 2203/20; C08L 2205/025; C08L 2203/30; C08J 2377/02; C09D 177/06

(57) ABSTRACT

The present disclosure relates to articles for transmitting and/or receiving radio waves therethrough having a frequency in the range of 0.5 GHz to 81 GHz. The recyclable articles include a thermoplastic resin including a polyamide and provide low signal attenuation of the radio waves transmitted or received therethrough. The article can include a colorant dispersed in the thermoplastic resin, wherein the colorant is substantially free of metals and metal-containing compounds; the article can include a paint, ink, or colored coating on an exterior thereof, wherein the paint, ink, and colored coating are substantially free of metals and metal-containing compounds; or a combination thereof.

### CROSS REFERENCE TO RELATED APPLICATIONS

This application is a continuation-in-part application of U.S. application Ser. No. 17/221,519, filed on Apr. 2, 2021, which is a continuation of International PCT Application No. PCT/IB2021/052093, filed on Mar. 12, 2021, which claims priority to U.S. Provisional Application No. 63/142,081, filed on Jan. 27, 2021, U.S. Provisional Application No. 63/154,035, filed on Feb. 26, 2021, and U.S. Provisional Application No. 62/989,105, filed on Mar. 13, 2020, all of which are hereby incorporated by reference in their entireties.

### FIELD

The present disclosure relates to thermoplastic resins and articles including the same suitable for transmitting and/or receiving radio waves therethrough having a frequency in the range of 0.5 GHz to 81 GHz.

### BACKGROUND

World-wide communications technology advancements are heading towards faster more reliable and affordable products and services. Technologies such as 4G LTE and 5G (abbreviated for the 5th Generation of mobile device communication) have been evolving to cater to the needs of the global consumer base.

In recent years, 5G wireless communication technology, in particular, is advancing at a much faster pace. The 5G coverage can be separated into two regimes in the electromagnetic spectrum: i) millimeter waves (mmWave), and ii) low-/mid-band. The mmWave technology uses frequencies in the 6-100 GHz range, for example, above 24-25 GHz, for example, in the range of 28-39 GHz, while the low-/mid-frequency band uses frequencies below 6 GHz.

One of the hurdles in mmWave 5G communication networks is that newer and more transmitters are required for proper functioning. This is due to its range being severely limited as compared to low and mid-band networks. Also, there is a problem of mmWave 5G radio waves transmitting through physical obstacles like buildings and structures. This would limit transmission range, which is undesirable for consumers adopting this technology.

Materials used in antenna concealment assemblies have generally been customized structures including fiberglass, fiberglass reinforced plastic (“FRP”), polyurethane foam, ABS plastic, other composite material, or combinations thereof. These materials have offered a reasonable degree of structural integrity and strength as well as a reasonable degree of radio frequency (RF) transparency for lower-frequency cellular applications. However, such customized structures and material choices are less feasible for higher-spectrum broadband and satellite applications due to extreme RF transparency requirements.

Approaches to developing low transmission loss materials have included Hitachi Chemical's low dielectric material, AS-400HS, which Hitachi reportedly offers improved electric properties and workability compared to polytetrafluoroethylene (PTFE) and aromatic liquid crystal polymers (LCP), examples of which can be found at New Low Transmission Loss Material for Millimeter-wave Radar Module “AS-400HS”, Hitachi Chemical Technical Report No. 58., Tanigawa et al. Additional approaches to developing low transmission loss materials have included low-density foam enclosures and panels such as those used with the RayCap INVISIWAVE™ product.

There remains a need to provide materials and articles including the same with suitably high transmissibility for 5G applications while at the same time providing structurally useful tensile strength, toughness, and improved durability.

Colorants for coloring polymers and for producing color in inks, paints, and colored coatings can cause 5G signal attenuation. While some 5G-compatible colorants are available, obtaining a full range of colors is not possible. There remains a need to provide colorized articles, including colorized articles having a full range of colors, including deep, rich colors, with suitably high transmissibility for 5G applications while at the same time providing structurally useful tensile strength, UV resistance, toughness, and improved durability.

### SUMMARY

The present disclosure provides an article for transmitting and/or receiving radio waves therethrough having a frequency in the range of 0.5 GHz to 81 GHz. The article includes a thermoplastic resin. The thermoplastic resin includes a first polyamide. The first polyamide includes nylon-6; nylon-6,6; a copolymer of nylon-6 or nylon-6,6 including at least one repeating unit that is poly(hexamethylene terephthalamide), poly(hexamethylene isophthalamide), or a copolymer of poly(hexamethylene terephthalamide) and poly(hexamethylene isophthalamide); a mixture thereof or a copolymer thereof. The thermoplastic resin also includes a second polyamide, an additive, or a mixture thereof. The additive can be selected from the group consisting of a reinforcing fiber, an ultraviolet resistance additive, a flame retardancy additive, an anti-static additive, an impact modifier, a colorant, a moisture repellant, and a mixture thereof. The article includes a colorant dispersed in the thermoplastic resin, wherein the colorant is substantially free of metals and metal-containing compounds; or the article includes a paint, ink, colored coating, or a combination thereof, on an exterior thereof, wherein the paint, ink, and colored coating is substantially free of metals and metal-containing compounds; or a combination thereof.

In various aspects, the article includes a colorant dispersed in the thermoplastic resin, wherein metals and metal-containing compounds are 0 wt % to 0.001 wt % of the colorant.

In various aspects, the article includes a paint, ink, colored coating, or a combination thereof, on an exterior thereof, wherein metals and metal-containing compounds are 0 wt % to 0.001 wt % of the paint, ink, and colored coating.

In various aspects, the article includes a colorant dispersed in the thermoplastic resin, wherein the colorant is substantially free of metals and metal-containing compounds. The article includes a paint, ink, colored coating, or a combination thereof, on an exterior thereof, wherein the paint, ink, and colored coating are substantially free of metals and metal-containing compounds. The colorant and the ink, paint, or colored coating have the same general class of color, wherein the general class of color includes red, orange, yellow, green, blue, cyan, indigo, violet, or black.

The present disclosure provides a system including the article described herein. The system also includes an antenna for transmitting and/or receiving radio waves having a frequency in the range of 0.5 GHz to 81 GHz.

The present disclosure provides a method of making the article described herein. The method includes injection molding, thermoforming, compression molding, or extruding the thermoplastic resin to form the article or one or more components thereof.

The present disclosure provides a method including transmitting and/or receiving radio waves having a frequency in the range of 0.5 GHz to 81 GHz through the article described herein.

There are many advantages and unexpected properties associated with the disclosed subject matter. For example, according to various aspects, articles including the presently claimed thermoplastic resin including polyamides such as nylon-6,6 and including a colorant, paint, ink, colored coating, or a combination thereof, are able to provide good mechanical strength, especially when glass fibers are included in the thermoplastic resin, while providing adequate mmWave transmissibility properties. The low mmWave signal attenuation of the articles is unexpected due to the hygroscopic nature of polyamides. The hygroscopic nature of polyamides has been thought to allow too much moisture uptake, which is thought to destroy transmissibility. However, the inventors have found that this is not the case.

The articles including the colorant, paint, ink, colored coating, or a combination thereof, can have lower mmWave attenuation than other colorized articles. The colorant, paint, ink, or colored coating can provide the articles with a wide variety of colors (e.g., a full range of colors), including deep, rich colors. The combination of a colorant in the thermoplastic resin with a paint, ink, and or colored coating on the exterior of the article can provide the article with scratch resistance while maintaining low 5G signal attenuation.

The high tensile strength, toughness, and durability of the articles including the thermoplastic resin and the colorant, paint, ink, colored coating, or a combination thereof, makes them ideal for structural applications and/or applications where low weight or low thickness is advantageous. The high strength, toughness, and durability of the thermoplastic resin allows the formation of hardware or structural components from the thermoplastic resin having dimensions that would have insufficient structural properties if made from other 5G-transparent materials. In addition, chemical or mechanical recycling of the thermoplastic resin composition and articles including the same can be facile.

### BRIEF DESCRIPTION OF THE FIGURES

The drawings illustrate generally, by way of example, but not by way of limitation, various aspects of the present invention.

FIG. 1 is a graph showing moisture gain data for 1.5 mm thick test specimen plaques measured according to the ISO 1110 Procedure, according to various examples of the present disclosure.

FIG. 2 is a graph showing moisture gain data for 3.0 mm thick test specimen plaques measured according to the ISO 1110 Procedure, according to various examples of the present disclosure.

FIGS. 3A, 4A, 5A, 6A, 7A, 8A, 9A, 10A, 11A, 12A, 13A, 14A, 15A, and 16A are graphs showing the transmission loss (S21 in dB on the Y-axis) and reflection (in dB) as a function of thickness (mm on the X-axis) for dry as molded (DAM) (or dry) specimens at two frequencies, according to various examples of the present disclosure.

FIGS. 3B, 4B, 5B, 6B, 7B, 8B, 9B, 10B, 11B, 12B, 13B, 14B, 15B, and 16B are graphs showing the transmission loss (S21 in dB on the Y-axis) and reflection (in dB) as a function of thickness (mm on the X-axis) for conditioned (or wet) specimens at two frequencies, according to various examples of the present disclosure.

FIGS. 17A and 17B represent a cyclone plot showing insertion loss (dB) data according to Example 18 of the present disclosure.

FIGS. 18A and 18B represent the array antenna data measured at three azimuths, 0°, 30°, and 60°, according to an aspect of the present disclosure.

FIG. 19 is a perspective view of a low transmission loss panel, according to various examples of the present disclosure.

FIG. 20 illustrates schematic representations of various panels or enclosures including windows according to Comparative Example 1 of the present disclosure.

FIG. 21 illustrates schematic representations of various panels windowless panels or enclosures according to Example 26 of the present disclosure.

FIG. 22 represents a cyclone plot showing insertion loss (dB) data according to an aspect of the present disclosure.

FIGS. 23A and 23B represent array antenna data measured at three azimuths, 0°, 30°, and 60°, according to Example 28 of the present disclosure.

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms “about” or “substantially” as used herein can allow for a degree of variability in a value or range, for example, within 20%, within 15%, within 10%, within 5%, or within 1% of a stated value or of a stated limit of a range, and includes the exact stated value or range.

The term “polyamide” as used herein refers to polymer having repeating units linked by amide bonds. Polyamides may arise from monomers including aliphatic, semi-aromatic or aromatic groups. Polyamide includes nylons, e.g., nylon-6,6 or nylon-6, and may refer to polyamides arising from a single monomer, two different monomers, or three or more different monomers. The term polyamide thus includes dimonomeric polyamides. The polyamide may be a nylon having as monomer units a dicarboxylic acid monomer unit and a diamine monomer unit. For example, if the dicarboxylic acid monomer unit is adipic acid and the diamine is hexamethylene diamine, the resulting polyamide can be nylon-6,6. Nylon-6 is a polyamide having a caprolactam monomer. The polyamide may be copolymers which may be prepared from aqueous solutions or blends of aqueous solutions that contain more than two monomers. In various aspects, polyamides can be manufactured by polymerization of dicarboxylic acid monomers and diamine monomers. In some cases, polyamides can be produced via polymerization of aminocarboxylic acids, aminonitriles, or lactams. Suitable polyamides include, but are not limited, to those polymerized from the monomer units described herein. The term “polyamide” includes polyamides such as PA6, PA66, PA11, PA12, PA612, Nylon-66/6T. However, this term can be modified, when done so expressly, to exclude particular polyamides. For example, in some aspects, the polyamide can be a polyamide other than PA11, PA12, and PA612; or the polyamide can be a polyamide other than Nylon-66/6T.

The term “N6,” “nylon-6,” or “PA6” as used herein, refers to a polymer synthesized by polycondensation of caprolactam. The polymer is also known as polyamide 6, nylon-6, and poly(caprolactam).

The term “N66,” “nylon-6,6,” or “PA66” as used herein, refers to a polymer synthesized by polycondensation of hexamethylenediamine (HMD) and adipic acid. The polymer is also known as Polyamide 66, nylon-66, nylon-6-6, and nylon-6/6.

The polymers described herein can terminate in any suitable way. In some aspects, the polymers can terminate with an end group that is independently chosen from a suitable polymerization initiator, —H, —OH, a substituted or unsubstituted (C1-C20)hydrocarbyl (e.g., (C1-C10)alkyl or (C6-C20)aryl) interrupted with 0, 1, 2, or 3 groups independently selected from —O—, substituted or unsubstituted —NH—, and —S—, a poly(substituted or unsubstituted (C1-C20)hydrocarbyloxy), and a poly(substituted or unsubstituted (C1-C20)hydrocarbylamino).

In the present disclosure, the terms “DAM” or “dry” refer to the dry-as-molded test specimens.

In the present disclosure, the terms “wet” or “cond” or “conditioned” refer to the conditioned test specimens.

The term “substantially uniform attenuation” means the reduction in signal strength across a sample of uniform thickness when an electromagnetic signal crosses the thickness of the sample in a direction normal to the surface of the sample.

The term “attenuation coefficient,” as used herein, refers to a calculated value for the measured wave attenuation (or loss) in decibels (dB) as the wave signal of a certain frequency (in GHz) passes through a medium of ca certain structural thickness (in cm). The unit of measure for the attenuation coefficient is dB/GHz·cm. As an illustration, attenuation coefficient value of 1.0 dB/GHz·cm means 1.0 dB of wave loss per 1 unit of GHz per 1 cm medium thickness.

The following applications are incorporated by reference in their entirety: U.S. application Ser. No. 17/221,519, filed on Apr. 2, 2021, International Application No. PCT/IB2021/052093, filed on Mar. 12, 2021, U.S. Provisional Application No. 62/989,105 filed on Mar. 13, 2020, U.S. Provisional Application No. 63/142,081, filed on Jan. 27, 2021, and U.S. Provisional Application No. 63/154,035, filed on Feb. 26, 2021.

### Article.

The present disclosure provides an article for transmitting and/or receiving radio waves therethrough having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). The article includes a thermoplastic resin. The thermoplastic resin includes a first polyamide that includes nylon-6; nylon-6,6; a copolymer of nylon-6 or nylon-6,6 including at least one repeating unit that is poly(hexamethylene terephthalamide), poly(hexamethylene isophthalamide), or a copolymer of poly(hexamethylene terephthalamide) and poly(hexamethylene isophthalamide); a mixture thereof or a copolymer thereof. The thermoplastic resin also includes a second polyamide, an additive, or a mixture thereof. The article includes a colorant dispersed in the thermoplastic resin, wherein the colorant is substantially free of metals and metal-containing compounds; or the article includes a paint, ink, colored coating, or a combination thereof, on an exterior thereof, wherein the paint, ink, and colored coating is substantially free of metals and metal-containing compounds; or a combination thereof.

Any suitable proportion of the article can be the thermoplastic resin. Substantially all of the article can be the thermoplastic resin, or 100 wt % of the article can be the thermoplastic resin. The thermoplastic resin can be 0.001 wt % to 100 wt % of the article, 50 wt % to 100 wt %, 90 wt % to 100 wt %, 0.001 wt % to 49.9 wt %, 0.001 wt % to 10 wt % of the article, or less than, equal to, or greater than 0.001 wt %, 0.01, 0.1, 0.5, 1, 2, 3, 4, 5, 10, 15, 20, 25, 30, 35, 40, 45, 50, 55, 60, 65, 70, 75, 80, 85, 90, 95, 96, 97, 98, 99, 99.5, 99.9, 99.99, or 99.999% of the article.

The article can be substantially free of materials (e.g., 0 wt %, or 0 wt % to 0.001 wt %) that cause the article to increase attenuation of radio waves at one or more frequencies in the range of 0.5 GHz to 81 GHz, as compared to the same region of the article without the material, or as compared to the same region of the thermoplastic resin without the material. Materials that cause the article (in regions including the material) to increase attenuation of radio waves at one or more frequencies in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof) as compared to the same region of the article without the material, or as compared to the same region of the thermoplastic resin without the material (such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20%), can be 0 wt % of the article, or 0 wt % to 0.001 wt % of the article, or any suitable wt % of the article that does not cause an increase in attenuation of the radio waves to climb above the desired maximum percentage. The article can be substantially free of metals or metal-containing compounds. Metals or metal-containing compounds can be 0 wt % of the article, or 0 wt % to 0.001 wt % of the article.

In various aspects of the article, the article can include one or more portions that include the thermoplastic resin or that are entirely the thermoplastic resin and one or more other portions that are substantially free of the thermoplastic resin (e.g., include 0 wt % thermoplastic resin, or that include 0 wt % to 0.001 wt % of the thermoplastic resin).

The article can be for use with communication devices, electronics, and/or electric power systems. For example, the article can be for use with stationary electronics installations, such as poles, buildings, roof-tops, and the like, or moving installations, such as vehicles, aircrafts, bicycles, boats, wearables, and the like. The articles may be designed according to the application specification in terms of the volume, weight, ease of access for maintenance/repairs, aesthetics (color, finish, appearance, and the like), or other criteria. The article can be for use with, electronic equipment such as AC or DC powered 5G mmWave and 4G radios, AC/DC rectifiers or remote powering units, fiber connectivity enclosures, radio-frequency combiners or diplexers, alarm systems and intrusion systems, AC and DC power distribution panels, 5G antennas, or 5G receivers.

The article can be a power cable termination component, an antenna enclosure, an antenna component, a cell phone casing, a cell phone casing component, an electronic component housing, a power transformer or power conditioner component or enclosure, an optical fiber component, a fiber termination box component or enclosure, a radio enclosure, a radio component, a diplexer/multiplexer component or enclosure, a coaxial cable component, a monocoque, a car unibody, or a combination thereof. The article can be an automotive wall, a building wall, a panel, a wall plate, a structural frame, a radome, a radome cover, a car unibody, a monocoque, or a combination thereof. The article can be an aircraft fuselage or a component thereof. The article can be a drone or remote-controlled (RC) aircraft fuselage, or a component thereof. The article can be a cell phone case, a cell phone protector, or a component thereof. The article can be an exterior-mounted vehicular decorative or structural component. The article can be an enclosure for electronic equipment, or a component of an enclosure for electronic equipment. The article can be a panel or can include a panel that includes the thermoplastic resin.

The article can be a structural article (e.g., for forming part of a building or vehicle). The article can be a wall, such as an automobile wall, a truck wall, or a building wall. The article can be an automobile skin or a truck skin. The wall can include one or more monolithic windowless panels that include the thermoplastic resin. The one or more panels can form a portion of a major face of the wall. The one or more panels can be electromagnetic windows in the wall that are translucent or opaque to visible light. The article can be the panel (e.g., a wall panel) or the article can be a wall that includes the panel.

The article can be a wall plate. A wall plate can be a planer or curved cover structure for functional and/or aesthetic applications. In some aspects, a wall plate can cover something to keep it out of sight. The article can be a structural frame, such as a window frame, a door frame, a vehicle frame, or any suitable structural frame. A window frame is a supporting frame for the glass of a window. A door frame is a supporting frame for a door. The article can be a vehicle frame or a component thereof, such as a car frame, a bus frame, an RV frame, or a truck frame.

The article can be an enclosure for protecting a radio antenna operating in the 0.5 GHz to 81 GHz frequency range. The article can fully or partially enclose the radio antenna.

The article can be a radome or a radome cover. A radome is a structural enclosure that can be weather resistant and that protects an antenna. A radome protects the antenna from weather and other external phenomena and conceals the antenna from view. The walls of the radome or radome cover can include the thermoplastic resin. The radome or radome cover can have uniform RF transmissibility throughout (e.g., transmissibility of radio waves having a frequency in the range of 0.5 GHz to 81 GHz, e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). In other aspects, the radome or radome cover can include one or more areas of non-uniform RF transmissibility. For example, the radome or radome cover can include variation in a thickness of the thermoplastic resin that corresponds with the non-uniform RF transmissibility of the radome or radome cover, or the radome or radome cover includes variation in composition of the thermoplastic resin that corresponds with the non-uniform RF transmissibility of the radome or radome cover, or a combination thereof. The radome or radome cover includes variation in a thickness of the thermoplastic resin that corresponds with the non-uniform RF transmissibility of the radome or radome cover (e.g., with or without variation of thickness). The radome or radome cover can include variation in composition of the thermoplastic resin that corresponds with the non-uniform RF transmissibility of the radome or radome cover (e.g., with or without variation of composition). The non-uniform RF transmissibility of the radome or radome cover can be effective for steering a beam of radio waves having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). The non-uniform RF transmissibility of the radome or radome cover can be effective to act as a lens for a beam of radio waves having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof).

The radome or radome cover can be configured such that heating of a wall of the radome or radome cover is effective to melt ice and/or evaporate water from a surface of the radome or radome cover. The heating of the wall can be configured to at least partially be provided by a radio transmitter (e.g., a 5G radio transmitter) enclosed within the radome or radome cover.

The article can be an exterior-mounted vehicular decorative or structural component. The vehicle can be a car, bus, truck, van, RV, motorcycle, bicycle, or scooter.

The article can be a fuselage for an aircraft, or a component thereof. The article can be a fuselage for a remote-controlled (RC) aircraft or drone, such as an unmanned aerial vehicle (UAV), or one or more components of such a fuselage.

The article can include a first plate of a first thickness and a second plate of a second thickness that each include the thermoplastic resin. The first plate and the second plate can attenuate electromagnetic signals having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof) the same or differently.

The article and/or thermoplastic resin can have a uniform thickness, or the article and/or thermoplastic resin can have a variable thickness. The article and/or thermoplastic resin can have a thickness in a range of from about 0.5 mm to about 6 mm, 1 mm to about 2 mm, or less than, equal to, or greater than about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.1, 4.2, 4.3, 4.5, 4.6, 4.7, 4.8, 4.9, 5.1, 5.2, 5.3, 5.4, 5.5, 5.6, 5.7, 5.8, or 5.9 mm, or 6 mm.

In various aspects, the article and/or thermoplastic resin can be weather-resistant. As used herein the term “weather resistant” refers to an article's ability to withstand reasonable exposure to the elements (e.g., sun, rain, wind, or combinations thereof) while substantially maintaining its structural integrity.

In various aspects the article can include a coating thereon. The article can include a flame-retardancy coating. The flame-retardancy coating and be sufficient (in addition to any optional flame-retardant additives present in the thermoplastic resin) to provide the article with a UL-94 test rating of V-0.

The article can be free of portions and windows for transmission of an electromagnetic signal having a frequency range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof) and that are free of the thermoplastic resin. In other aspects, the article can include portions or windows for transmission of an electromagnetic signal having a frequency range of 0.5 GHz to 81 GHz and that are free of the thermoplastic resin.

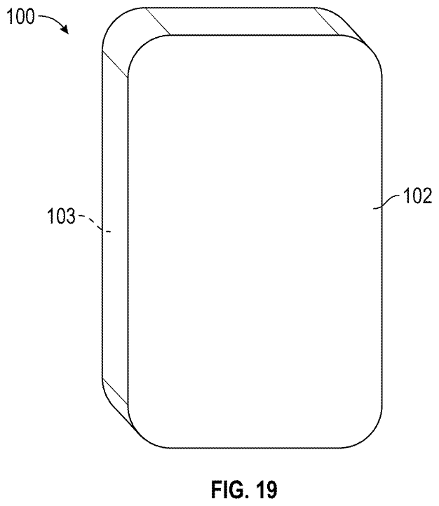

FIG. 19 shows an example of panel 100, according to the present disclosure. According to various aspects, an article can include a one or more of the panels, or can be formed from or include a plurality of joined panels 100.

The panel 100 made substantially (e.g., up to impurities or negligible structural features made from other materials) from a low transmission loss material, can take on many different forms. For example, the panel 100 can be configured to be a panel 100 for covering a transmissive element such as an antenna. In various aspects, the panel 100 can be all or part of an article, such as a molded article. The molded article, for example, can be an enclosure designed to cover the antenna or other transmissive element. Where present as part of an article, the panel 100 may be the only portion of the article that includes a low transmission loss material, or that includes the thermoplastic resin. Alternatively, in some aspects, the entire article can be formed of the same material as panel 100.

The panel can have any suitable dimensions. The panel can have a thickness in a range of from about 0.5 mm to about 6 mm, 1 mm to about 2 mm, or less than, equal to, or greater than about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.1, 4.2, 4.3, 4.5, 4.6, 4.7, 4.8, 4.9, 5.1, 5.2, 5.3, 5.4, 5.5, 5.6, 5.7, 5.8, or 5.9 mm, or 6 mm. FIG. 19 is a perspective view of an example of a panel 100. The thickness of the panel 100 is defined between opposed major surfaces 102 and 103. The surfaces 102 and 103 of the panel 100 can be, e.g., circular (or substantially circular, allowing for some deviation from a perfect circle) or otherwise rounded, or polygonal in shape. Examples of suitable polygonal shapes include a triangular shape (e.g., equilateral triangle, right triangle, obtuse triangle, an isosceles triangle, or acute triangle), a quadrilateral shape (e.g., a square or rectangle), a pentagonal shape, a hexagonal shape, a heptagonal shape, an octagonal shape, or any higher-order polygonal shape.

The opposed major surfaces 102 and 103 of the panel 100 can have a flat profile or a curved profile. The curved profile can include a single curve or a series of undulations. The curved profile can give the panel 100 a generally convex or concave shape. Respective adjacent undulations can be evenly spaced with respect to each other or unevenly spaced with respect to each other. Additionally, either of the opposed major surfaces 102 and 103 can include one or more projections such as a rib. Where present, a rib can be helpful to increase the strength of the panel 100. Each surface can be substantially smooth or textured. The opposed major surfaces can have the same profile or each major surface can have a different profile.

The article and/or portions of the article including the thermoplastic resin can have a substantially uniform signal attenuation of, when a direction of a signal impinging on the article and/or portions of the article including the thermoplastic resin is normal to a surface thereof, and wherein a thickness of the article and/or portions of the article including the thermoplastic resin is substantially uniform across an area where the signal impinges thereon: from 1 dB to 0 dB, or from 2 dB to 0 dB, or 0 dB, or less than or equal to 2 and greater than or equal to 0.1, 0.2, 0.3, 0.4, 0.5, 0.6, 0.7, 0.8, 0.9, 1, 1.1, 1.2, 1.3, 1.4, 1.5, 1.6, 1.7, 1.8, or 1.9 dB, for a signal of frequency 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). The article and/or portions of the article including the thermoplastic resin can have a substantially uniform signal attenuation of, when a direction of a signal impinging on the article and/or portions of the article including the thermoplastic resin is normal to a surface of the article, and wherein a thickness of the article is substantially uniform across an area where the signal impinges thereon: from 1 dB to 0 dB for signal of frequency 500 MHz to 6 GHz when a thickness is from 1.5 mm to 4 mm; from 1 dB to 0 dB for signal of frequency 24 GHz to 30 GHz when the thickness is from 2.5 mm to 4 mm; from 1 dB to 0 dB for signal of frequency 36 GHz to 40 GHz when the thickness is from 1.75 mm to 2.75 mm; from 1 dB to 0 dB for signal of frequency 76 GHz to 81 GHz when the thickness is from 1.75 mm to 2.75 mm; or a combination thereof.

The article can be characterized by its dielectric constant. For example, a dielectric constant of the article and/or portions of the article including the thermoplastic resin can be in a range of from about 2.50 to about 4.00 in the 3-40 GHz frequency range, about 2.75 to about 3, less than, equal to, or greater than about 2.50, 2.60, 2.70, 2.80, 2.90, 3.00, 3.10, 3.20, 3.30, 3.40, 3.50, 3.60, 3.70, 3.80, 3.90, or about 4.0. These values can be measured, e.g., using Active Standard Test Method (ASTM) D2520.

The article can be further characterized by its dissipation factor (DF), which can be in a range of about 0.004 to about 0.025, about 0.010 to about 0.020, less than, equal to, or greater than about 0.004, 0.006, 0.007, 0.008, 0.009, 0.010, 0.011, 0.012, 0.013, 0.014, 0.015, 0.016, 0.017, 0.018, 0.019, 0.020, 0.021, 0.022, 0.023, or 0.024 in the 3-40 GHz frequency range. These values can be measured, e.g., using ASTM D2520. An attenuation of the article and/or portions of the article including the thermoplastic resin can be from 1 dB to 0 dB for a signal of frequency 500 MHz to 6 GHz and a thickness from 0.5 mm to 6 mm, for a signal of frequency 24 GHz to 30 GHz and a thickness from 0.5 mm to 4.5 mm, for a signal of frequency 36 GHz to 40 GHz and a thickness from 0.5 mm to 4 mm, or for a signal of frequency 76 GHz to 81 GHz and a thickness from 0.5 mm to 3.5 mm.

When the frequency is 500 MHz to 6 GHz, signal impingement angle with the surface is 90±5°, and the desired attenuation is from 1 dB to 0 dB, then suitable thicknesses of the article and/or portions of the article including the thermoplastic resin can be between 0.5 mm and 6 mm. When the frequency is 24 GHz to 30 GHz, signal impingement angle with the surface is 90±5°, and the desired attenuation is from 1 dB to 0 dB, then suitable thicknesses of the article and/or portions of the article including the thermoplastic resin can be between 0.5 mm and 4.5 mm. When the frequency is 36 GHz to 40 GHz, signal impingement angle with the surface is 90±5°, and the desired attenuation is from 1 dB to 0 dB, then suitable thicknesses of the article and/or portions of the article including the thermoplastic resin can be between 0.5 mm and 4 mm. When the frequency is 76 GHz to 81 GHz, signal impingement angle with the surface is 90±5°, and the desired attenuation is from 1 dB to 0 dB, then suitable thicknesses of the article and/or portions of the article including the thermoplastic resin can be between 0.5 mm and 3.5 mm.

Colorant, Ink, Paint, and/or Colored Coating.

The article includes a colorant dispersed in the thermoplastic resin, wherein the colorant is substantially free of metals and metal-containing compounds; or the article includes a paint, ink, colored coating, or a combination thereof, on an exterior thereof, wherein the paint, ink, and colored coating is substantially free of metals and metal-containing compounds; or a combination thereof.

In various aspects, the article includes the colorant. The article can include the colorant alone with substantially no paint or ink or colored coating, can include the colorant and the ink, the colorant and the paint, the colorant and the colored coating, or can include a combination of the colorant, ink, paint, and the colored coating. The thermoplastic resin can include the colorant. The article can include one or more of the colorants. The colorant can be homogeneously distributed in the thermoplastic resin. The colorant can be any suitable proportion of the resin; for example, the colorant can be 0.001 wt % to 10 wt % of the thermoplastic resin, or 0.001 wt % to 5 wt %, or less than or equal to 10 wt % and equal to or greater than 0.001 wt %, 0.005, 0.01, 0.05, 0.1, 0.5, 1, 0.5, 2, 2.5, 3, 3.5, 4, 4.5, 5, 6, 7, 8, or 9 wt %.

The colorant can be a dye, a pigment, or a combination thereof. The colorant can include an organic colorant, an inorganic colorant, or a colorant that includes an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof. The colorant can include an organic colorant.

The colorant, article, and/or thermoplastic resin can be substantially free of inorganic compounds; for example, inorganic compounds can be 0 wt %, or 0 wt % to 0.001 wt %, of the colorant, article, and/or thermoplastic resin. The colorant, article, and/or thermoplastic resin can be substantially free of metal or metal-containing compounds; for example, metal or metal-containing compounds can be 0 wt %, or 0 wt % to 0.001 wt %, of the colorant, article, and/or thermoplastic resin. The colorant, article, and/or thermoplastic resin can be substantially free of colorants or other materials, or concentrations thereof, that increase attenuation of radio waves transmitted and/or received through regions of the article or thermoplastic resin including the colorant or other material and having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof), such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the same region of a corresponding article or thermoplastic resin that is free of the colorant or other material; for example, such colorants or other materials can be 0 wt % of the colorant, article, and/or thermoplastic resin, or 0 wt % to 0.001 wt %, or any suitable wt % of the colorant, article, and/or thermoplastic resin that does not cause an increase in attenuation of the radio waves to climb above the desired maximum percentage.

In various aspects, the article includes the ink on an exterior and/or interior surface thereof. The article can include the ink alone with substantially no colorant or paint or colored coating, can include the ink and the colorant, the ink and the paint, the ink and the colored coating, or can include a combination of the colorant, ink, paint, and the colored coating. The ink can form any suitable proportion of the article; for example, the ink can be 0.0001 wt % to 10 wt % of the article, 0.0001 wt % to 3 wt %, or less than or equal to 10 wt % and greater than or equal to 0.0001 wt %, 0.0005, 0.001, 0.005, 0.01, 0.05, 0.1, 0.5, 1, 1.5, 2, 2.5, 3, 3.5, 4, 4.5, 5, 6, 7, 8, or 9 wt % of the article.

The ink can include an ink colorant that provides the ink with a desired color. The ink can include one or more of the ink colorants. The ink colorant can include a dye, pigment, or a combination thereof. The ink colorant can include an organic colorant, an inorganic colorant, or a colorant that includes an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

The ink can be substantially free of inorganic compounds; for example, inorganic compounds can be 0 wt %, or 0 wt % to 0.001 wt %, of the ink. The ink can be substantially free of metal or metal-containing compounds; for example, metal or metal-containing compounds can be 0 wt %, or 0 wt % to 0.001 wt %, of the ink. The ink can be substantially free of colorants or other materials, or concentrations thereof, that increase attenuation of radio waves transmitted and/or received through the thermoplastic resin including the ink and having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof), such as that increase the attenuation in regions of the article including the ink by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the same regions of a corresponding article including the same ink but that is free of the colorant or other material; for example, such colorants or other materials can be 0 wt % of the ink, or 0 wt % to 0.001 wt %, or any suitable wt % of the ink that does not cause an increase in attenuation of the radio waves to climb above the desired maximum percentage. The article can be substantially free of inks that increase attenuation of radio waves transmitted and/or received through the thermoplastic resin including the ink and having a frequency in the range of 0.5 GHz to 81 GHz, such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the article that is free of the ink; for example, such colorants or other materials can be 0 wt % of the article, or 0 wt % to 0.001 wt %, or any suitable wt % of the article that does not cause an increase in the attenuation of the radio waves to climb above the desired maximum percentage.

The article can include a solid continuous coating of ink on a surface of the article. The article can include the ink in the form of a pattern or image on a surface of the article. Any suitable proportion of the surface area of the article can include the ink, such as 0.0001% to 100%, or 0%, or greater than, equal to, or less than 0.0001, 0.0005, 0.001, 0.005, 0.01, 0.05, 0.1, 0.5, 1, 2, 3, 4, 5, 10, 15, 20, 30, 40, 50, 60, 70, 80, 85, 90, 95, 96, 97, 98, 99, 99.9, 99.99, or 99.999% of the surface area of the article. The article can include a film on an exterior thereof, wherein the ink is between the film and the article; in such aspects, the ink can be applied to the article or the film prior to applying the film to the article. The ink can be applied in any suitable way, such as using a method including sublimation printing, inkjet printing, pad printing, screen-printing, or a combination thereof.

In various aspects, the article includes the paint on an exterior and/or interior surface thereof. The article can include the paint alone with substantially no colorant or ink or colored coating, can include the paint and the colorant, the paint and the ink, the paint and the colored coating, or can include a combination of the colorant, ink, paint, and the colored coating. The paint can form any suitable proportion of the article; for example, the paint can be 0.0001 wt % to 10 wt % of the article, 0.0001 wt % to 3 wt %, or less than or equal to 10 wt % and greater than or equal to 0.0001 wt %, 0.0005, 0.001, 0.005, 0.01, 0.05, 0.1, 0.5, 1, 1.5, 2, 2.5, 3, 3.5, 4, 4.5, 5, 6, 7, 8, or 9 wt % of the article. The paint can include an oil-based paint or a water-based paint.

The paint can include a paint colorant that provides the paint with a desired color. The paint can include one or more of the paint colorants. The paint colorant can include a dye, pigment, or a combination thereof. The paint colorant can include an organic colorant, an inorganic colorant, or a colorant that includes an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

The paint can be substantially free of inorganic compounds; for example, inorganic compounds can be 0 wt %, or 0 wt % to 0.001 wt %, of the paint. The paint can be substantially free of metal or metal-containing compounds; for example, metal or metal-containing compounds can be 0 wt %, or 0 wt % to 0.001 wt %, of the paint. The paint can be substantially free of colorants or other materials, or concentrations thereof, that increase attenuation of radio waves transmitted and/or received through the thermoplastic resin in regions including the paint and having a frequency in the range of 0.5 GHz to 81 GHz, such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the region of a corresponding article including the same paint but that is free of the colorant or other material; for example, such colorants or other materials can be 0 wt % of the paint, or 0 wt % to 0.001 wt %, or any suitable wt % of the paint that does not cause an increase in the attenuation of the radio waves to climb above the desired maximum percentage. The article can be substantially free of paints that increase attenuation of radio waves transmitted and/or received through regions of the thermoplastic resin including the paint and having a frequency in the range of 0.5 GHz to 81 GHz, such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the same regions of a corresponding article that is free of the paint; for example, such paints can be 0 wt % of the article, or 0 wt % to 0.001 wt %, or any suitable wt % of the article that does not cause an increase in attenuation of the radio waves to climb above the desired maximum percentage.

The article can include a solid continuous coating of paint on a surface of the article. The article can include the paint in the form of a pattern or image on a surface of the article. Any suitable proportion of the surface area of the article can include the paint, such as 0.0001% to 100%, or 0%, or greater than, equal to, or less than 0.0001, 0.0005, 0.001, 0.005, 0.01, 0.05, 0.1, 0.5, 1, 2, 3, 4, 5, 10, 15, 20, 30, 40, 50, 60, 70, 80, 85, 90, 95, 96, 97, 98, 99, 99.9, 99.99, or 99.999% of the surface area of the article. The paint can be applied in any suitable way, such as using a method including brushing, spraying, or a combination thereof.

In various aspects, the article includes the colored coating on an exterior and/or interior surface thereof. The article can include the colored coating alone with substantially no colorant or ink or paint, can include the colored coating and the colorant, the colored coating and the ink, the colored coating and the paint, or can include a combination of the colorant, ink, and the colored coating. The colored coating can form any suitable proportion of the article; for example, the colored coating can be 0.0001 wt % to 10 wt % of the article, 0.0001 wt % to 3 wt %, or less than or equal to 10 wt % and greater than or equal to 0.0001 wt %, 0.0005, 0.001, 0.005, 0.01, 0.05, 0.1, 0.5, 1, 1.5, 2, 2.5, 3, 3.5, 4, 4.5, 5, 6, 7, 8, or 9 wt % of the article. The colored coating can include a pre-colored flexible film, a printed coating, a non-ink coating, a non-paint coating, a fabric, a polymer encasement (e.g., a polyurethane encasement, such as a rigid or flexible encasement), or a combination thereof.

The colored coating can include a colored coating colorant that provides the colored coating with a desired color. The colored coating can include one or more of the colored coating colorants. The colored coating colorant can include a dye, pigment, or a combination thereof. The colored coating colorant can include an organic colorant, an inorganic colorant, or a colorant that includes an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

The colored coating can be substantially free of inorganic compounds; for example, inorganic compounds can be 0 wt %, or 0 wt % to 0.001 wt %, of the colored coating. The colored coating can be substantially free of metal or metal-containing compounds; for example, metal or metal-containing compounds can be 0 wt %, or 0 wt % to 0.001 wt %, of the colored coating. The colored coating can be substantially free of colorants or other materials, or concentrations thereof, that increase attenuation of radio waves transmitted and/or received through the thermoplastic resin in regions including the colored coating and having a frequency in the range of 0.5 GHz to 81 GHz, such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the region of a corresponding article including the same colored coating but that is free of the colorant or other material; for example, such colorants or other materials can be 0 wt % of the colored coating, or 0 wt % to 0.001 wt %, or any suitable wt % of the colored coating that does not cause an increase in the attenuation of the radio waves to climb above the desired maximum percentage. The article can be substantially free of colored coatings that increase attenuation of radio waves transmitted and/or received through regions of the thermoplastic resin including the colored coating and having a frequency in the range of 0.5 GHz to 81 GHz, such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20% as compared to the same regions of a corresponding article that is free of the colored coating; for example, such colored coatings can be 0 wt % of the article, or 0 wt % to 0.001 wt %, or any suitable wt % of the article that does not cause an increase in attenuation of the radio waves to climb above the desired maximum percentage.

The article can include a solid continuous coating of colored coating on a surface of the article. The article can include the colored coating in the form of a pattern or image on a surface of the article. Any suitable proportion of the surface area of the article can include the colored coating, such as 0.0001% to 100%, or 0%, or greater than, equal to, or less than 0.0001, 0.0005, 0.001, 0.005, 0.01, 0.05, 0.1, 0.5, 1, 2, 3, 4, 5, 10, 15, 20, 30, 40, 50, 60, 70, 80, 85, 90, 95, 96, 97, 98, 99, 99.9, 99.99, or 99.999% of the surface area of the article. The colored coating can be applied in any suitable way, such as by spraying, printing, applying as a fabric, applying as a film, encasing, or a combination thereof.

In various aspects, the article includes the colorant; and the ink, the paint, the colored coating, or a combination thereof. A visual color of the article including the colorant prior to addition of the ink, paint, or colored coating can be close to the visual color of the article including the colorant after the addition of the ink, paint, or colored coating. The colorant and the ink, paint, or colored coating can have the same general class of color, wherein the general class of color includes red, orange, yellow, green, blue, cyan, indigo, violet, or black. By using a colorant and an ink, paint, or colored coating that are closely matched in visual color or that belong to the same general class of color, a scratch to the surface of the article can be hidden due a lack of a substantially different color visible through the scratched ink, paint, or colored coating.

### Thermoplastic Resin.

The article includes a thermoplastic resin. The thermoplastic resin includes a first polyamide that includes nylon-6; nylon-6,6; a copolymer of nylon-6 or nylon-6,6 including at least one repeating unit that is poly(hexamethylene terephthalamide), poly(hexamethylene isophthalamide), or a copolymer of poly(hexamethylene terephthalamide) and poly(hexamethylene isophthalamide); a mixture thereof or a copolymer thereof. The thermoplastic resin also includes a second polyamide, an additive, or a mixture thereof.

The thermoplastic resin can be substantially free of materials (e.g., 0 wt %, or 0 wt % to 0.001 wt %) that cause the thermoplastic resin to increase attenuation of radio waves at one or more frequencies in the range of 0.5 GHz to 81 GHz, as compared to the same region of the thermoplastic resin without the material. Materials that cause the thermoplastic resin (in regions including the material) to increase attenuation of radio waves at one or more frequencies in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof) as compared to the same region of the thermoplastic resin without the material (such as that increase the attenuation by more than 0%, 0.001, 0.005, 0.01, 0.05, 0.1, 0.5, 1, 1.5, 2, 3, 4, 5, 6, 8, 10, 12, 14, 16, 18, or by more than 20%), can be 0 wt % of the thermoplastic resin, or 0 wt % to 0.001 wt % of the thermoplastic resin, or any suitable wt % of the thermoplastic resin that does not cause an increase in attenuation of the radio waves to climb above the desired maximum percentage. The thermoplastic resin can be substantially free of metals or metal-containing compounds. Metals or metal-containing compounds can be 0 wt % of the thermoplastic resin, or 0 wt % to 0.001 wt % of the thermoplastic resin.

The first polyamide and second polyamide can be independently selected. The first polyamide is present in the thermoplastic resin, and the second polyamide is optionally present. The decision on the specific polyamide or blend of polyamides (or the proportion thereof) that are used in the article can be a function of the respective polyamide's tensile strength, toughness, or both. The first polyamide, and the second polyamide (if present), can together form about 30 wt % to about 100 wt % of the thermoplastic resin, about 50 wt % to about 95 wt %, less than, equal to, or greater than, 30 wt %, 35, 40, 45, 50, 55, 60, 65, 70, 75, 80, 85, 90, 95 wt % of the thermoplastic resin, or 100 wt % of the thermoplastic resin. In various aspects, the first polyamide, and the second polyamide (if present) can form the major portion of the composition (i.e., over 50 wt %) with additives forming the minor portion of the composition (i.e., less than 50 wt %). The polyamide can be PA6; PA4,6; PA6,6; PA6,9; PA6,10; PA6,12; PA10,12; PA12,12; PA6; PA11; PA12; PA66/6T; PA6I/6T; PADT/6T; PA66/6I/6T; or blends thereof, such as PA6/PA66. In some examples, the polyamide can include 6I repeating units (hexamethylene isophthalamide), 6T repeating units (polyhexamethylene terephthalamide) or a combination of 6I/6T repeating units. When a combination of 6I and 6T repeating units is present the 6I and 6T repeating units can be present in any suitable weight ratio, for example, weight ratios from about 96:4 to about 10:90 wt:wt of 6I:6T, about 80:20 to about 20:80 wt:wt, about 70:30 to about 30:70 wt:wt, or about 60:40 to about 40:60 wt:wt or 6I:6T. In some examples the polyamide can be PA66:DI with a molar weight ratio between PA66 and DI in a range of 85:15 to 96:4 (wt:wt).

As used herein, “PA66/DI” refers to a type of co-polyamide of polyhexamethyleneadipamide (nylon-6,6 or N66 or PA66) and “DI” which is a combination of 2-methyl-pentamethylenediamine (or “MPMD”) and isophthalic acid. MPMD is commercially available as INVISTA Dytek® A amine and industrially known as “D” in the abbreviated formulation labeling. Isophthalic acid is commercially available and industrially known as “I” in the abbreviated formulation labeling. The formulation “PA66/DI” used in the examples of the present disclosure had an RV of 45, and a composition of 92:8 PA66:DI (wt/wt), with the “DI” part being about 40:60 D:I (wt/wt). Other non-limiting co-polyamides suitable for use in place of the PA66/DI used in the present examples include 66/D6, 66/DT, 6T/DT, 66/610, or 66/612.

INVISTA Dytek® A amine is commercially produced by hydrogenating 2-methylglutaronitrile (or “MGN”). MGN is a branched C6 dinitrile obtained as a side-product from butadiene double-hydrocyanation process of adiponitrile (or “ADN”) manufacture. The otherwise disposed MGN side-product can be recycled and reused in the production of INVISTA Dytek® A amine or the “D” portion. Therefore, suitable thermoplastic resins and articles made therefrom, and according to the present disclosure, include those having recycled amine content when the “D” portion is present, for example, in 66/DI, 66/D6, 66/DT, 6T/DT, and the like.

The polyamide can include nylon-6 (e.g., PA6) and nylon-6,6 (e.g., PA6,6). The polyamide can be nylon-6,6 and the thermoplastic resin can optionally be substantially free of all other polyamides (e.g., nylon-6,6 can be the only polyamide used to form the thermoplastic resin).

In various aspects, the thermoplastic resin includes the first polyamide, the second polyamide, and the additive.

The first polyamide and/or second polyamide can include nylon-6 or nylon-6,6. The first polyamide and/or second polyamide can also include a copolymer including nylon-6 or nylon-6,6, wherein the copolymer includes at least one repeating unit that is poly(hexamethylene terephthalamide), poly(hexamethylene isophthalamide), or a copolymer of poly(hexamethylene terephthalamide) and poly(hexamethylene isophthalamide), wherein a molar ratio of the poly(hexamethylene terephthalamide) repeating unit to poly(hexamethylene isophthalamide) repeating unit is in a range of from about 60:40 to about 90:10 (e.g., about 70:30 to about 75:25).

The first polyamide and/or second polyamide can be nylon-6, nylon-6,6, or a combination thereof.

The thermoplastic resin can be substantially free of polymers that are not polyamides. For example, polymers that are not polyamides can be 0 wt %, or 0 wt % to 0.001 wt %, of the thermoplastic resin. In some aspects, the thermoplastic resin can include other polymers in addition to the first polyamide and optional second polyamide, such as polyethers such as polyphenylene ether (PPE) and polyolefins such as polyethylene, polypropylene, polybutylene, acrylonitrile-butadiene-styrene (ABS) resin, polybutylene terephthalate (TBT), propylene carbonate (PC), and blends thereof.

In various aspects, the thermoplastic resin includes the additive. The additive can be or include a reinforcing fiber. The reinforcing fiber can be up to 50 wt % of the thermoplastic resin (e.g., 5 to 50 wt % reinforcing fibers, 10 to 50 wt %, 10 to 30 wt %, 12 to 50 wt %, or 14 to 40 wt % reinforcing fibers, or less than, equal to, or greater than about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt % reinforcing fibers). Reinforcing fibers can be helpful to increase the tensile strength and toughness of the article. The amount of reinforcing fiber added can be enough to impart the desired tensile strength and toughness to the article while not compromising the low transmission loss characteristics of the article. The reinforcing fiber can be any suitable reinforcing fiber, such as glass fibers, silicon fibers, carbon fibers, polypropylene fibers, polyacrylonitrile fibers, basalt fibers, or mixtures thereof. The reinforcing fiber can include or be glass fiber. Glass fibers can be 10 to 50 wt % of the thermoplastic resin, or 12 to 50 wt %, or 14 to 40 wt % of the thermoplastic resin. The reinforcing fiber can be incorporated into the thermoplastic resin, for example, in an extruder.

In various aspects, the thermoplastic resin consists of the first polyamide and a reinforcing fiber (e.g., glass fibers). In various aspects, the thermoplastic resin consists of the first polyamide, a reinforcing fiber (e.g., glass fibers), and one or more additives. In various aspects, the thermoplastic resin consists of the first polyamide, the second polyamide, and a reinforcing fiber (e.g., glass fibers). In various aspects, the thermoplastic resin consists of the first polyamide, the second polyamide, a reinforcing fiber (e.g., glass fibers), and one or more additives. In various aspects, the thermoplastic resin includes or consists of nylon-6,6 and a reinforcing fiber.

The additive can be chosen from a reinforcing fiber, an ultraviolet resistance additive, a flame retardancy additive, an anti-static additive, an impact modifier, a colorant, a moisture repellant, or a combination thereof. The thermoplastic resin can include the additive and the one or more additives can be about 0.1 wt % to about 60 wt % of the thermoplastic resin, 0.1 wt % to about 50 wt %, 0.5 wt % to 55 wt %, 0.75 wt % to 50 wt %, or about 0.1 wt % to about 30 wt % of the thermoplastic resin. The additive can be substantially free of metals and/or metal-containing compounds; e.g., the additive can be 0 wt %, or 0 wt % to 0.001 wt %, metals and/or metal-containing compound. Examples of additives or packages of additives can include ultraviolet radiation resistance additives, flame retardancy additives, anti-static additives, impact modifiers, color additives (e.g., pigments or colorants), heat stabilizer additives, moisture repellency additives, or a combination thereof. In some examples, the thermoplastic resin can include a flame retardancy coating disposed on an external surface of the article. Examples of ultraviolet radiation resistance additives include ultraviolet radiation resistance additives that are substantially free of metal and/or metal-containing compounds; for example, the ultraviolet radiation resistance additive can be 0 wt %, or 0 wt % to 0.001 wt %, metals and/or metal-containing compounds.

Examples of suitable impact-modifying additives can include a maleated polyolefin. Examples of suitable maleated polyolefins include maleated polyolefins available under the trade designation AMPLIFY™ GR, which are commercially available from Dow Chemical Co., Midland Mich., USA (examples include Amplify™ GR 202, Amplify™ GR 208, Amplify™ GR 216, and Amplify™ GR380), maleated polyolefins available under the trade designation EXXELOR™ available from ExxonMobil, Irving TX, USA (examples include Exxelor™ VA 1803, Exxelor™ VA 1840, Exxelor™ VA1202, Exxelor™ PO 1020, and Exxelor™ PO 1015), maleated polyolefins available under the trade designation ENGAGE™ 8100 available from Dow Elastomer Midland Mich., USA, and maleated polyolefins available under the trade designation BONDYRAM® 7103 available from Ram-On Industries LP.

In various aspects, the thermoplastic resin is substantially free of chemical reaction during formation of the article, such as during injection molding, thermoforming, compression molding, or extruding the thermoplastic resin to form the article. In other aspects, the thermoplastic resin can at least partially react during formation of the article, such as during injection molding, thermoforming, compression molding, or extruding the thermoplastic resin to form the article. For example, in some aspects, the thermoplastic resin includes a maleated polyolefin, and during formation of the article the one or more polyamides in the thermoplastic resin can form a reaction product with the maleated polyolefin, such as a polyamide-polyolefin copolymer formed from at least partial reaction of the condensation polyamide and the maleated polyefin.

Examples of suitable flame retardants include, for example, organophosphorus compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (such as trialkyl phosphites, triaryl phosphites, or mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (such as aluminum tris(diethyl phosphinate)); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame retardant (such as polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants.

Examples of suitable ultraviolet additives include ultraviolet absorbers, quenchers, hindered amine light stabilizers (HALS), or mixtures thereof. Ultraviolet absorbers are a type of light stabilizer that functions by competing with the chromophores to absorb ultraviolet radiation. Absorbers change harmful ultraviolet radiation into harmless infrared radiation or heat that is dissipated through the polymer matrix. Carbon black is an effective light absorber. Another ultraviolet absorber is rutile titanium oxide which is effective in the 300-400 nm range. Hydroxybenzophenone and hydroxyphenylbenzotriazole are also suitable ultraviolet stabilizers that have the advantage of being suitable for neutral or transparent applications. Hydroxyphenylbenzotriazole is not very useful in thin parts below 100 microns. Other ultraviolet absorbers include oxanilides for polyamides, benzophenones for polyvinyl chloride and benzotriazoles and hydroxyphenyltriazines for polycarbonate. Ultraviolet absorbers have the benefit of low cost but may be useful only for short-term exposure. Quenchers return excited states of the chromophores to ground states by an energy transfer process. The energy transfer agent functions by quenching the excited state of a carbonyl group formed during the photo-oxidation of a polymeric material and through the decomposition of hydroperoxides. This prevents bond cleavage and ultimately the formation of free radicals. Hindered Amine Light Stabilizers are long-term thermal stabilizers that act by trapping free radicals formed during the photo-oxidation of a polymeric material and thus limiting the photodegradation process. The ability of Hindered Amine Light Stabilizers to scavenge radicals created by ultraviolet absorption is explained by the formation of nitroxy radicals through a process known as the Denisov Cycle. Although there are wide structural differences in the Hindered Amine Light Stabilizers, most share the 2,2,6,6-tetramethylpiperidine ring structure. Hindered Amine Light Stabilizers are proficient UV stabilizers for a wide range of polymeric materials. While Hindered Amine Light Stabilizers are also very effective in polyolefins, polyethylene, and polyurethane, they are not useful in polyvinyl chloride. Non-limiting examples of optional additives include adhesion promoters, biocides, anti-fogging agents, anti-static agents, anti-oxidants, bonding, blowing and foaming agents, catalysts, dispersants, extenders, smoke suppressants, impact modifiers, initiators, lubricants, nucleants, pigments, colorants and dyes, optical brighteners, plasticizers, processing aids, release agents, silanes, titanates and zirconates, slip agents, anti-blocking agents, stabilizers, stearates, ultraviolet light absorbers, waxes, catalyst deactivators, and combinations thereof.

Non-limiting examples of optional additives include adhesion promoters, biocides, anti-fogging agents, anti-static agents, anti-oxidants, bonding, blowing and foaming agents, catalysts, dispersants, extenders, smoke suppressants, impact modifiers, initiators, lubricants, nucleants, pigments, colorants and dyes, optical brighteners, plasticizers, processing aids, release agents, silanes, titanates and zirconates, slip agents, anti-blocking agents, stabilizers, stearates, ultraviolet light absorbers, waxes, catalyst deactivators, and combinations thereof.

In various aspects the thermoplastic resin includes the additive in an amount of about 0.1 wt % to about 50 wt %, or 10 wt % to 30 wt % of the resin, and a transmittance loss of the thermoplastic resin, when a direction of a signal impinging on the thermoplastic resin is normal to a surface of the thermoplastic resin, and when a thickness of the thermoplastic resin is substantially uniform across an area where the signal impinges on the article, can be: less than 2 decibels (dB) for a signal having a frequency between 500 MHz and 40 GHz; less than 1 dB within at least one of a 0.5 GHz to 6 GHz frequency range, a 24 GHz to 30 GHz frequency range, and a 36 GHz to 40 GHz range; less than 0.5 dB within at least one of a 0.5 GHz to 6 GHz frequency range, a 24 GHz to 30 GHz frequency range, and a 36 GHz to 40 GHz range is less than 0.5 decibels (dB); or a combination thereof.

The relative weight gain of the article, and/or of the thermoplastic resin, due to moisture gain of the article and/or thermoplastic resin at 70° C. and 62% relative humidity, can be less than 4 wt %, or 0 wt % to 3.5 wt %, or 0 wt % to 1 wt %, or less than wt % and greater than or equal to 0 wt %, 0.1, 0.5, 1, 1.5, 2, 2.5, 3, or 3.5 wt %.

In various aspects, the thermoplastic resin can have a density of greater than or equal to 0.7 g/cm³ to less than or equal to 5 g/cm³, or greater than or equal to 0.8 g/cm³ to less than or equal to 4 g/cm³, or greater than or equal to 0.85 to less than or greater than 3 g/cm³. The thermoplastic resin can have a density in a range of from about 0.7 g/cm³ to about 10 g/cm³, 0.7 g/cm³ to about 5 g/cm³, about 2 g/cm³ to about 5 g/cm³, about 0.75 g/cm³ to 4 g/cm³, 0.8 g/cm³ to about 4 g/cm³, about 0.8 g/cm³ to about 3 g/cm³, 0.85 to about 3 g/cm³, or, equal to, or greater than about 0.7 g/cm³, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or about 10.0 g/cm³. The ability of the thermoplastic resin to achieve density values greater than 1 g/cm³ can help to increase the tensile strength and toughness of the resulting article. This is in direct contrast, for example, to articles that include a foam material.

In various aspects, the thermoplastic resin can include reinforcing glass fiber in up to 50 wt % level of the total composition mass. The thermoplastic resin can have a tensile strength in a range of from about 40 MPa to about 300 MPa. The thermoplastic resin can have a density in a range of from 0.7 g/cm³ to 5 g/cm³. The thermoplastic resin can have an impact resistance in a range of from 40 kJ/m² to 150 kJ/m². The thermoplastic resin can have a signal attenuation of at least one of the following, when a direction of a signal impinging on the thermoplastic resin is normal to a surface of the thermoplastic resin, and wherein a thickness of the thermoplastic resin is substantially uniform across an area where the signal impinges on the thermoplastic resin: from 1 dB to 0 dB for signal of frequency 500 MHz to 6 GHz when the thermoplastic resin thickness is from 0.5 mm to 6 mm; from 1 dB to 0 dB for signal of frequency 24 GHz to 30 GHz when the thermoplastic resin thickness is from 0.5 mm to 4.5 mm; from 1 dB to 0 dB for signal of frequency 36 GHz to 40 GHz when the thermoplastic resin thickness is from 0.5 mm to 4 mm; and rom 1 dB to 0 dB for signal of frequency 76 GHz to 81 GHz when the thermoplastic resin thickness is from 0.5 mm to 3.5 mm.

The thermoplastic resin can have a substantially uniform signal attenuation of, when a direction of a signal impinging on the thermoplastic resin is normal to a surface of the thermoplastic resin, and wherein a thickness of the thickness of the article is substantially uniform across an area where the signal impinges thereon: from 1 dB to 0 dB, or from 2 dB to 0 dB, or 0 dB, or less than or equal to 2 and greater than or equal to 0.1, 0.2, 0.3, 0.4, 0.5, 0.6, 0.7, 0.8, 0.9, 1, 1.1, 1.2, 1.3, 1.4, 1.5, 1.6, 1.7, 1.8, or 1.9 dB, for a signal of frequency 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). The thermoplastic resin can have a substantially uniform signal attenuation of, when a direction of a signal impinging on the thermoplastic resin is normal to a surface of the thermoplastic resin, and wherein a thickness of the thermoplastic resin is substantially uniform across an area where the signal impinges on the thermoplastic resin: from 1 dB to 0 dB for signal of frequency 500 MHz to 6 GHz when a thickness of the thermoplastic resin is from 1.5 mm to 4 mm; from 1 dB to 0 dB for signal of frequency 24 GHz to 30 GHz when the thermoplastic resin thickness is from 2.5 mm to 4 mm; from 1 dB to 0 dB for signal of frequency 36 GHz to 40 GHz when the thermoplastic resin thickness is from 1.75 mm to 2.75 mm; from 1 dB to 0 dB for signal of frequency 76 GHz to 81 GHz when the thermoplastic resin thickness is from 1.75 mm to 2.75 mm; or a combination thereof.

Up to 20 wt % of the thermoplastic resin can be one or more flame-retardancy additives (e.g., 0 wt % to 20 wt %, or 0 wt % to 10 wt %, or 0 wt % to 5 wt %, or 0 wt %, or less than 20 wt % and greater than or equal to 0 wt %, 0.5, 1, 2, 3, 4, 5, 6, 8, 10, 12, 14, 16, or 18 wt %). The flame-retardancy additive, along with any optional flame-retardant coating on the article, can be sufficient to provide the thermoplastic resin and/or article with a UL-94 test rating of V-0.

In various aspects, the thermoplastic resin includes PA66:DI (85:15 to 96:4 wt:wt), glass fiber in a range of about 5 to about 20 wt %, a flame-retardant additive in a range of up to about 20 wt %, a UV additive in a range of up to about 3 wt %, a heat stabilizer additive in a range of up to about 2 wt %, and a colorant additive in a range of up to about 3 wt %.

Suitable first and/or second polyamides according to this disclosure can have sufficient tensile modulus and tensile strength values to allow an article formed from the thermoplastic resin to withstand environmental stresses. As an example, suitable polyamides include those having a tensile modulus in a range from 30 MPa to 50,000 MPa, 1,000 MPa to 50,000 MPa, 1,000 MPa to 40,000 MPa, or, 30 MPa to 30,000 MPa. As an example, suitable polyamides include those having tensile strength from 30 MPa to 400 MPa, 35 MPa to 300 MPa, 40 MPa to 280 MPa, or less than, equal to, or greater than about 30, 50, 100, 150, 200, 250, 300, 350, or 400 MPa.

The thermoplastic resin can have any suitable tensile strength. For example, the thermoplastic resin can have a tensile strength of 30 MPa to 50,000 MPa, 1,000 MPa to 50,000 MPa, 1,000 MPa to 40,000 MPa, or, 1,000 MPa to 30,000 MPa. As an example, suitable thermoplastic resins include those having tensile strength from 30 MPa to 400 MPa, 35 MPa to 300 MPa, 40 MPa to 280 MPa, or less than, equal to, or greater than about 30, 50, 100, 150, 200, 250, 300, 350, or 400 MPa.

A thermoplastic resin including or consisting of a polyamide and a glass fiber additive can have any suitable tensile strength. In some examples, a PA66 with 20 wt % GF can have a tensile strength in a range of from about 100 MPa to about 150 MPa at a temperature of 50° C. and from about 70 MPa to about 100 MPa at a temperature of about 23° C. In some examples, a PA66 with 30 wt % glass fiber can have a tensile strength in a range of from about 140 MPa to about 190 MPa at a temperature of 50° C. and from about 100 MPa to about 130 MPa at a temperature of about 23° C. In some examples, a PA66 with 20 wt % glass fiber can have a tensile strength in a range of from about 100 MPa to about 150 MPa at a temperature of 50° C. and from about 70 MPa to about 100 MPa at a temperature of about 23° C. In some examples, a PA66 with polyphenylene ether can have a tensile strength in a range of from about 45 MPa to about 65 MPa at a temperature of 50° C. and from about 40 MPa to about 55 MPa at a temperature of about 23° C. In some examples, a PA66 with polyphenylene ether and 20 wt % glass fiber can have a tensile strength in a range of from about 100 MPa to about 130 MPa at a temperature of 50° C. and from about 80 MPa to about 100 MPa at a temperature of about 23° C.

Additionally, suitable thermoplastic resins further include those within the tensile strength or tensile modulus ranges above that exhibit toughness in the un-notched Charpy impact test at 23° C. from 30 KJ/m² to non-break, for example 40 KJ/m² to 200 KJ/m², 40 KJ/m² to 150 KJ/m², equal to, or greater than 40, 50, 60, 70, 80, 90, 100, 110, 120, 130, 140, 150, 160, 170, 180, 190, or 200 KJ/m². In some examples, a PA66 with 20 wt % glass fiber can have an un-notched Charpy impact value in a range of from about 98 KJ/m² to about 110 KJ/m² at a temperature of 50° C. and from about 53 KJ/m² to about 72 KJ/m² at a temperature of about 23° C. In some examples, a PA66 with 30 wt % glass fiber can have an un-notched Charpy impact value in a range of from about 110 KJ/m² to about 120 KJ/m² at a temperature of 50° C. and from about 89 KJ/m² to about 100 KJ/m² at a temperature of about 23° C. In some examples, a PA66 with polyphenylene ether can have an un-notched Charpy impact value in a range of from about 240 KJ/m² to about 340 KJ/m² at a temperature of 50° C. and from about 310 KJ/m² to about 370 KJ/m² at a temperature of about 23° C. In some examples, a PA66 with polyphenylene ether and 20 wt % glass fiber can have an un-notched Charpy impact value in a range of from about 73 KJ/m² to about 76 KJ/m² at a temperature of 50° C. and from about 79 KJ/m² to about 82 KJ/m² at a temperature of about 23° C. In some examples, a PA66 with 20 wt % glass fiber can have a notched Charpy impact value in a range of from about 10 KJ/m² to about 22 KJ/m² at a temperature of 50° C. and from about 7 KJ/m² to about 8.5 KJ/m² at a temperature of about 23° C. In some examples, a PA66 with 30 wt % glass fiber can have a notched Charpy impact value in a range of from about 15 KJ/m² to about 27 KJ/m² at a temperature of 50° C. and from about 11 KJ/m² to about 14 KJ/m² at a temperature of about 23° C. In some examples, a PA66 with polyphenylene ether can have a notched Charpy impact value in a range of from about 24 KJ/m² to about 35 KJ/m² at a temperature of 50° C. and from about 20 KJ/m² to about 23 KJ/m² at a temperature of about 23° C. In some examples, a PA66 with polyphenylene ether and 20 wt % glass fiber can have a notched Charpy impact value in a range of from about 11 KJ/m² to about 14 KJ/m² at a temperature of 50° C. and from about 11 KJ/m² to about 12 KJ/m² at a temperature of about 23° C.

The thermoplastic resin can be characterized by its dielectric constant. For example, a dielectric constant of the thermoplastic resin can be in a range of from about 2.50 to about 4.00 in the 3-40 GHz frequency range, about 2.75 to about 3, less than, equal to, or greater than about 2.50, 2.60, 2.70, 2.80, 2.90, 3.00, 3.10, 3.20, 3.30, 3.40, 3.50, 3.60, 3.70, 3.80, 3.90, or about 4.0. These values can be measured, e.g., using Active Standard Test Method (ASTM) D2520.

The thermoplastic resin can be further characterized by its dissipation factor (DF), which can be in a range of about 0.004 to about 0.025, about 0.010 to about 0.020, less than, equal to, or greater than about 0.004, 0.006, 0.007, 0.008, 0.009, 0.010, 0.011, 0.012, 0.013, 0.014, 0.015, 0.016, 0.017, 0.018, 0.019, 0.020, 0.021, 0.022, 0.023, or 0.024 in the 3-40 GHz frequency range. These values can be measured, e.g., using ASTM D2520. An attenuation of the thermoplastic resin can be from 1 dB to 0 dB for a signal of frequency 500 MHz to 6 GHz and a thermoplastic resin thickness from 0.5 mm to 6 mm, for a signal of frequency 24 GHz to 30 GHz and a thermoplastic resin thickness from 0.5 mm to 4.5 mm, for a signal of frequency 36 GHz to 40 GHz and a thermoplastic resin of thickness from 0.5 mm to 4 mm, or for a signal of frequency 76 GHz to 81 GHz and a thermoplastic resin thickness from 0.5 mm to 3.5 mm.

When the frequency is 500 MHz to 6 GHz, signal impingement angle with the surface is 90±5°, and the desired attenuation is from 1 dB to 0 dB, then suitable thicknesses of the thermoplastic resin can be between 0.5 mm and 6 mm. When the frequency is 24 GHz to 30 GHz, signal impingement angle with the surface is 90±5°, and the desired attenuation is from 1 dB to 0 dB, then suitable thicknesses of the thermoplastic resin can be between 0.5 mm and 4.5 mm. When the frequency is 36 GHz to 40 GHz, signal impingement angle with the surface is 90±5°, and the desired attenuation is from 1 dB to 0 dB, then suitable thicknesses of the thermoplastic resin can be between 0.5 mm and 4 mm. When the frequency is 76 GHz to 81 GHz, signal impingement angle with the surface is 90±5°, and the desired attenuation is from 1 dB to 0 dB, then suitable thicknesses of the thermoplastic resin can be between 0.5 mm and 3.5 mm.

### System.

Various aspects of the present invention provide a system that includes the article described herein and an antenna for transmitting and/or receiving radio waves having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof). The article can fully or partially enclose the antenna.

### Method of Making the Article.

Various aspects of the present invention provide a method of making the article. The method of making the article can include injection molding, thermoforming, compression molding, or extruding the thermoplastic resin to form the article or one or more components thereof. The method can further include assembling the one or more components to form the article.

The first polyamide and optional second polyamide can be provided as individual pellets. In some examples, a diameter or length of an individual pellet can independently be in a range of from about 1 mm to about 5 mm, about 2 mm to about 4 mm. The individual pellets can include the first polyamide, the optional second polyamide, along with any of the additives described herein. Alternatively, in some examples, the pellets can include the polyamide or mixture of polyamides, and these pellets can then be heated so that they soften and any additives, reinforcing fibers, or both can be added to the softened pellets and mixed. Following mixing, the mixture of the polyamides, additives, reinforcing fibers, or a sub-combination thereof can be subjected to an injection molding process, extrusion process, or additive manufacturing process.

The panel 100 shown in FIG. 19 can be formed by any of a number of suitable processes including injection molding, thermoforming, and compression molding. The disclosed panel 100 can optionally be formed in a single molding operation or in a multi-shot process in which surrounding material is the same or different from that of the disclosed panel 100. In general, a multi-shot process is performed on one machine that is programmed to perform two injections in one cycle. In the first cycle, a nozzle injects plastic into a mold. The mold is then automatically rotated, and a different type of plastic is injected into the mold from a second nozzle. Double injection molding optimizes co-polymerization of hard and soft materials to create a powerful molecular bond. The result is a single part with production and feature advantages. It can be used for a variety of product designs across all industries. It also allows for molding using clear plastics, colored graphics and stylish finishes, which improves product functionality and marketplace value.

In applications where a panel 100 cannot be formed through injection molding, the panel 100 may be formed through extrusion. In some examples of extrusion, a die placed at the end of the extruder can have a shape that is the negative impression of the intended shape of the panel 100. In still some further examples, any part of the panel 100 can be formed through an additive manufacturing process.

The method can include compounding the thermoplastic resin and the colorant together prior to the injection molding, thermoforming, compression molding, or extruding of the thermoplastic resin to form the article or one or more components thereof.

The method can include applying the ink onto, and/or applying the paint onto, the injection molded, thermoformed, compression molded, or extruded thermoplastic resin, to form the article described herein. Applying the ink can include sublimation printing, inkjet printing, pad printing, screen-printing, or a combination thereof. Applying the ink can include ink sublimation. Applying the ink can include printing the ink on a film and applying the film to the exterior of the article.

### Method of Using the Article.

Various aspects of the present invention provide a method of using the article. The method includes transmitting and/or receiving radio waves having a frequency in the range of 0.5 GHz to 81 GHz (e.g., 0.5 GHz to 6 GHz, 24 GHz to 30 GHz, 28 GHz to 39 GHz, 36 GHz to 40 GHz, 76 GHz to 81 GHz, 6 GHz to 100 GHz, or a combination thereof) through the article described herein.

### EXAMPLES

Various aspects of the present invention can be better understood by reference to the following Examples, which are offered by way of illustration. The present invention is not limited to the Examples given herein.

### Part I.

Certain combinations of composition, surface profile and structural thickness can surprisingly yield molded articles exhibiting useful dielectric constants and high transparency to millimeter waves.

### General Procedure for Producing Compounded Material.

A twin-screw extruder having a minimum 18-mm diameter co-rotating screw with a 40-56 L/D (e.g., L/D ratio of 40-56) is used for compounding. The unit has one main feeder and a minimum of three side feeders. A feed rate of at least 1 kg/hr is used. The twin-screw co-rotating/turning at the speed of at least 1000 RPM is sufficient to provide the high shear for compounding function. The total compounder throughput is at least 15 kg/hr.

The compounding unit has at least three vent ports, one atmospheric and two vacuum ports. The rotating twin screws impart the forward momentum to the heated mass inside the barrel, and the barrel is heated along its length in zones at temperatures in a range of 250−310° C.

The processing section of the twin-screw compounder is set up to suit various process needs and to allow for a wide variety of processes, including compounding processes. Polymer, fillers, and additives, as desired, are continuously fed into the first barrel section of the twin screw using a metering feeder. The products are conveyed along the screw and are melted and mixed by kneading elements in the plastification section of the barrel. The polymer then travels along to a side port where, if desired, fillers or additives are mixed in, and is supplied to degassing zones and from there to a pressure build zone where it then exits the die via an at least 3-mm hole as a lace. The cast lace is fed into a water bath to cool and to enable it to be cut into chips via a pelletizer. The unit is designed to be able to withstand at least 70 bar die pressure. The die with a minimum of four holes, each at least 3 mm diameter for pelletizing, can be included.

A compounded pellet of polyamide having a diameter of 3 mm and a length of 3-5 mm is produced using the above equipment. The moisture content of the pelletized polyamide material is less than about 0.2 wt %.

### General Procedure for Producing Molded Panels.

An injection molding machine (Demag Sumitomo Sytec 100/200) used includes a feed throat, and a single rotating screw in a temperature zoned barrel, where zones can range from 40 to 320° C. to melt a nylon-6,6 based resin, and where the screw moves within the barrel to inject a volume of molten resin into a mold, where the mold is at 60-90° C. for a nylon-6,6 based resin. The mold yields solid parts or specimens, which includes those suitable for testing, such as flammability bars of desired dimensions.

In these examples, flammability ratings are established by performing a test functionally equivalent to the UL 94 Standard.

### Materials Used in Examples.

Feedstock PA6 neat polyamide, as used herein, is commercially available from BASF as Ultramid® polyamide, DSM Engineering Materials as Akulon® polyamide or similar.

Feedstock PA66 neat polyamide, as used herein, is a commercially available INVISTA nylon-66 (or N66) grade under the Tradename INVISTA™ U4800 polyamide resin, available from INVISTA, Wichita Kans. The PA66 has standard RV range of 42-50. The feedstock PA66 has high RV ranging from 80 to 240.

As used herein, “6I/6T” is commercially available from EMS-Chemie (North America) Inc. of Sumter, S.C., USA, as EMS Grivory G21.

As used herein, the term “PA66-6I/6T” or “PA66+6I/6T” refers to a blended material of PA66 and 6I/6T. For example, “PA66+6I/6T (70+30)” is a 70:30 (wt:wt) nylon:6I/6T blended material of PA66 and 6I/T.

As used herein, “PA66-GF30” is a glass fiber reinforced nylon-66. “GF30” indicates 30 wt % glass fiber content.

As used herein, “PA66-GF20” is a glass fiber reinforced nylon-66. “GF20” indicates 20 wt % glass fiber content.

As used herein, “PA66-PPE” is a commercially available thermoplastic polymer blend of PA66 and polyphenylene ether (abbreviated as PPE). Such material is available from Asahi Kasei, SABIC, Mitsubishi and LG Chem, for example, LG Chemical LUMILOY® TX5002 High Flow PPE/PA Alloy, Mitsubishi Lemalloy® C61HL PPE-PA66 Alloy, or similar. The suitable PA66-PPE blends may have mass ratio range from 90:10 to 10:90, for example, 80:20, 70:30, 60:40, 50:50, 40:60, 30:70, 20:80, and such.

As used herein, “PA66-PPE-GF20” is a glass fiber reinforced nylon-66-PPE. “GF20” indicates 20 wt % glass fiber content.

As used herein, “PPE” is commercially available material, such as that available from Asahi Kasei, SABIC, Mitsubishi and LG Chem.

As used herein, “PA66-IM-GF30” is a nylon-66 containing impact modified polyolefin with 30 wt % GF.

Neat polycarbonate (PC) is a commercially available material, such as that available from Lotte Chemical.

As used herein, “PA66/DI” is known as a copolymer of hexamethylene adipamide and 2-methyl-1,5-pentamethylene-isophthalamide. PA66/DI used in the examples has a relative viscosity (RV) of 45 and contains about 92:8 (wt:wt) PA66:DI. The “DI” part in PA66/DI is about 50:50 (molar) or about 40:60 (wt:wt) D:I.

### Material Specimens Tested.

Seven resin specimens are tested in these Examples. The seven resins are listed below in Table 1. The starting resin pellet moisture is measured by AquaTrac instrument prior to molding plaques.

TABLE 1
Resins.

| | | | | Pellet Moisture |
|---|---|---|---|---|
| | | | | (wt %) |
| | | | | measured |
| Specimen | | | Material | before molding |
| Label | Material ID | Material Type | Condition | plaques |
| A | PA66 Neat | Polyamide, unreinforced | DAM | 0.12% |
| B | | | c50% RH | |
| C | PA66-GF30 | Polyamide with 30% glass fiber | DAM | 0.05% |
| D | | | c50% RH | |
| E | PA6 Neat | Polyamide, unreinforced | DAM | 0.12% |
| F | | | c50% RH | |
| G | PA66-PPE | Polyamide + PPE blend, unreinforced | DAM | 0.02% |
| H | | | c50% RH | |
| I | PA66-6I/6T | Polyamide blend, unreinforced | DAM | 0.05% |
| J | | | c50% RH | |
| K | PA66-IM-GF30 | Polyamide with 30% glass fiber | DAM | 0.05% |
| L | | | c50% RH | |
| M | PC | Polycarbonate, unreinforced | DAM | 0.02% |
| N | | | c50% RH | |

### Test Methods Used in the Examples.

ISO 1110 Accelerated conditioning of polyamide specimens.

ASTM D2520 Standard Test Methods for Complex Permittivity (Dielectric Constant) of Solid Electrical Insulating Materials at Microwave Frequencies and Temperatures to 1650 Degrees C.” (Method B, Resonant Cavity Perturbation Technique).

ASTM D789 Relative viscosity (RV) measurement method.

UL 94 Std. Flammability (V-0/V-1/V-2) rating determination method.

### Moisture Gain Determination.

Each resin specimen is molded as 100×134×3 mm plaques and as 100×155×1.5 mm plaques. Plaques are stored in foil bags in dry-as-molded state, so moisture in DAM plaques is expected to be the same as in pellets fed to the molding machine.

Starting from a dry as molded (DAM) state, the plaques are conditioned using an ISO 1110 procedure.

The ISO 1110 standard provides a method for accelerated conditioning of polyamide specimens, where specimens are held in a humidity chamber having an atmosphere of 70° C. with 62% relative humidity (RH). Specimens are allowed to gain moisture until they reach equilibrium weight, which is determined by measuring the mass of specimens every day, the endpoint of conditioning being indicated by specimens reaching a constant mass. This procedure represents very similar moisture gain to that which would be gained if specimens are held in 23° C. 50% RH atmosphere until reaching equilibrium moisture, which can take over 9 months depending on specimen thickness.

For each of the 7 test specimens, both 1.5 mm and 3 mm thickness plaques are conditioned in the humidity chambers according to the ISO 1110 procedure. For each test specimen and plaque thickness, three replicates are weighed to track moisture gain. In all cases, the three replicates give excellent agreement in weight gain.

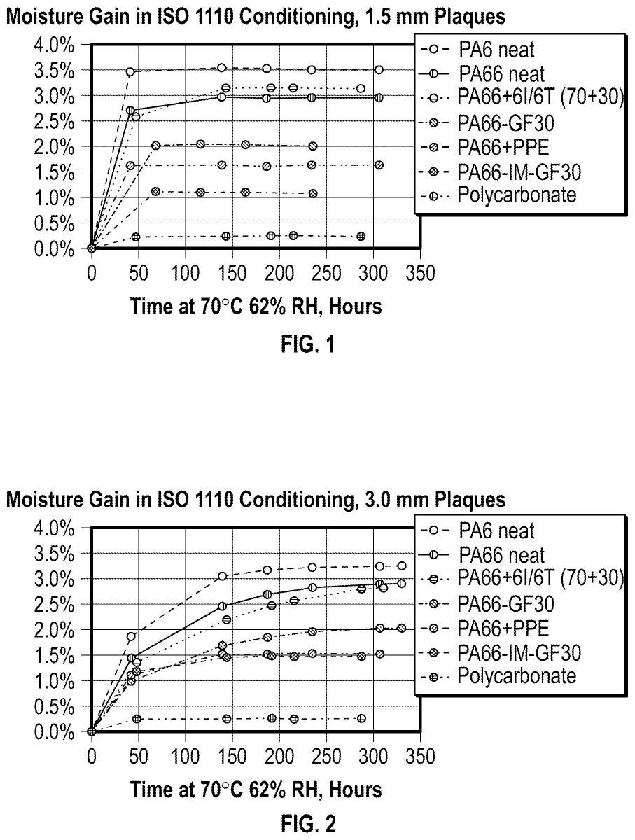

FIG. 1 (for 1.5 mm thick plaques) and FIG. 2 (for 3.0 mm thick plaques) show average weight gain (in wt % compared to initial DAM weight) for each tested specimen. Table 2 below lists the final equilibrium moisture levels for the seven tested specimens.

TABLE 2
Equilibrium Moisture Levels for Tested Specimens.

| | Final wt gain for | Final wt gain |
|---|---|---|
| Resin | 1.5 mm plaques | for 3.0 mm plaques |
| PA66 neat | 2.96% | 2.92% |
| PA6 neat | 3.50% | 3.26% |
| PA66 + 6I/6T (70 + 30) | 3.14% | 2.82% |
| PA66-GF30 | 2.01% | 2.04% |
| PA66 + PPE neat | 1.64% | 1.54% |
| PA66-IM-GF30 | 1.08% | 1.48% |
| Polycarbonate neat | 0.23% | 0.26% |

### Dielectric Constant and Dissipation Factor Measurements.

Approximately ⅛″ (3.175 mm) thick plaques of each material are used for dielectric constant and dissipation factor measurements using the guidelines of ASTM D2520, Method B. All plaques are approximately 3.9″×5.3″×0.12″.

Two replicates of each material (see Table 1) are prepared for testing at each required test frequency as noted below. Test frequencies included 3 GHz, 5 GHz, 10 GHz, 20 GHz, 30 GHz and 40 GHz.

Table 3 lists test samples sizes for each test frequency. All test samples are prepared so that test sample length corresponds to the plaque flow direction. Two plaques of each material (A-N in Table 1) are used to prepare the test samples. One replicate for each frequency is fabricated from each plaque.

TABLE 3
Test Sample Sizes.

| | Approximate |
|---|---|
| Test | Piece Size |
| Frequency | (Inches) |
| 3 GHz | 0.070 × 0.200 × 1.5 |
| 5 GHz | 0.090 × 0.140 × 1.5 |
| 10 GHz | 0.075 × 0.075 × 1.5 |
| 20 GHz | 0.050 × 0.050 × 1.5 |
| 30 GHz | 0.030 × 0.030 × 1.5 |
| 40 GHz | 0.025 × 0.025 × 1.5 |

All testing is conducted at laboratory ambient conditions. Test conditions are run at 24° C. and 46% RH. All samples are handled to limit exposure to laboratory ambient conditions during both sample preparation and testing.

### Dielectric Constant Measurements.

Testing is performed using the guidelines set forth in ASTM D2520, “Standard Test Methods for Complex Permittivity (Dielectric Constant) of Solid Electrical Insulating Materials at Microwave Frequencies and Temperatures to 1650 Degrees C.” Method B, Resonant Cavity Perturbation Technique, is used. The electric field inside the cavities is parallel to the length of the test samples. The measured dielectric constant data for all tested specimens at the six frequencies is listed in Table 4 below. Dielectric constant precision is about ±1% for the 3 GHz-20 GHz frequency range and about ±2% for the 30 GHz-40 GHz range. Results are shown in Table 4.

TABLE 4
Dielectric Constant Measurements.

| Frequency - | | | | | | | |
|---|---|---|---|---|---|---|---|
| Material | Sample | 3 | 5 | 10 | 20 | 30 | 40 |
| ID | ID | GHz | GHz | GHz | GHz | GHz | GHz |
| PA66 | A1 | 3.04 | 3.01 | 3.06 | 3.04 | 3.09 | 2.91 |
| | A2 | 3.02 | 3.02 | 3.07 | 3.05 | 3.09 | 2.91 |
| | B1 | 3.16 | 3.15 | 3.19 | 3.16 | 3.17 | 3.07 |
| | B2 | 3.17 | 3.15 | 3.20 | 3.16 | 3.16 | 3.09 |
| PA66-GF | C1 | 3.58 | 3.59 | 3.64 | 3.61 | 3.72 | 3.70 |
| | C2 | 3.57 | 3.59 | 3.65 | 3.60 | 3.75 | 3.64 |
| | D1 | 3.69 | 3.70 | 3.76 | 3.72 | 3.81 | 3.63 |
| | D2 | 3.67 | 3.70 | 3.76 | 3.71 | 3.79 | 3.69 |
| PA6 | E1 | 3.04 | 3.03 | 3.07 | 3.07 | 3.10 | 3.07 |
| | E2 | 3.03 | 3.02 | 3.08 | 3.06 | 3.13 | 3.05 |
| | F1 | 3.19 | 3.18 | 3.21 | 3.17 | 3.21 | 3.09 |
| | F2 | 3.20 | 3.17 | 3.23 | 3.18 | 3.21 | 3.09 |
| PA66-PPE | G1 | 2.76 | 2.77 | 2.81 | 2.81 | 2.87 | 2.83 |
| | G2 | 2.77 | 2.77 | 2.82 | 2.80 | 2.88 | 2.79 |
| | H1 | 2.84 | 2.83 | 2.86 | 2.85 | 2.88 | 2.82 |
| | H2 | 2.84 | 2.84 | 2.87 | 2.85 | 2.89 | 2.82 |
| PA Blend | I1 | 3.09 | 3.09 | 3.14 | 3.11 | 3.20 | 3.10 |
| | I2 | 3.08 | 3.10 | 3.15 | 3.11 | 3.20 | 3.11 |
| | J1 | 3.21 | 3.19 | 3.24 | 3.22 | 3.26 | 3.15 |
| | J2 | 3.19 | 3.19 | 3.25 | 3.22 | 3.26 | 3.12 |
| PA-IM-GF | K1 | 3.36 | 3.37 | 3.42 | 3.37 | 3.46 | 3.35 |
| | K2 | 3.36 | 3.37 | 3.43 | 3.37 | 3.44 | 3.42 |
| | L1 | 3.44 | 3.44 | 3.49 | 3.43 | 3.49 | 3.37 |
| | L2 | 3.43 | 3.45 | 3.51 | 3.43 | 3.51 | 3.38 |
| PC | M1 | 2.77 | 2.78 | 2.81 | 2.81 | 2.88 | 2.78 |
| | M2 | 2.78 | 2.78 | 2.81 | 2.80 | 2.86 | 2.78 |
| | N1 | 2.78 | 2.78 | 2.82 | 2.81 | 2.87 | 2.81 |
| | N2 | 2.79 | 2.79 | 2.83 | 2.81 | 2.86 | 2.80 |

### Dissipation Factor Measurements.

Testing is performed using the guidelines set forth in ASTM D2520, “Standard Test Methods for Complex Permittivity (Dielectric Constant) of Solid Electrical Insulating Materials at Microwave Frequencies and Temperatures to 1650 Degrees C.” Method B, Resonant Cavity Perturbation Technique, is used. The electric field inside the cavities is parallel to the length of the test samples. Dissipation factor resolution is about ±5% for 3 the GHz-20 GHz frequency range and ±10% for the 30 GHz-40 GHz range. Results are shown in Table 5.

TABLE 5
Dissipation Factor Measurements.

| Frequency - | | | | | | | |
|---|---|---|---|---|---|---|---|
| Material | Sample | 3 | 5 | 10 | 20 | 30 | 40 |
| ID | ID | GHz | GHz | GHz | GHz | GHz | GHz |
| PA66 | A1 | 0.0103 | 0.0099 | 0.0094 | 0.0099 | 0.0093 | 0.0086 |
| | A2 | 0.0105 | 0.0099 | 0.0095 | 0.0098 | 0.0095 | 0.0089 |
| | B1 | 0.0182 | 0.0166 | 0.0160 | 0.0182 | 0.0139 | 0.0133 |
| | B2 | 0.0176 | 0.0167 | 0.0161 | 0.0176 | 0.0138 | 0.0134 |
| PA66- | C1 | 0.0105 | 0.0104 | 0.0102 | 0.0091 | 0.0116 | 0.0132 |
| GF | C2 | 0.0106 | 0.0105 | 0.0104 | 0.0095 | 0.0116 | 0.0132 |
| | D1 | 0.0165 | 0.0156 | 0.0159 | 0.0128 | 0.0159 | 0.0164 |
| | D2 | 0.0164 | 0.0158 | 0.0156 | 0.0122 | 0.0159 | 0.0169 |
| PA6 | E1 | 0.0121 | 0.0114 | 0.0109 | 0.0104 | 0.0110 | 0.0124 |
| | E2 | 0.0123 | 0.0117 | 0.0111 | 0.0103 | 0.0114 | 0.0129 |
| | F1 | 0.0201 | 0.0188 | 0.0186 | 0.0207 | 0.0161 | 0.0151 |
| | F2 | 0.0206 | 0.0189 | 0.0182 | 0.0195 | 0.0159 | 0.0156 |
| PA66- | G1 | 0.0061 | 0.0060 | 0.0058 | 0.0060 | 0.0065 | 0.0065 |
| PPE | G2 | 0.0062 | 0.0060 | 0.0059 | 0.0058 | 0.0065 | 0.0065 |
| | H1 | 0.0095 | 0.0090 | 0.0091 | 0.0076 | 0.0079 | 0.0074 |
| | H2 | 0.0096 | 0.0089 | 0.0089 | 0.0077 | 0.0080 | 0.0074 |
| PA | I1 | 0.0121 | 0.0116 | 0.0110 | 0.0109 | 0.0111 | 0.0117 |
| Blend | I2 | 0.0120 | 0.0115 | 0.0109 | 0.0111 | 0.0112 | 0.0114 |
| | J1 | 0.0142 | 0.0136 | 0.0133 | 0.0114 | 0.0139 | 0.0136 |
| | J2 | 0.0144 | 0.0138 | 0.0135 | 0.0115 | 0.0138 | 0.0137 |
| PA-IM- | K1 | 0.0157 | 0.0143 | 0.0134 | 0.0143 | 0.0127 | 0.0129 |
| GF | K2 | 0.0157 | 0.0144 | 0.0134 | 0.0138 | 0.0130 | 0.0127 |
| | L1 | 0.0195 | 0.0174 | 0.0174 | 0.0134 | 0.0141 | 0.0135 |
| | L2 | 0.0197 | 0.0177 | 0.0172 | 0.0129 | 0.0143 | 0.0137 |
| PC | M1 | 0.0052 | 0.0051 | 0.0053 | 0.0060 | 0.0063 | 0.0064 |
| | M2 | 0.0052 | 0.0051 | 0.0053 | 0.0061 | 0.0062 | 0.0062 |
| | N1 | 0.0056 | 0.0055 | 0.0057 | 0.0061 | 0.0065 | 0.0061 |
| | N2 | 0.0057 | 0.0054 | 0.0057 | 0.0060 | 0.0065 | 0.0063 |

### Waveform Modeling:

The above dielectric constant and dissipation factor measurement data (Tables 4 and 5) for the seven tested specimens, DAM and conditioned, are used for the waveform modeling. Various commercial code packages are available for such modeling, for example, from Altair Feko™, comprehensive computational electromagnetics (CEM) code.

Using the waveform modeling, the transmission loss (in decibels, dB) as well as reflection (dB) at each of the tested frequencies (in GHz) for each of the seven test specimens (with respective thickness varied) is determined.

### Test Methods.

Mechanical testing includes testing for the following parameters. Tensile modulus is tested using ISO 527. Tensile strength is tested using ISO 527. Tensile elongation (break) is tested using ISO 527. Flexural modulus is tested using ISO 178. Flexural strength is tested using ISO 178. Notched Charpy impact is tested using ISO 179. Unnotched Charpy impact is tested using ISO 179. Fire retardancy (FR) testing can include testing for the following parameters. Material FR testing is conducted using UL 94. Flame testing is conducted using ASTM E84-3. Weatherability testing includes testing for the following parameters. Lifecycle UV testing (10 yr, 15 yr and 20 yr) is conducted using AATCC Method 16 Option 3. Color fade is determined by measuring change in color at specified points. Scratch testing is conducted using ASTM 50452. Paint adhesion testing is conducted for the following parameters. Cross-hatch testing is conducted using ISO 2409. Humidity and cross hatch tests are conducted together using ISO 6270-2 and ISO 554. A cross-hatch test after UV exposure is conducted according to ISO 2409.

### Example 1. Specimens (Dry and Wet) at 3 GHz Frequency

Table 6 illustrates data from Example 1.

TABLE 6

| | | Losses at 3 GHz | | | | | |
|---|---|---|---|---|---|---|---|
| | | Dry | | | | | |
| | | 1 | | 2 | | 3 | |
| | Fre- | Thick- | | Thick- | | Thick- | |
| | quency | ness | Loss | ness | Loss | ness | Loss |
| Material | (GHz) | (mm) | (dB) | (mm) | (dB) | (mm) | (dB) |
| PA66- | 3 | 2 | 0.058 | 3 | 0.21 | 6 | 0.422 |
| PPE | | | | | | | |
| | | Losses at 3 GHz | | | | | |
| | | Wet | | | | | |
| | | 1 | | 2 | | 3 | |
| | Fre- | Thick- | | Thick- | | Thick- | |
| | quency | ness | Loss | ness | Loss | ness | Loss |
| Material | (GHz) | (mm) | (dB) | (mm) | (dB) | (mm) | (dB) |
| PA66- | 3 | 2 | 0.067 | 3 | 0.234 | 6 | 0.459 |
| PPE | | | | | | | |

### Example 2. Specimens (Dry and Wet) at 28 GHz Frequency

Tables 7 and 8 illustrate data from Example 2.

TABLE 7

| | | Optimums 28 GHz | | | | | |
|---|---|---|---|---|---|---|---|
| | | Dry | | | | | |
| | | 1 | | 2 | | 3 | |
| | Fre- | Thick- | | Thick- | | Thick- | |
| | quency | ness | Loss | ness | Loss | ness | Loss |
| Material | (GHz) | (mm) | (dB) | (mm) | (dB) | (mm) | (dB) |
| PA66 | 28 | 3.032 | 0.127 | 6.078 | 0.254 | 9.122 | 0.383 |
| PA66-GF | 28 | 2.762 | 0.159 | 5.536 | 0.319 | 8.31 | 0.48 |
| PA66- | 28 | 3.144 | 0.089 | 6.298 | 0.178 | 9.452 | 0.267 |
| PPE | | | | | | | |
| PA | 28 | 2.978 | 0.152 | 5.97 | 0.306 | 8.962 | 0.46 |
| Blend | | | | | | | |
| PA-IM- | 28 | 2.868 | 0.176 | 5.75 | 0.353 | 8.63 | 0.531 |
| GF | | | | | | | |
| PC | 28 | 3.15 | 0.085 | 6.31 | 0.171 | 9.468 | 0.257 |

TABLE 8

| | | Optimums 28 GHz | | | | | |
|---|---|---|---|---|---|---|---|
| | | Wet | | | | | |
| | | 1 | | 2 | | 3 | |
| | Fre- | Thick- | | Thick- | | Thick- | |
| | quency | ness | Loss | ness | Loss | ness | Loss |
| Material | (GHz) | (mm) | (dB) | (mm) | (dB) | (mm) | (dB) |
| PA66 | 28 | 2.99 | 0.189 | 5.998 | 0.38 | 9.006 | 0.572 |
| PA66-GF | 28 | 2.732 | 0.218 | 5.476 | 0.438 | 8.222 | 0.661 |
| PA66- | 28 | 3.138 | 0.109 | 6.29 | 0.219 | 9.442 | 0.329 |
| PPE | | | | | | | |
| PA Blend | 28 | 2.948 | 0.189 | 5.912 | 0.38 | 8.874 | 0.572 |
| PA-IM- | 28 | 2.846 | 0.194 | 5.706 | 0.39 | 8.568 | 0.588 |
| GF | | | | | | | |
| PC | 28 | 3.152 | 0.089 | 6.314 | 0.178 | 9.476 | 0.267 |

### Example 3. Specimens (Dry and Wet) at 39 GHz Frequency

Tables 9 and 10 illustrate data from Example 3.

TABLE 9

| | | Optimums 39 GHz | | | | | | | |
|---|---|---|---|---|---|---|---|---|---|
| | | Dry | | | | | | | |
| | | 1 | | 2 | | 3 | | 4 | |
| | Frequency | Thickness | Loss | Thickness | Loss | Thickness | Loss | Thickness | Loss |
| Material | (GHz) | (mm) | (dB) | (mm) | (dB) | (mm) | (dB) | (mm) | (dB) |
| PA66 | 39 | 2.42 | 0.119 | 4.496 | 0.239 | 6.748 | 0.36 | 9 | 0.481 |
| PA66- | 39 | 1.998 | 0.181 | 4.002 | 0.363 | 6.008 | 0.547 | 8.014 | 0.732 |
| GF | | | | | | | | | |
| PA66- | 39 | 2.284 | 0.089 | 4.578 | 0.178 | 6.87 | 0.267 | 9.162 | 0.356 |
| PPE | | | | | | | | | |
| PA | 39 | 2.17 | 0.158 | 4.35 | 0.317 | 6.53 | 0.476 | 8.712 | 0.637 |
| Blend | | | | | | | | | |
| PA-IM- | 39 | 2.078 | 0.175 | 4.166 | 0.351 | 6.256 | 0.529 | 8.344 | 0.708 |
| GF | | | | | | | | | |
| PC | 39 | 2.296 | 0.086 | 4.602 | 0.172 | 6.906 | 0.259 | 9.212 | 0.345 |

TABLE 10

| | | Optimums 39 GHz | | | | | | | |
|---|---|---|---|---|---|---|---|---|---|
| | | Wet | | | | | | | |
| | | 1 | | 2 | | 3 | | 4 | |
| | Frequency | Thickness | Loss | Thickness | Loss | Thickness | Loss | Thickness | Loss |
| Material | (GHz) | (mm) | (dB) | (mm) | (dB) | (mm) | (dB) | (mm) | (dB) |
| PA66 | 39 | 2.178 | 0.182 | 4.366 | 0.366 | 6.554 | 0.551 | 8.744 | 0.737 |
| PA66- | 39 | 1.998 | 0.228 | 4.006 | 0.459 | 6.014 | 0.691 | 8.022 | 0.926 |
| GF | | | | | | | | | |
| PA66- | 39 | 2.28 | 0.101 | 4.568 | 0.202 | 6.856 | 0.304 | 9.144 | 0.406 |
| PPE | | | | | | | | | |
| PA | 39 | 2.156 | 0.186 | 4.326 | 0.374 | 6.496 | 0.564 | 8.666 | 0.754 |
| Blend | | | | | | | | | |
| PA-IM- | 39 | 2.08 | 0.186 | 4.172 | 0.374 | 6.264 | 0.562 | 8.354 | 0.752 |
| GF | | | | | | | | | |
| PC | 39 | 2.286 | 0.085 | 4.582 | 0.169 | 6.876 | 0.255 | 9.17 | 0.34 |

Examples 4-17 include figures showing test results for 1 mm thick panels that include various materials (e.g., polyamides, reinforced polyamides, and polycarbonates) for their transmission loss and reflection under wet and dry conditions. The results show that panels formed from polyamide materials, including reinforced polyamide materials, show superior transmission loss and reflection properties compared to panels formed from other materials such as polycarbonate. Surprisingly, given the hydrophilic nature of polyamides, those panels including a polyamide perform well when wet.

### Example 4. PA66 Specimens (Dry and Wet) at 28 GHz Frequency

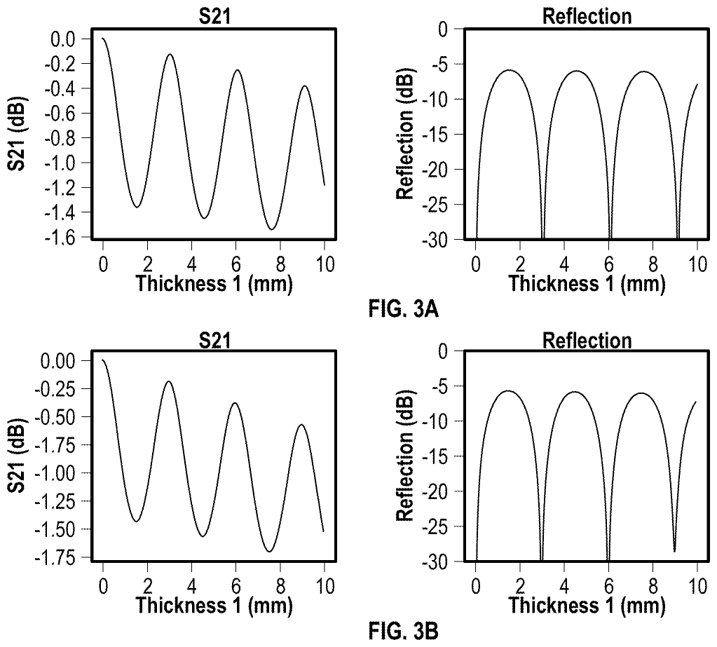

FIG. 3A (dry) and FIG. 3B (wet) are graphical data of the transmission loss (S21 in dB on the Y-axis) and reflection (in dB) as a function of specimen thickness (mm on the X-axis).

### Example 5. PA66 Specimens (Dry and Wet) at 39 GHz Frequency

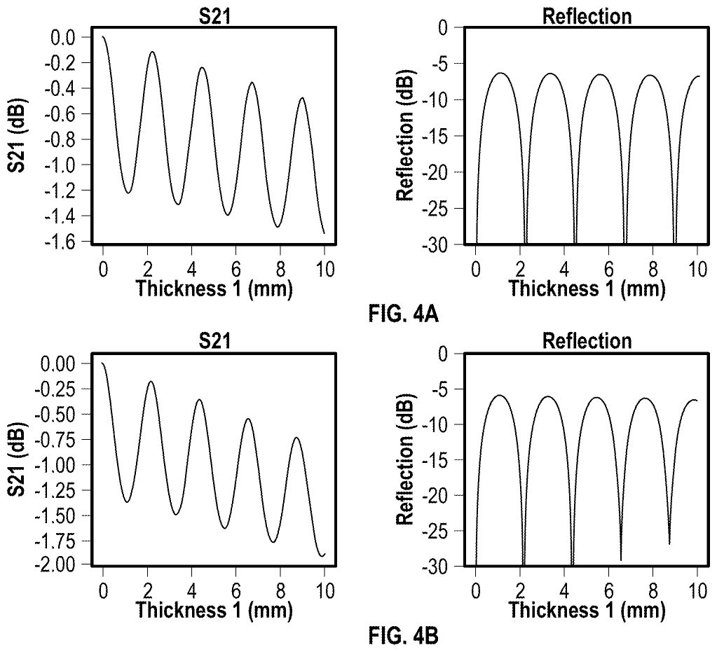

FIG. 4A (dry) and FIG. 4B (wet) are graphical data of the transmission loss (in terms of the scattering parameter S21, which is the ratio of the transmitted power to the incident power, provided in dB on the Y-axis) and reflection (in dB) as a function of specimen thickness (mm on the X-axis).

### Example 6. PA66-GF Specimens (Dry and Wet) at 28 GHz Frequency

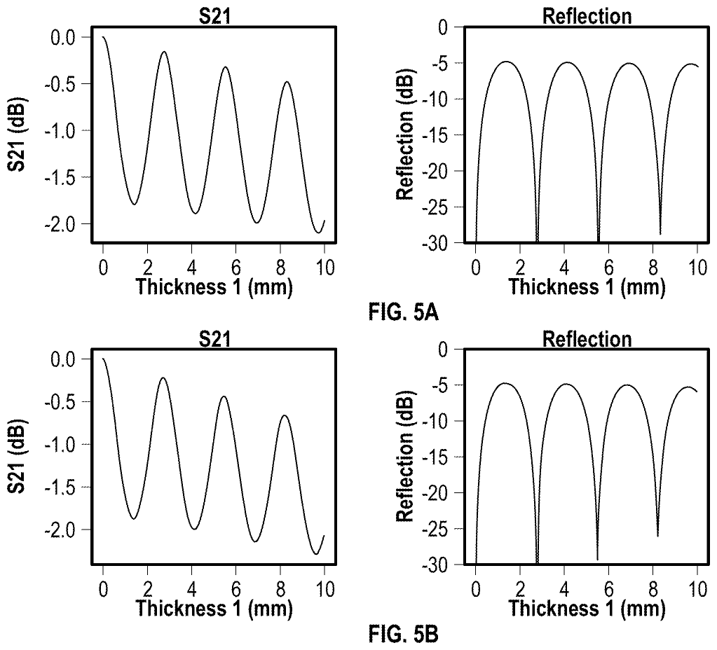

FIG. 5A (dry) and FIG. 5B (wet) are graphical data of the transmission loss (S21 in dB on the Y-axis) and reflection (in dB) as a function of specimen thickness (mm on the X-axis).

### Example 7. PA66-GF Specimens (Dry and Wet) at 39 GHz Frequency

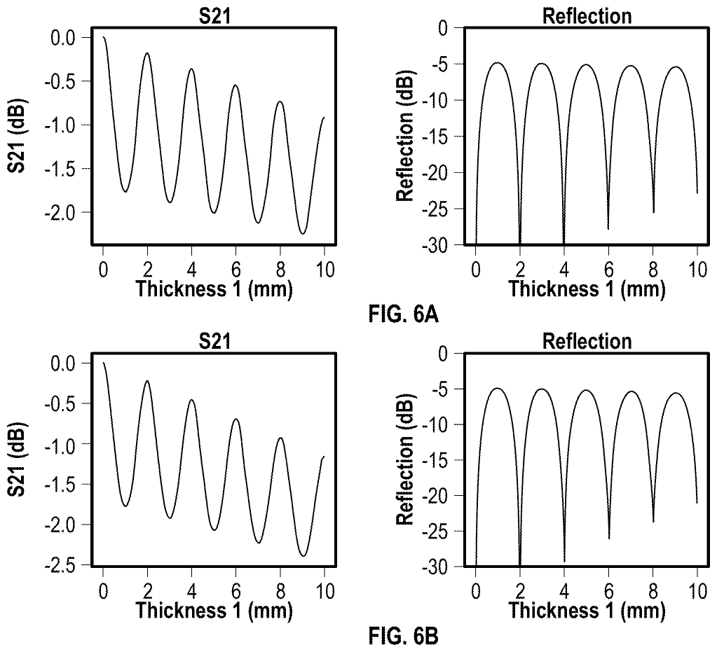

FIG. 6A (dry) and FIG. 6B (wet) are graphical data of the transmission loss (S21 in dB on the Y-axis) and reflection (in dB) as a function of specimen thickness (mm on the X-axis).

### Example 8. PA66-PPE Specimens (Dry and Wet) at 28 GHz Frequency

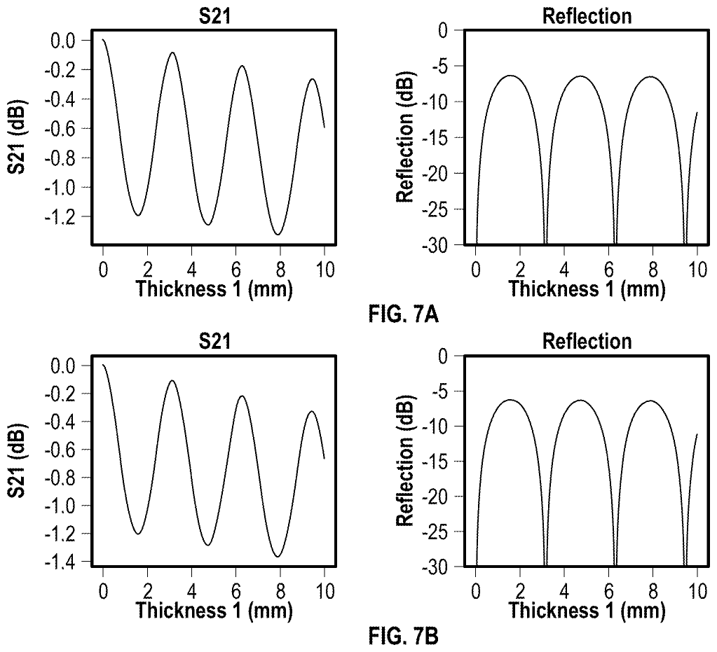

FIG. 7A (dry) and FIG. 7B (wet) are graphical data of the transmission loss (S21 in dB on the Y-axis) and reflection (in dB) as a function of specimen thickness (mm on the X-axis).

### Example 9. PA66-PPE Specimens (Dry and Wet) at 39 GHz Frequency

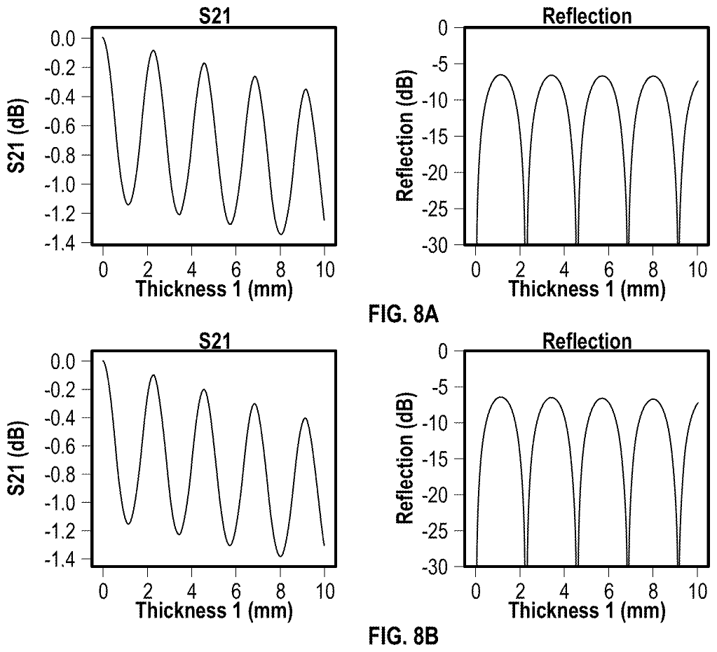

FIG. 8A (dry) and FIG. 8B (wet) are graphical data of the transmission loss (S21 in dB on the Y-axis) and reflection (in dB) as a function of specimen thickness (mm on the X-axis).

### Example 10. PA66-IM-GF30 Specimens (Dry and Wet) at 28 GHz Frequency

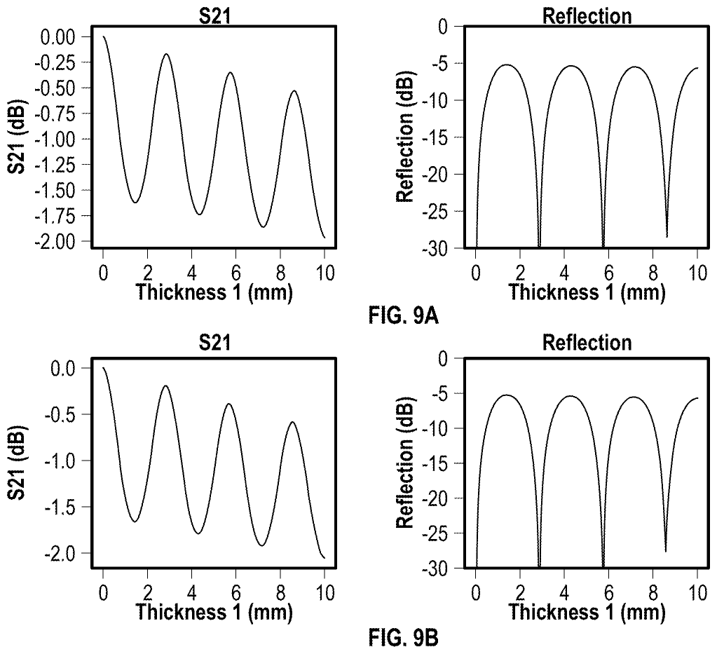

FIG. 9A (dry) and FIG. 9B (wet) are graphical data of the transmission loss (S21 in dB on the Y-axis) and reflection (in dB) as a function of specimen thickness (mm on the X-axis).

### Example 11. PA66-IM-GF30 Specimens (Dry and Wet) at 39 GHz Frequency

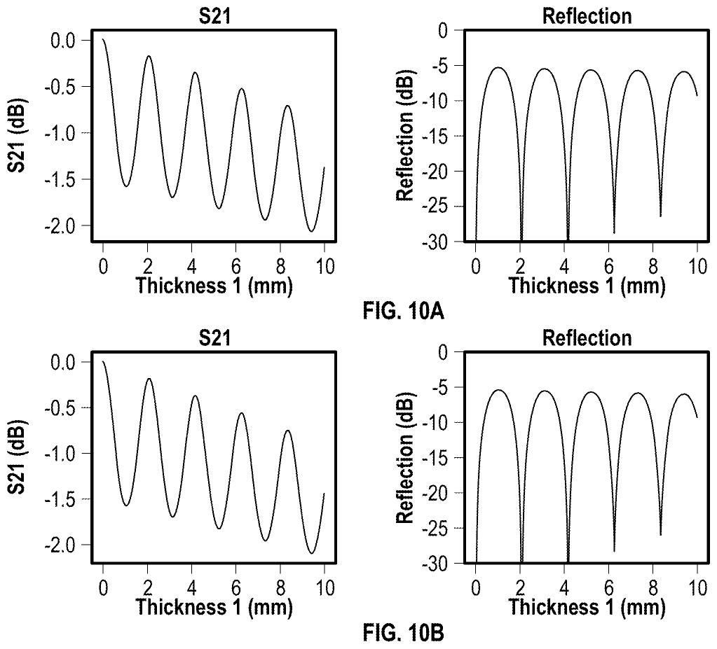

FIG. 10A (dry) and FIG. 10B (wet) are graphical data of the transmission loss (S21 in dB on the Y-axis) and reflection (in dB) as a function of specimen thickness (mm on the X-axis).

### Example 12. PC Specimens (Dry and Wet) at 28 GHz Frequency

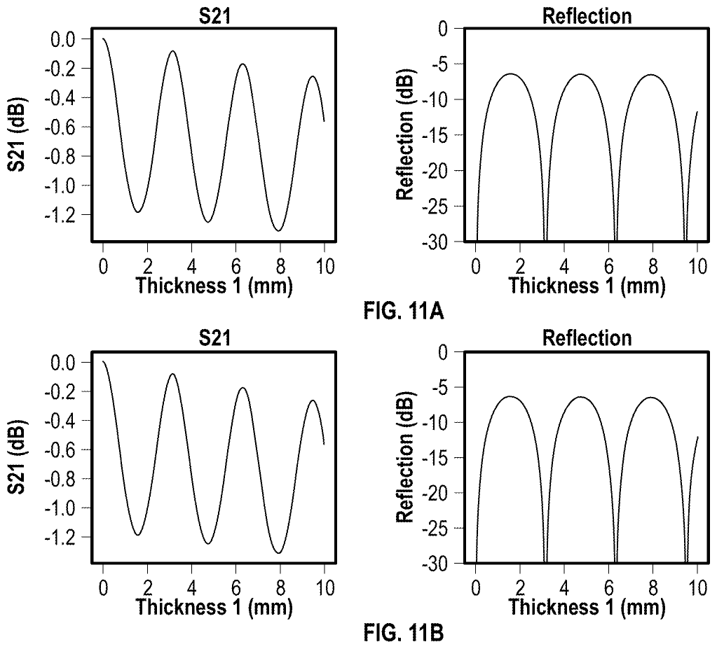

FIG. 11A (dry) and FIG. 11B (wet) are graphical data of the transmission loss (S21 in dB on the Y-axis) and reflection (in dB) as a function of specimen thickness (mm on the X-axis).

### Example 13. PC Specimens (Dry and Wet) at 39 GHz Frequency

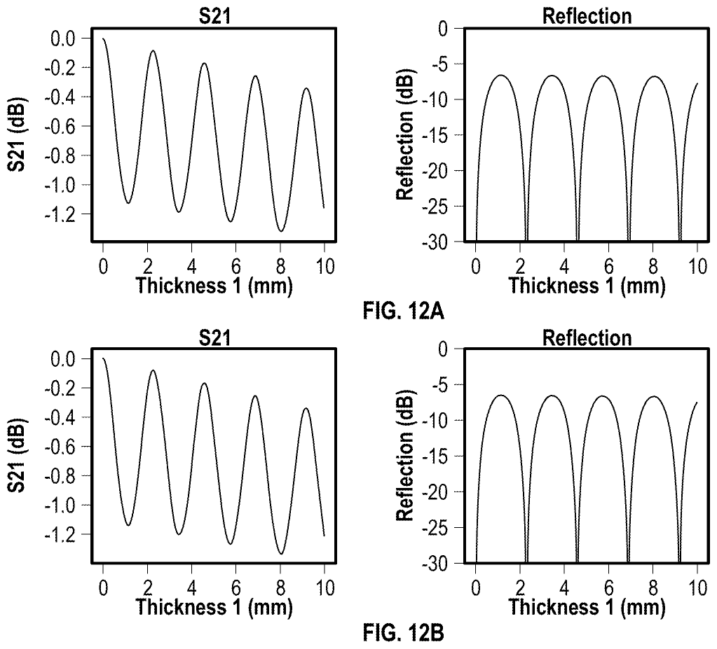

FIG. 12A (dry) and FIG. 12B (wet) are graphical data of the transmission loss (S21 in dB on the Y-axis) and reflection (in dB) as a function of specimen thickness (mm on the X-axis).

### Example 14. PA66+6I/6T (70/30) Blend Specimens (Dry and Wet) at 28 GHz Frequency

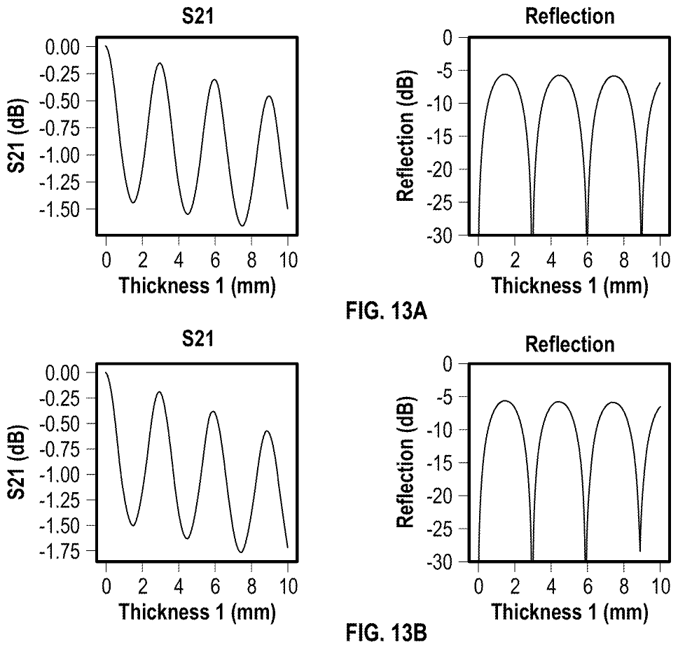

FIG. 13A (dry) and FIG. 13B (wet) are graphical data of the transmission loss (S21 in dB on the Y-axis) and reflection (in dB) as a function of specimen thickness (mm on the X-axis).

### Example 15. PA66+6I/6T (70/30) Blend Specimens (Dry and Wet) at 39 GHz Frequency

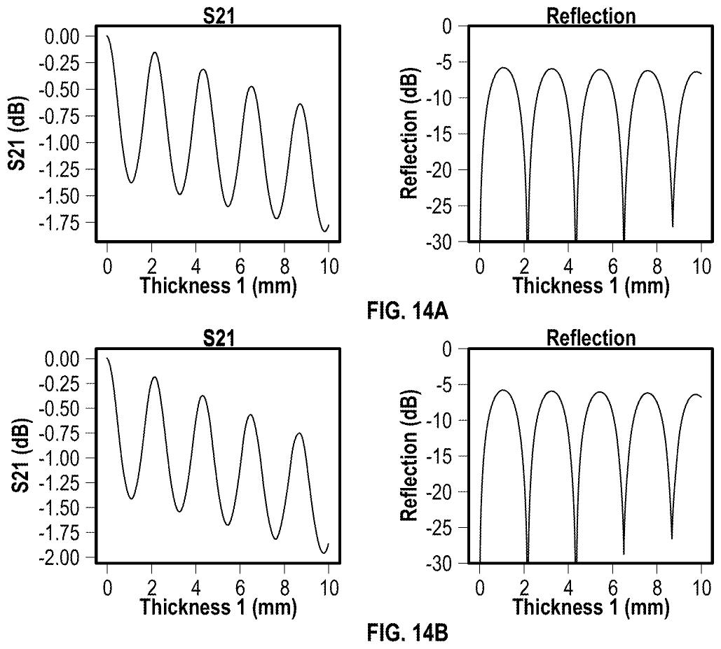

FIG. 14A (dry) and FIG. 14B (wet) are graphical data of the transmission loss (S21 in dB on the Y-axis) and reflection (in dB) as a function of specimen thickness (mm on the X-axis).

### Example 16. PA6 Specimens (Dry and Wet) at 28 GHz Frequency

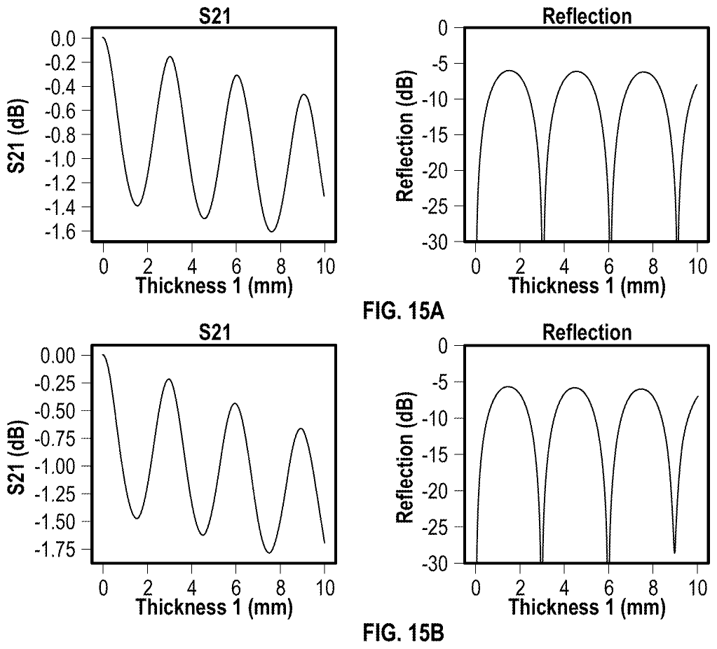

FIG. 15A (dry) and FIG. 15B (wet) are graphical data of the transmission loss (S21 in dB on the Y-axis) and reflection (in dB) as a function of specimen thickness (mm on the X-axis).

### Example 17. PA6 Specimens (Dry and Wet) at 39 GHz Frequency

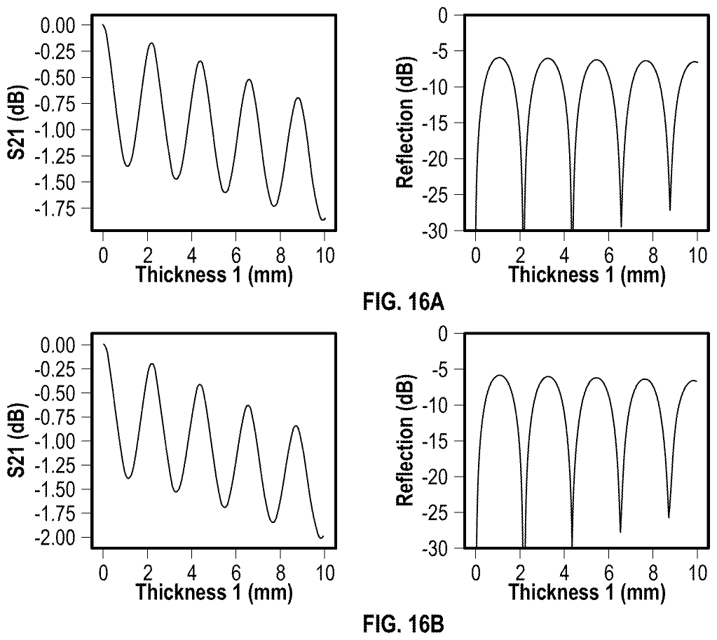

FIG. 16A (dry) and FIG. 16B (wet) are graphical data of the transmission loss (S21 in dB on the Y-axis) and reflection (in dB) as a function of specimen thickness (mm on the X-axis).

### Example 18. RF Testing—Insertion Loss Versus Distance at 24-40 GHz Wave Frequency

Several materials, as described in Table 1, are tested by molding the materials into 1 ft×1 ft flat plaques. These plaques are precision-machined to obtain about 2.18 mm structural thickness. A 0.25 mm thick basecoat of flame retardant (FR) material and 0.11 mm thick top-coat of decorative color are applied to each plaque using roller applicators. The coated plaque surfaces are somewhat rough due to the roller coat application. The total specimen structural thickness is 2.54 mm.

Using a horn antenna setup, the insertion loss in (S21 in dB) is measured in the far field in the 24-40 GHz wave frequency spectrum as a function of the plaque surface distance from the antenna.

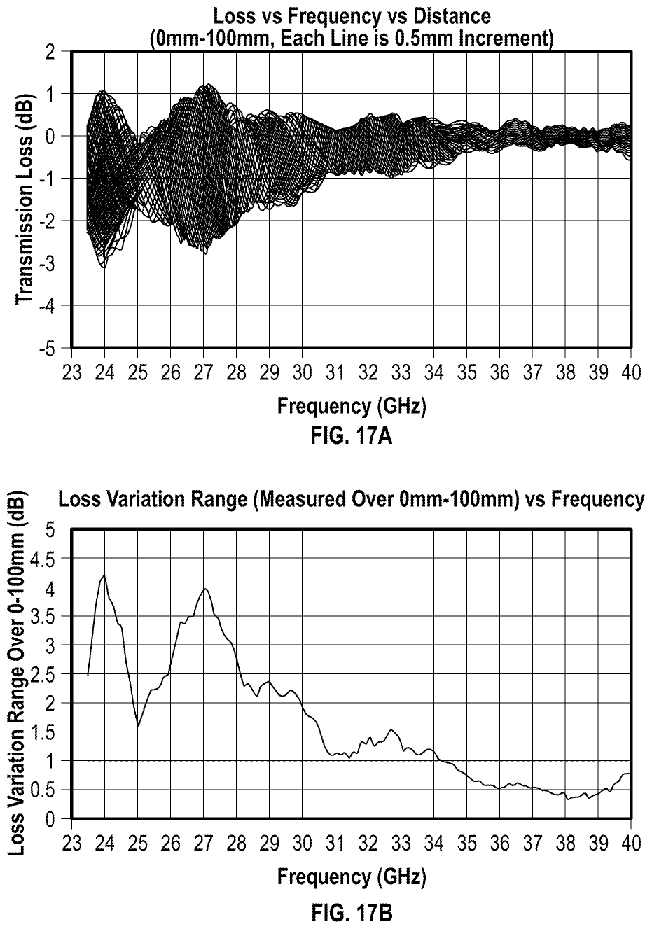

FIGS. 17A and 17B represent a cyclone plot showing insertion loss (dB) data measured for one of the tested plaques. FIG. 17A is a cyclone plot of the insertion loss in dB (Y-axis) measured over a 0-100 mm distance span in 0.5 mm increments over the 24-40 GHz wave frequency range (X-axis); each line shown is a 0.5 mm distance increment. FIG. 17B plots the insertion loss variation (Y-axis) of the tested plaque measured over a 0-100 mm distance variation and for the 24-40 GHz frequency range.

### Example 19. Array Antenna Testing at 28 GHz Wave Frequency

The plaque specimens, described in Example 18 above, are next tested using a phased array antenna tuned to 28 GHz.

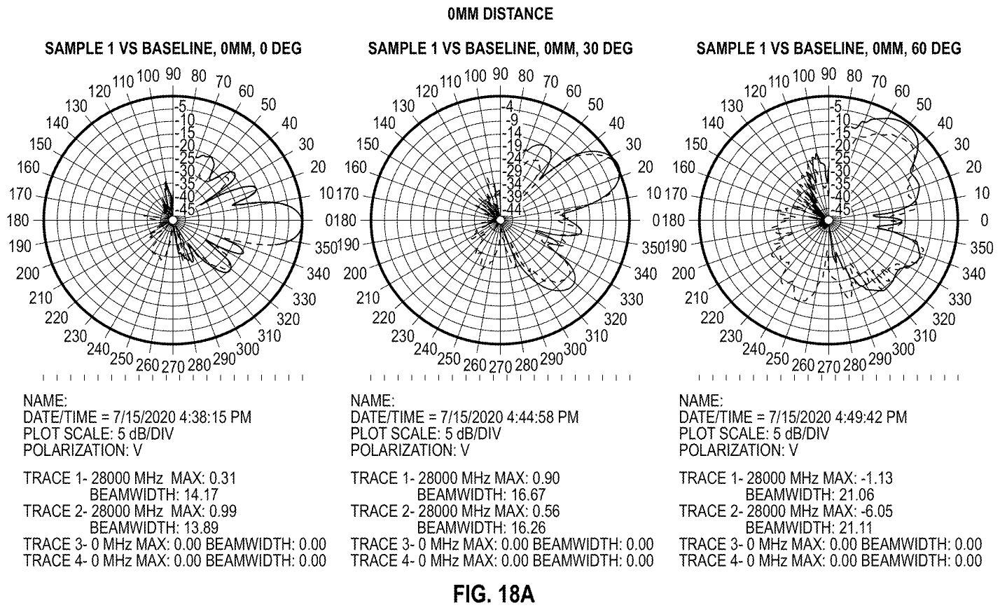

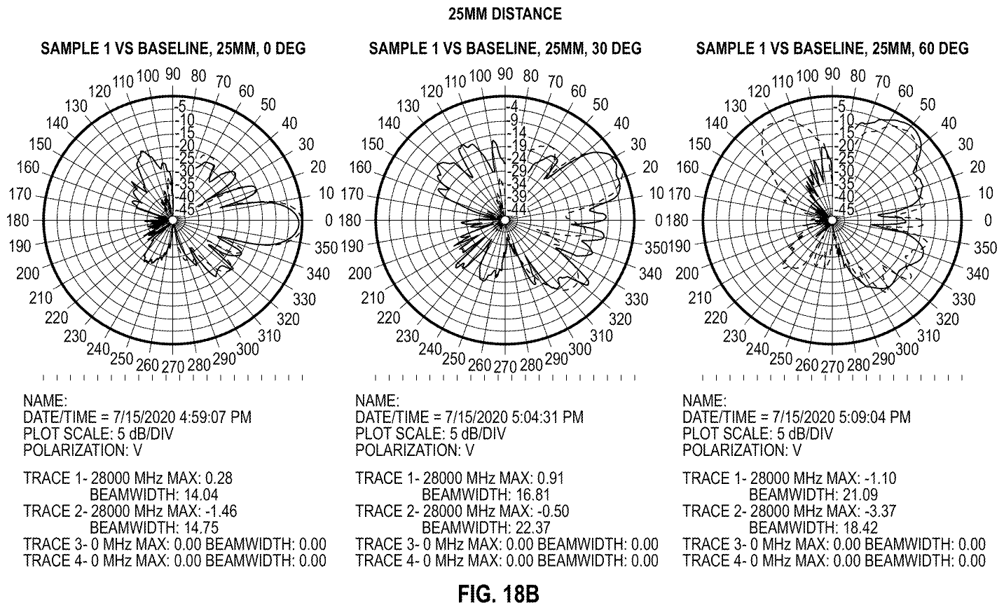

Changes in radiation as well as reflection patterns, for example, main lobe, side lobes, reflections, boresight error, and relative insertion losses (in dB), are measured at 28 GHz frequency and at two radio antenna distances, namely, i) close to each other, see “0 mm Distance” plots in FIG. 18A, and ii) few wavelengths apart, see “25 mm Distance” plots in FIG. 18B. Incident ray measurements for main beam bore sight loss, error, 3 dB beam width change, 1^{st} sidelobe gain increase, and backlobe/reflected lobes gain increase are performed at three azimuths, 0°, 30° and 60°. The term “azimuth” is an angular measurement in a spherical coordinate system. In FIGS. 18A and 18B, the solid line represents the baseline performance for the two antenna system without the in-between plaque specimen, and the dashed line represents the plaque performance tested with the two-antenna system at 0 mm and 25 mm distance spacing.

In FIG. 18A for “0 mm Distance”, the main lobe at each of the azimuths show little loss and the side lobes are improved.

### Example 20. Enclosure for Telecommunication Equipment in the 500 MHz-6 GHz Frequency Range

A three-dimensional enclosure is prepared from panels made of glass-fiber-reinforced thermoplastic polymer. The panel structural thickness is about 2 mm excluding the paint coatings. The enclosure houses telecommunication equipment, namely, radio, antenna, power supply. In the radio signal frequency range of between 500 MHz to 6 GHz, a signal attenuation between 1 dB and 0 dB is observed.

### Example 21. Enclosure for Telecommunication Equipment in the 24 GHz-30 GHz Frequency Range

A three-dimensional enclosure is prepared from panels made of glass-fiber-reinforced thermoplastic polymer. The panel structural thickness is about 3 mm, excluding the paint coatings. The enclosure houses telecommunication equipment, such as capacitors, actuators, power cable terminations, miniatured antenna, power transformer/power conditioner, optical fiber, radios, diplexer/multiplexer, coaxial cable, and their combinations, and may serve, e.g., as antenna concealment, cell phone casings, housing for an electronic component, fiber termination box, coaxial cable sheath, and the like. In the radio signal frequency range of between 24 GHz and 30 GHz, a signal attenuation between 1 dB and 0 dB is observed. The enclosures can optionally include a cell phone case or protective cover, or a backpack for carrying articles including electronic equipment.

### Example 22. Enclosure for Telecommunication Equipment in the 36 GHz-40 GHz Frequency Range

A three-dimensional enclosure is prepared from panels made of glass-fiber-reinforced thermoplastic polymer. The panel structural thickness is about 2 mm, excluding the paint coatings. The enclosure houses telecommunication equipment, such as capacitors, actuators, power cable terminations, miniatured antenna, power transformer/power conditioner, optical fiber, radios, diplexer/multiplexer, coaxial cable, and their combinations, and may serve as, e.g., antenna concealment, cell phone casings, housing for electronic components, fiber termination box, coaxial fiber sheath, and the like. In the radio signal frequency range of between 36 GHz and 40 GHz, a signal attenuation between 1 dB and 0 dB is observed.

### Comparative Example 1. Panel Having a Window for Electromagnetic Signal Transmission

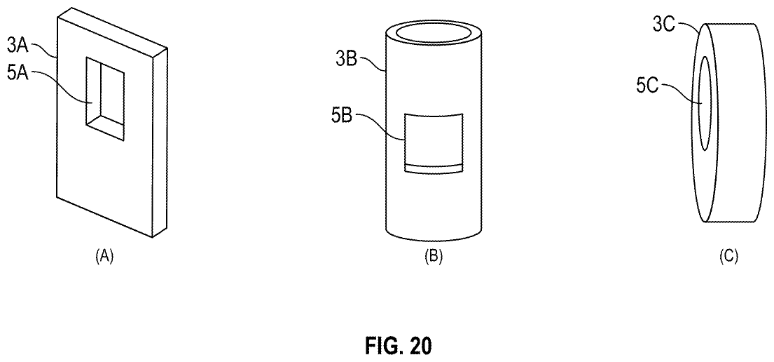

FIG. 20 illustrates schematic representations of panels 3A-3C. Panels 3A-3C include respective openings 5A-5C. Panels 3A-3C can have a number of suitable geometric shapes such as a square shape, rectangular shape (3A), cylindrical shape (3B), disc shape (3C), or any other suitable shape.

An enclosure (not shown) formed from one or more of such panels can house one or more items of electromagnetic equipment. Examples of electromagnetic equipment include, for instance, a three-phase electrical wire terminated into a circuit breaker/disconnect; a power transformer/power conditioner; an optical fiber wire and fiber termination box; a radio or radios; a diplexer/multiplexer (per radio); a coaxial cable from radio to antenna(s); or an antennae. This enclosure may also require a coax penetration to a remote antenna mount location. The enclosure is designed to accommodate any target application and has temperature control systems (fans, vent holes, or slots), access doors (screwed on, clipped on, hinged) for internals, and mounting accessories (brackets, screwed mounts, swivel mounts, sliding guides), and the like.

Opening 5A, 5B, or 5C, may be fitted with a window structure or assembly constructed from any suitable material that enables the transmission of an electromagnetic signals. Examples include mono- or multi-layered transparent films, sheets, glass cover, metal or plastic mesh, and such. There may be multiple such openings of different shapes and sizes to accommodate the electromagnetic signal conveyance with reduced signal strength loss.

While such panel(s) and the enclosure(s) formed therefrom may be of any suitable material such as polymer, plastic, foam, metal, composites, etc., incorporation of opening(s) necessary for signal transmission make such enclosures complex to design, fabricate, mount, and maintain. Furthermore, such panels and enclosures made therefrom having openings or windows fitted with materials different from the panel materials make such structures less durable (e.g., short life cycle) while compromising their structural integrity, mechanical strength and impact resistance. An enclosure is deemed “windowless” as used in the instant disclosure if it lacks such an opening or window that is fitted with a material different from the panel material.

### Example 23. Panel Through which Electromagnetic Signals are Transmitted or Received

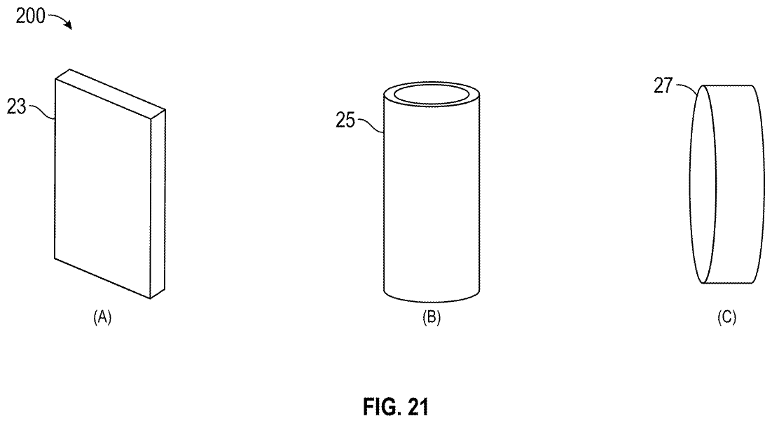

FIG. 21 illustrates schematic representations of enclosures 23, 25, and 27. Compared to Comparative Example 1, enclosures 23, 25, and 27 have a thickness as described in the Examples herein and have no separate opening or window for transmission or receival of electromagnetic signal. The enclosure may be of any suitable geometric shape such as square, rectangular (enclosure 23 in FIG. 21), cylindrical (enclosure 25 in FIG. 21), disc (enclosure 27 in FIG. 21), dome-shaped, cone-shaped, or any suitable shape.

The formed enclosure is part of a continuously molded article. The article described in this example can be useful for providing weather-resistant shielding for electronic equipment. Such an enclosure (not shown), or articles formed from one or more of such enclosures, can house one or more items of electromagnetic equipment. The electronic equipment can include, for example, a three-phase electrical wire terminated into a circuit breaker/disconnect; a power transformer/power conditioner; an optical fiber wire and fiber termination box; a radio or radios; a diplexer/multiplexer (per radio); a coaxial cable from radio to antenna(s); an antennae. This enclosure may also require a coax penetration to a remote antenna mount location. The enclosure is designed to accommodate any target application and has temperature control systems (fans, vent holes, or slots), access doors (screwed on, clipped on, hinged) for internals, and mounting accessories (brackets, swivel mounts, slider mounts), and such.

Absence of any opening(s) or window(s) while transmission and receival of electromagnetic signals occur though an enclosure body make such enclosures simple to design, fabricate, mount, and maintain. Furthermore, such panels and enclosures made therefrom, absent openings or windows fitted with materials different from the panel materials, make such structures more durable (e.g., long-lasting) with their structural integrity, strength, and impact resistance well-preserved.

### Example 24. PA66-Based Panel and Enclosure Through which 30 GHz Frequency Electromagnetic Signals are Transmitted or Received

Several panel structures are molded using a PA66 based thermoplastic resin labeled “PA66-IM-GF30” and corresponding to Specimen labeled “L” (50% RH) in Table 1 of the present disclosure. PA66-IM-GF30 is prepared using INVISTA™ PA66 material and further containing impact modified polyolefin with 30 wt % glass fiber (GF) reinforcement. The densities of four panels are 1.097, 1.244, 1.277 and 1.361 g/cc.

The so-formed panels are joined to form a three-dimensional rectangular enclosure having the dimensions of 48″ L×24″ W×12″ D (or, 4′ L×2′ W×1′ D). Proper network telecommunication equipment is housed inside the enclosure. The enclosure contains no separate opening or windows having any transparent medium such as film, glass covering, sheet, or the like. The PA66-IM-GF30 resin specimen has a dielectric constant of 3.5 and dissipation factor (DF) of 0.0142, both measured at 30 GHz frequency.

The panel wall structural thickness is maintained to about 3 mm for the transmission and receival of 30 GHz frequency electromagnetic signal having less than 0.5 dB loss during its transmission across the panel wall. This electromagnetic signal transmission and reception do not occur through a transparent or optical window.

### Example 25. PA66-Based Panel and Enclosure Through which 40 GHz Frequency Electromagnetic Signals are Transmitted or Received

Several panel structures are molded using a PA66 based thermoplastic resin labeled “PA66-PPE”, which corresponds to Specimen labeled “H” (50% RH) in Table 1 of the present disclosure. PA66-PPE is an unreinforced thermoplastic resin. The densities of the panels are ≥1.1 g/cc and ≤1.4 g/cc.

The so-formed panels are joined to form a three-dimensional cylindrical enclosure having the dimensions of from about 22′ to about 36″ outside diameter and from about 0.5′ to about 6.5′ length (or, 3′ O.D×5′ long cylinder). Proper network telecommunication equipment is housed inside the enclosure. The enclosure contains no separate opening or windows having any transparent medium such as film, glass covering, sheet, and the like. The PA66-PPE resin specimen have a dielectric constant of about 2.82 and a dissipation factor (DF) of about 0.0074, both measured at 40 GHz frequency.

The panel wall structural thickness is maintained to about 4 mm for the transmission and receival of 40 GHz frequency electromagnetic signal having less than 0.5 dB loss during its transmission across the panel wall. This electromagnetic signal transmission and receival did not occur through a transparent or optical window.

### Example 26. PA66-Based Panel and Enclosure Through which Sub-6 GHz (3 GHz) Frequency Electromagnetic Signals are Transmitted or Received

Several panel structures are molded using a PA66 based thermoplastic resin labeled “PA66-PPE”, which corresponds to Specimen labeled “H” (c50% RH) in Table 1 of the present disclosure. PA66-PPE is an unreinforced thermoplastic resin. The density of the panel is ≥1.1 g/cc and ≤1.4 g/cc.

The formed panels are joined to form a three-dimensional clamshell-shaped enclosure intended for sub-6 GHz 5G and 4G LTE radio equipment shrouds. Proper network telecommunication equipment is housed inside the enclosure. The enclosure contains no separate opening or windows having any transparent medium such as film, glass covering, sheet, and the like. The PA66-PPE resin specimen has a dielectric constant of about 2.84 and a dissipation factor (DF) of about 0.0095, both measured at 3 GHz frequency.

The panel wall structural thickness is maintained to about 4 mm for the transmission and receival of 3 GHz frequency electromagnetic signal having less than 0.5 dB loss during its transmission across the panel wall. This electromagnetic signal transmission and receival does not occur through a transparent or optical window.

The present polyamide-based clamshell radio shroud weighs about 20-25 lbs and offers cost-efficient, durable solution in sub-6 GHz 5G and 4G LTE radio frequency transmission markets. An equivalent metal shroud having the necessary openings for radio wave transmission and receival functions is more expensive, less durable and heavier (˜60-70 lbs).

### Example 27. RF Testing—Insertion Loss Versus Distance at 24-40 GHz Wave Frequency

Similar to Example 18, a horn antenna setup is used to measure the insertion loss (S21 in dB) in the far field in the 24-40 GHz wave frequency spectrum as a function of the test specimen plaque surface distance from the antenna. Several materials, as described in Table 1, are tested by molding the materials into 1 ft×1 ft flat plaques. These plaques are precision-machined to obtain about 2.18 mm structural thickness. A 0.56 mm thick basecoat of flame retardant (FR) material and 0.15 mm thick top-coat of decorative color are applied to each plaque using spray coating technology. The total specimen structural thickness is 2.89 mm.

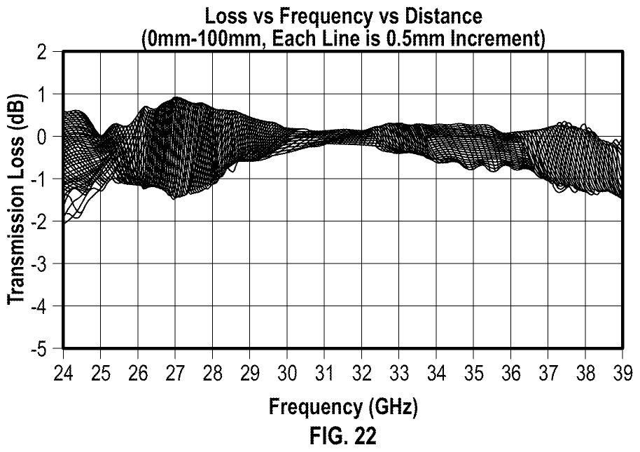

FIG. 22 is a cyclone plot of the insertion loss in dB (Y-axis) measured over a 0-100 mm distance span in 0.5 mm increments over a 24-40 GHz frequency range (X-axis); each line shown is a 0.5 mm distance increment.

### Example 28. Array Antenna Testing at 28 GHz Wave Frequency

The plaque specimens, described in Example 27 above, are next tested using a phased array antenna tuned to 28 GHz.

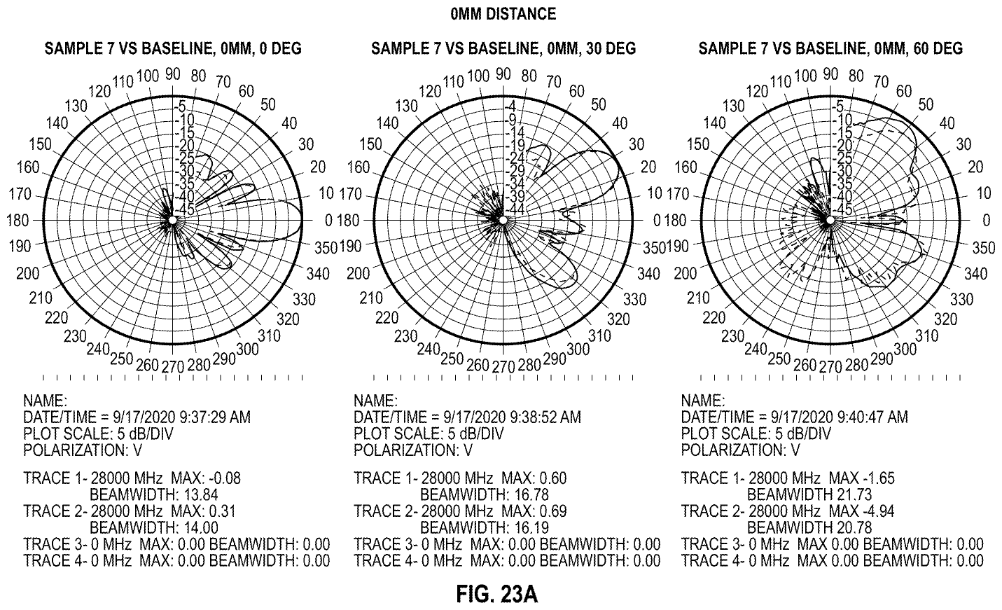

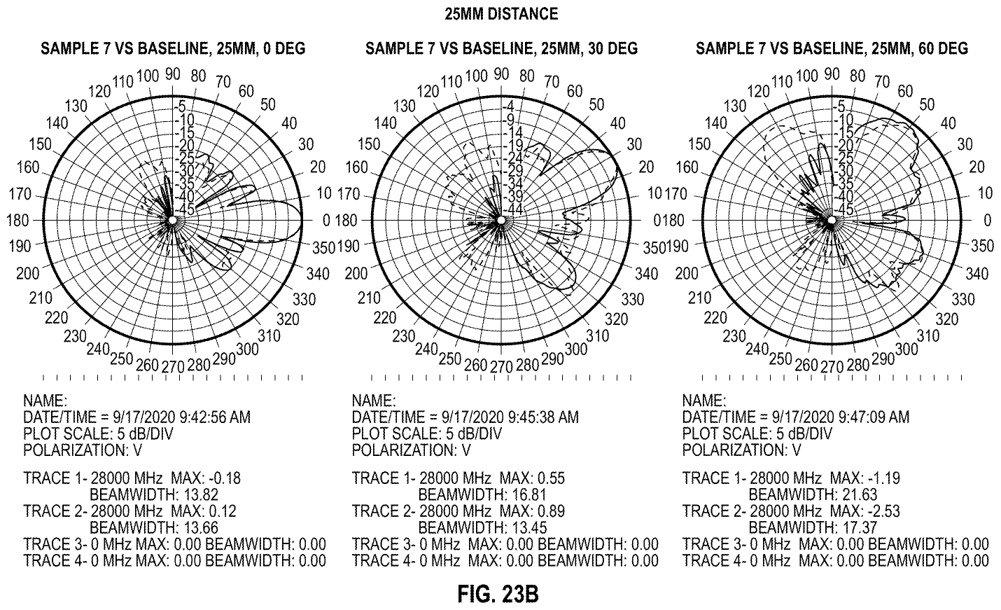

Changes in radiation as well as reflection patterns, for example, main lobe, side lobes, reflections, boresight error, and relative insertion losses (in dB), are measured at 28 GHz frequency and at two radio antenna distances, namely, i) close to each other (“0 mm Distance” plots in FIG. 23A), and ii) a few wavelengths apart (“25 mm Distance”) plots in FIG. 23B. Incident ray measurements for main beam bore sight loss, error, 3 dB beam width change, 1^{st} sidelobe gain increase, and backlobe/reflected lobes gain increase, are performed at three azimuths, 0°, 30°, and 60°.

In FIGS. 23A-23B, the solid lines represent the baseline performance for the two-antenna system without the in-between plaque specimen, and the dashed lines represent the plaque performance tested with the two-antenna system at 0 mm and 25 mm distance spacing.

In FIGS. 23A-23B, for “0 mm Distance” and “25 mm Distance,” respectively, the main lobe at each of the azimuths show little loss and the side lobes are improved compared to the ones in FIGS. 18A-18B in Example 19.

### Example 29. Mechanical Performance Data for Table 1 Specimens

Some of the material specimens from Table 1 are tested for mechanical performance. Specifically, specimens for material labeled “G” [DAM] and “H” [Cond] for PA66+PPE, as well as materials labeled “C” [DAM” and “D” [Cond] for PA66+GF30 are tested. Additional specimens are prepared using 20 wt % GF reinforced PA66+PPE and 20 wt % GF reinforced PA66 materials (not shown in Table 1), referred to as “PA66+PPE GF20” and “PA66 GF20”, respectively. Tables 11A-F below provide the mechanical performance data for the tested specimens at three temperatures: −40° C., 23° C., and 50° C.

TABLE 11A
Tensile Data for Dry as Molded [DAM] Specimens.

| | | Tensile | Elong- | Tensile | | Tensile | |
|---|---|---|---|---|---|---|---|
| | Table | strength | ation | strength | Nomi- | modulus | |
| | 1 | Tensile | Nominal | Tensile | nal | Modulus | |
| | refer- | stress at | yield | stress at | break | of | |
| Mater- | ence | yield | strain | break | strain | elasticity | Temp |
| ial | label | (MPa) | (%) | (MPa) | (%) | (MPa) | (° C.) |
| PA66 + | “G” | 60.8 | 5 | 59.9 | >59 | 2640 | 23 |
| PPE | | 90.5 | 7.8 | 87.4 | 34 | 2980 | −40 |
| | | 48.7 | 26 | 51.3 | 86 | 1820 | 50 |
| PA66 + | | 127 | 3.8 | 123 | 5.3 | 6730 | 23 |
| PPE | | 180 | 4.9 | 179 | 4.9 | 7130 | −40 |
| GF 20 | | 103 | 4.9 | 100 | 7.5 | 5590 | 50 |
| PA66 | | | | 147 | 3.4 | 7190 | 23 |
| GF 20 | | | | 173 | 3 | 7460 | −40 |
| | | 115 | 5.1 | 111 | 9.6 | 6050 | 50 |
| PA66 | “C” | 184 | 3.8 | 182 | 4.4 | 10100 | 23 |
| GF 30 | | | | 237 | 3.3 | 10200 | −40 |
| | | 147 | 5.1 | 144 | 6.7 | 8370 | 50 |

TABLE 11B
Tensile Data for Conditioned [COND] Specimens.

| | | Tensile | Elong- | Tensile | | Tensile | |
|---|---|---|---|---|---|---|---|
| | Table | strength | ation | strength | Nomi- | modulus | |
| | 1 | Tensile | Nominal | Tensile | nal | Modulus | |
| | refer- | stress at | yield | stress at | break | of | |
| Mater- | ence | yield | strain | break | strain | elasticity | Temp |
| ial | label | (MPa) | (%) | (MPa) | (%) | (MPa) | (° C.) |
| PA66 + | “H” | 49 | 16 | 52.9 | 100 | 1600 | 23 |
| PPE | | 88 | 7.2 | 84.4 | 38 | 3310 | −40 |
| | | 41.4 | 18 | 43.6 | 96 | 1250 | 50 |
| PA66 + | | 100 | 5 | 97.2 | 7.8 | 5280 | 23 |
| PPE | | 166 | 4.2 | 163 | 4.1 | 7350 | −40 |
| GF 20 | | 85.9 | 5.8 | 83.9 | 8.3 | 4700 | 50 |
| PA66 | | 94.6 | 8.4 | 91.1 | 13 | 4460 | 23 |
| GF 20 | | | | 174 | 3.1 | 8680 | −40 |
| | | 80.8 | 9.9 | 78.3 | 13 | 3570 | 50 |
| PA66 | “D” | 127 | 6.5 | 125 | 8.2 | 6830 | 23 |
| GF 30 | | | | 229 | 3.3 | 10900 | −40 |
| | | 107 | 8.1 | 105 | 9.5 | 5440 | 50 |

TABLE 11C
Un-notched Charpy Data for DAM and Conditioned Specimens.

| | Table 1 | | | | | |
|---|---|---|---|---|---|---|
| | reference | | | Conditioned | Temp | Break |
| Material | label | Units | DAM | (ISO-1110) | (° C.) | type |
| PA66 + | “G” for | kJ/m² | 370 | 340 | 23 | Non |
| PPE | DAM and | | | | | break |
| | “H” for | kJ/m² | 400 | 420 | −40 | Non |
| | condi- | | | | | break |
| | tioned | kJ/m² | 310 | 240 | 50 | Non |
| | | | | | | break |
| PA66 + | | kJ/m² | 82 | 76 | 23 | Complete |
| PPE | | kJ/m² | 88 | 78 | −40 | Complete |
| GF 20 | | kJ/m² | 79 | 73 | 50 | Complete |
| PA66 | | kJ/m² | 53 | 98 | 23 | Complete |
| GF 20 | | kJ/m² | 49 | 45 | −40 | Complete |
| | | kJ/m² | 72 | 110 | 50 | Complete |
| PA66 | “C” for | kJ/m² | 89 | 110 | 23 | Complete |
| GF 30 | DAM and | kJ/m² | 66 | 59 | −40 | Complete |
| | “D” for | kJ/m² | 100 | 120 | 50 | Complete |
| | condi- | | | | | |
| | tioned | | | | | |

TABLE 11D
Notched Charpy Data for DAM and Conditioned Specimens.

| | Table 1 | | | | | |
|---|---|---|---|---|---|---|
| | reference | | | Conditioned | Temp | Break |
| Material | label | Units | DAM | (ISO-1110) | (° C.) | type |
| PA66 + | “G” for | kJ/m² | 20 | 24 | 23 | Complete |
| PPE | DAM and | kJ/m² | 16 | 12 | −40 | Complete |
| | “H” for | kJ/m² | 23 | 35 | 50 | Complete |
| | conditioned | | | | | |
| PA66 + | | kJ/m² | 11 | 11 | 23 | Complete |
| PPE | | kJ/m² | 8 | 7.3 | −40 | Complete |
| GF 20 | | kJ/m² | 12 | 14 | 50 | Complete |
| PA66 | | kJ/m² | 7.2 | 10 | 23 | Complete |
| GF 20 | | kJ/m² | 6.4 | 6.9 | −40 | Complete |
| | | kJ/m² | 8.5 | 22 | 50 | Complete |
| PA66 | “C” for | kJ/m² | 11 | 15 | 23 | Complete |
| GF 30 | DAM and | kJ/m² | 8.9 | 8.8 | −40 | Complete |
| | “D” for | kJ/m² | 14 | 27 | 50 | Complete |
| | conditioned | | | | | |

TABLE 11E
Flexural Data for DAM Specimens.

| | Table 1 | | | Flexural | | |
|---|---|---|---|---|---|---|
| | ref- | Flexural | Flexural | stress at | Flexural | |
| | erence | stress at | strain at | 3.5% strain | modulus | Temp |
| Material | label | yield | yield | (MPa) | (MPa) | (° C.) |
| PA66 + | “G” | | | 81.9 | 2380 | 23 |
| PPE | | | | 93.4 | 2600 | −40 |
| | | | | 44.9 | 1490 | 50 |
| PA66 + | | | | 171 | 5440 | 23 |
| PPE | | | | 195 | 5670 | −40 |
| GF 20 | | | | 125 | 4370 | 50 |
| PA66 | | | | 198 | 6050 | 23 |
| GF 20 | | 261 | 4.5 | 220 | 6190 | −40 |
| | | | | 144 | 5090 | 50 |
| PA66 | “C” | 280 | 4.9 | 252 | 8280 | 23 |
| GF 30 | | 341 | 4.6 | 289 | 8290 | −40 |
| | | | | 178 | 6660 | 50 |

TABLE 11F
Flexural Data for Conditioned Specimens.

| | Table 1 | | | Flexural | | |
|---|---|---|---|---|---|---|
| | ref- | Flexural | Flexural | stress at | Flexural | |
| | erence | stress at | strain at | 3.5% strain | modulus | Temp |
| Material | label | yield | yield | (MPa) | (MPa) | (° C.) |
| PA66 + | “H” | | | 47.4 | 1460 | 23 |
| PPE | | | | 97.6 | 2830 | −40 |
| | | | | 37 | 1120 | 50 |
| PA66 + | | | | 129 | 4430 | 23 |
| PPE | | 241 | 4.9 | 201 | 6000 | −40 |
| GF 20 | | | | 108 | 3740 | 50 |
| PA66 | | | | 107 | 3730 | 23 |
| GF 20 | | 256 | 4.3 | 226 | 6480 | −40 |
| | | | | 85.8 | 2890 | 50 |
| PA66 | “D” | | | 145 | 5360 | 23 |
| GF 30 | | 331 | 4.3 | 296 | 9250 | −40 |
| | | | | 118 | 4420 | 50 |

### Example 30

This Example illustrates ranges of thicknesses for nylon-6,6 free of glass reinforcing fibers (Example 30a), nylon-6,6 containing 30 weight percent glass reinforcing fibers (Example 30b) and polycarbonate (Example 30c).

TABLE 12A
Example 30a-Nylon-6,6 with no added glass fiber.

| | Thickness range to achieve | |
|---|---|---|
| Frequency, | less than 1 dB | |
| GHz | Min | Max |
| 0.5 | 0 mm | 5.136 mm |
| 6 | 0 mm | 4.28 mm |
| 24 | 2.53 mm | 4.39 mm |
| 30 | 2.00 mm | 3.55 mm |
| 36 | 1.66 mm | 3.04 mm |
| 40 | 1.49 mm | 2.73 mm |
| 76 | 1.96 mm | 2.52 mm |
| 81 | 1.84 mm | 2.37 mm |

TABLE 12B
Example 30b-Nylon-6,6 with
30% by weight glass fiber.

| | Thickness range to achieve | |
|---|---|---|
| Frequency, | less than 1 dB | |
| GHz | Min | Max |
| 0.5 | 0 mm | 3.911 mm |
| 6 | 0 mm | 3.25 mm |
| 24 | 2.46 mm | 4.08 mm |
| 30 | 1.97 mm | 3.19 mm |
| 36 | 1.66 mm | 2.64 mm |
| 40 | 1.49 mm | 2.38 mm |
| 76 | 1.85 mm | 2.34 mm |
| 81 | 1.73 mm | 2.1 mm |

TABLE 12C
Polycarbonate with no added glass fiber.

| | Thickness range to achieve | |
|---|---|---|
| Frequency, | less than 1 dB | |
| GHz | Min | Max |
| 0.5 | 0 mm | 7.024 mm |
| 6 | 0 mm | 5.86 mm |
| 24 | 2.33 mm | 5.04 mm |
| 30 | 1.90 mm | 3.95 mm |
| 36 | 1.55 mm | 3.37 mm |
| 40 | 1.4 mm | 3.03 mm |
| 76 | 1.94 mm | 2.74 mm |
| 81 | 2.96 mm | 3.65 mm |

### Examples 31A-E. Specimens Including PA66/DI Formulations

Several formulations are prepared that include PA66/DI along with the glass fiber, FR additive, heat stabilizer additive and UV stabilizer in the compositional ranges shown in Table 13.

TABLE 13

| | Range | Example | Example | Example | Example | Example |
|---|---|---|---|---|---|---|
| Component | (wt %) | 31A | 31B | 31C | 31D | 31E |
| PA66/DI [45 RV] | ≥50 to | 58 | 64 | 70 | 74 | 78 |
| | ≤85 | | | | | |
| Glass Fiber [GF] | ≥5 to | 15 | 15 | 10 | 10 | 5 |
| | ≤20 | | | | | |
| Flame Retardant [FR] | Up to | 20 | 20 | 20 | 15 | 15 |
| Additive | 20 | | | | | |
| UV Stabilizer Additive | | 0.2-3 | | | | |
| Heat stabilizer Additive | | 0.2-2 | | | | |
| Colorant/Pigmentation | Up to 5 | 0.2-3 | | | | |
| [added at molding step] | | | | | | |
| TOTAL | | 100 | 100 | 100 | 100 | 100 |

In Table 13 formulations, non-limiting examples of FR additive may include Exolit® OP 1080P, Exolit® OP 1314, Exolit® OP 1400, etc. The Exolit® FR additives are commercially available from Clariant.

In Table 13 formulations, non-limiting examples of UV stabilizer additive may include Carbon Black (19 nm range), organic UV/heat stabilizers such as Irganox® commercial products, phosphite-based commercial additives, hindered amine light [HAL] stabilizers (e.g.: Nylostab® products), UV absorber additives, and combinations thereof.

In Table 13 formulations, non-limiting examples of heat stabilizer and chain extending additives may include copper or organic-based such as Irganox® B1171, Irganox® B1098, Bruggolen™ TP-H1802, Bruggolen™ M1251, and the like. For example, Irganox® B1171 is a commercial polymer additive product of BASF.

The colorant additive may be added at molding step for Table 13 formulations. Non-limiting examples of such colorant additive may include commercial products available in the thermoplastics industry.

The test plaques are prepared using the Table 13 formulations and as described above in the “dielectric constant and dissipation factor determination” section. The dielectric constants and Loss Tangent values are determined according to the test methods described above and in the signal frequency range of 20-40 GHz. Table 14 provides a summary of the dielectric performance data measured for various specimens prepared according to the present disclosure. The term “Loss Tangent” is a measure of how much the wave will decay due to absorption through a medium.

TABLE 14

| At Frequency -> | 20 GHz | 30 GHz | 40 GHz | At Frequency -> | 20 GHz | 30 GHz |
|---|---|---|---|---|---|---|
| Speci- | Dielectric | Loss | Dielectric | Speci- | Dielectric | Loss |
| men | Constant | Tangent | Constant | men | Constant | Tangent |
| PA66 Neat | 3.16 | 0.0182 | 3.17 | PA66 Neat | 3.16 | 0.0182 |
| [unreinforced] | | | | [unreinforced] | | |
| PA66-GF30 | 3.72 | 0.0128 | 3.81 | PA66-GF30 | 3.72 | 0.0128 |
| Polyamide with | | | | Polyamide with | | |
| 30 wt % glass | | | | 30 wt % glass | | |
| fiber | | | | fiber | | |
| PA66-PPE | 2.85 | 0.0076 | 2.88 | PA66-PPE | 2.85 | 0.0076 |
| [unreinforced] | | | | [unreinforced] | | |
| PA66 GF20 | | | 3.35 | PA66 GF20 | | |
| [Polyamide with | | | | [Polyamide with | | |
| 20 wt % glass | | | | 20 wt % glass | | |
| fiber] | | | | fiber] | | |
| PA66 GF20 with | | | 3.31 | PA66 GF20 with | | |
| 20% FR additive, | | | | 20% FR additive, | | |
| 1% UV additive, | | | | 1% UV additive, | | |
| 1% colorant | | | | 1% colorant | | |
| PA66/DI [45 RV] | | | 3.00 | PA66/DI [45 RV] | | |

### Examples 32A-C. FR Performance Testing for PA66 Specimens

In Table 15 below, the flame retardancy [FR] performance data is summarized for several specimens according to the present disclosure. The tested specimens achieve the overall UL-94 test rating of V-0. The similar UL-94 test rating of V-0 is expected for the PA66/DI specimens with 20 wt % GF reinforcement, 20 wt % FR additive and up to 3 wt % each of UV additive and colorant. The FR coatings used in Table 15 are commercially available.

TABLE 15

| | | Nominal | Measured | | UL-94 Rating |
|---|---|---|---|---|---|
| Sample | Specimen | thickness | Average | | [FR |
| ID | Description | (mm) | Thickness (mm) | Conditions | Performance] |
| 32A | PA66-PPE | 1.5 | 2.481 | As received | V-0 |
| | with FR | | 2.485 | 168 hr. @ 70° C. | V-0 |
| | coating | 3.0 | 4.025 | As received | V-0 |
| | [unreinforced] | | 4.065 | 168 hr. @ 70° C. | V-0 |
| 32B | PA66 GF20 | 1.5 | 2.466 | As received | V-0 |
| | with FR | | 2.408 | 168 hr. @ 70° C. | V-0 |
| | coating | 3.0 | 3.912 | As received | V-0 |
| | | | 3.922 | 168 hr. @ 70° C. | V-0 |
| 32C | PA66 GF20 | 1.5 | 1.464 | As received | V-0 |
| | with 20% FR | | 1.443 | 168 hr. @ 70° C. | V-0 |
| | additive, 1% | 3.0 | 2.959 | As received | V-0 |
| | UV additive, | | 2.934 | 168 hr. @ 70° C. | V-0 |
| | 1% colorant | | | | |

There are a variety of tests and standards that may be used to rate the flame retardant nature of a polymeric resin system. Underwriters' Laboratories Test No. UL 94 serves as one Industry Standard test for flame retardant thermoplastic compounds. “UL 94 Standard for Tests for Flammability of Plastic Materials for Parts in Devices and Appliances” gives details of the testing method and criteria for rating. The test method ASTM D635 is Standard Test Method for Rate of Burning or Extent and Time of Burning of Plastics in a Horizontal Position. The test method ASTM D3801 is Standard Test Method for Measuring the Comparative Burning Characteristics of Solid Plastics in a Vertical Position. Vertical burning test ratings (e.g.: V-0, V-1, V-2) are more stringent and difficult to achieve than Horizontal burning ratings (HB-1, HB-2, HB-3).

The Examples surprisingly show that a nylon-6,6 based formula can be developed to meet the mechanical requirements of a mmWave enclosure while transmitting enough mmWave signal to be useful in 5G service. One of the reasons this is surprising is that the nylon-66 absorbs water, which is thought to detrimentally affect transmission. Another unexpected beneficial feature of this formulation that is found is its compatibility with various additives, which is better than other base thermoplastics such as polypropylene and polycarbonate. Thermoplastics are found beneficial for their superior processibility. It is also surprisingly found that the addition of 5, 10, 20, 30 or more weight percent glass fiber (to improve tensile strength and toughness) yields a compounded polyamide with acceptable mmWave transmissibility.

As shown in Example 30a for Nylon-6,6 with no added glass fiber, the Attenuation Coefficient value can range up to 3.9 dB/GHz·cm (for 0.5 GHz wave frequency) or can range between 0.05 and 0.07 dB/GHz·cm (for 81 GHz wave frequency). Example 30b for Nylon-6,6 with 30% by weight glass fiber, the attenuation coefficient value can range up to 5.25 dB/GHz·cm (for 0.5 GHz wave frequency), can range between 0.10 and 0.20 dB/GHz·cm (for 36 GHz wave frequency) or can range between 0.055 and 0.075 dB/GHz·cm (for 81 GHz wave frequency). Similarly, in the case of Example 30c for Polycarbonate with no added glass fiber, the attenuation coefficient value can range up to 3.0 dB/GHz·cm (for 0.5 GHz wave frequency) or can range between 0.03 and 0.045 dB/GHz·cm (for 81 GHz wave frequency).

### Part II.

### Example 33. Panels Including Colorants

Following the injection molding procedure from Part I, panels are injection molded from each of the materials of Table 1 of Part I (A-N in Table 1, including PA66 Neat, PA66-GF30, PA6 Neat, PA66-PPE, PA66-6I/6T, PA66-IM-GF30, and PC). The panels have dimensions of 600 mm×600 mm×2 mm. The panels include no other components other than the materials of Table 1. For each of the materials of Table 1, three different panels are made: one with no colorants added during compounding of the material, one with 1 wt % lead chromate added during compounding, and one with 1 wt % anthraquinone colorant that is free of metals and metal-containing compounds added during compounding.

Following the procedures described herein at Part I, the panels are tested for signal attenuation using radio frequencies at 3 GHz, 28 GHz, 30 GHz, 39 GHz, 40 GHz, 76 GHz, 81 GHz, 24-30 GHz, 3-40 GHz, 24-40 GHz, 36-40 GHz, and 0.5-6 GHz. The panels, the transmitter, and the receiver are arranged such that panels are the only non-radiopaque material between the transmitter and the receiver, and such that the radio waves impinging on the panels are normal to a surface of the panels. The panels that include no colorants and that include the anthraquinone colorant have a signal attenuation between 1 dB and 0 dB at all frequency ranges and specific frequencies tested. The panels formed from polyamide materials, including reinforced polyamide materials, show comparable or superior transmission loss and reflection properties compared to the panel formed from polycarbonate at all frequency ranges and specific frequencies tested. The panels that include lead chromate exhibit greater signal attenuation at all frequency ranges and specific frequencies tested, as compared to the panels that include no colorants and that include the anthraquinone colorant.

### Example 34. Panels Including Inks

Following the injection molding procedure from Part I, panels are injection molded from each of the materials of Table 1 of Part I (A-N in Table 1, including PA66 Neat, PA66-GF30, PA6 Neat, PA66-PPE, PA66-6I/6T, PA66-IM-GF30, and PC). The panels have dimensions of 600 mm×600 mm×2 mm. The panels include no other components other than the materials of Table 1. For each of the materials of Table 1, three different panels are made: one with no ink printed on the panel, one with iron oxide-containing ink printed on the panel such that the panel is 0.1 wt % iron oxide, and one with diketo pyrrolo pyrrole-containing ink printed on the panel such that the panel is 0.1 wt % diketo pyrrolo pyrrole. The panels that include ink are sublimation printed with the ink. The ink is applied as a uniform coating that covers the entire surface of the panel.

Following the procedures described herein at Part I, the panels are tested for signal attenuation using radio frequencies at 3 GHz, 28 GHz, 30 GHz, 39 GHz, 40 GHz, 76 GHz, 81 GHz, 24-30 GHz, 3-40 GHz, 24-40 GHz, 36-40 GHz, and 0.5-6 GHz. The panels, the transmitter, and the receiver are arranged such that panels are the only non-radiopaque material between the transmitter and the receiver, and such that the radio waves impinging on the panels are normal to a surface of the panels. The panels that include no inks and that include the diketo pyrrolo pyrrole ink have a signal attenuation between 1 dB and 0 dB at all frequency ranges and specific frequencies tested. The panels formed from polyamide materials, including reinforced polyamide materials, show comparable or superior transmission loss and reflection properties compared to the panel formed from polycarbonate at all frequency ranges and specific frequencies tested. The panels that include iron oxide exhibit greater signal attenuation at all frequency ranges and specific frequencies tested, as compared to the panels that include no inks and that include the diketo pyrrolo pyrrole ink.

### Example 35. Panels Including Paints

Following the injection molding procedure from Part I, panels are injection molded from each of the materials of Table 1 of Part I (A-N in Table 1, including PA66 Neat, PA66-GF30, PA6 Neat, PA66-PPE, PA66-6I/6T, PA66-IM-GF30, and PC). The panels have dimensions of 600 mm×600 mm×2 mm. The panels include no other components other than the materials of Table 1. For each of the materials of Table 1, three different panels are made: one with no paint on the panel, one with iron oxide-containing paint on the panel such that the panel is 0.1 wt % iron oxide, and one with diketo pyrrolo pyrrole-containing paint on the panel such that the panel is 0.1 wt % diketo pyrrolo pyrrole. The panels that include paint are spray painted with the paint. The paint is applied as a uniform coating that covers the entire surface of the panel.

Following the procedures described herein at Part I, the panels are tested for signal attenuation using radio frequencies at 3 GHz, 28 GHz, 30 GHz, 39 GHz, 40 GHz, 76 GHz, 81 GHz, 24-30 GHz, 3-40 GHz, 24-40 GHz, 36-40 GHz, and 0.5-6 GHz. The panels, the transmitter, and the receiver are arranged such that panels are the only non-radiopaque material between the transmitter and the receiver, and such that the radio waves impinging on the panels are normal to a surface of the panels. The panels that include no paints and that include the diketo pyrrolo pyrrole paint have a signal attenuation between 1 dB and 0 dB at all frequency ranges and specific frequencies tested. The panels formed from polyamide materials, including reinforced polyamide materials, show comparable or superior transmission loss and reflection properties compared to the panel formed from polycarbonate at all frequency ranges and specific frequencies tested. The panels that include iron oxide exhibit greater signal attenuation at all frequency ranges and specific frequencies tested, as compared to the panels that include no paints and that include the diketo pyrrolo pyrrole paint.

### Example 36. Panels Including Colorants and Inks

Following the injection molding procedure from Part I, panels are injection molded from each of the materials of Table 1 of Part I (A-N in Table 1, including PA66 Neat, PA66-GF30, PA6 Neat, PA66-PPE, PA66-6I/6T, PA66-IM-GF30, and PC). The panels have dimensions of 600 mm×600 mm×2 mm. The panels include no other components other than the materials of Table 1. For each of the materials of Table 1, three different panels are made: one with no colorant added to the thermoplastic resin during compounding and with diketo pyrrolo pyrrole-containing ink printed on the panel such that the panel is 0.1 wt % diketo pyrrolo pyrrole colorant, and one with 1 wt % anthraquinone colorant that is free of metals and metal-containing compounds added during compounding and with the same diketo pyrrolo pyrrole-containing ink printed on the panel such that the panel is 0.1 wt % diketo pyrrolo pyrrole colorant. The ink is sublimation printed on the panels. The ink is applied as a uniform coating that covers the entire surface of the panel.

Following the procedures described herein at Part I, the panels are tested for signal attenuation using radio frequencies at 3 GHz, 28 GHz, 30 GHz, 39 GHz, 40 GHz, 76 GHz, 81 GHz, 24-30 GHz, 3-40 GHz, 24-40 GHz, 36-40 GHz, and 0.5-6 GHz. The panels, the transmitter, and the receiver are arranged such that panels are the only non-radiopaque material between the transmitter and the receiver, and such that the radio waves impinging on the panels are normal to a surface of the panels. The inked panels that include the colorant and that are free of the colorant have a signal attenuation between 1 dB and 0 dB at all frequency ranges and specific frequencies tested. The panels formed from polyamide materials, including reinforced polyamide materials, show comparable or superior transmission loss and reflection properties compared to the panel formed from polycarbonate at all frequency ranges and specific frequencies tested. When the inked panels that include no colorant are scratched, the base color of the thermoplastic resin is clearly visible through the scratch. When the inked panels that include colorant are scratched, the base color of the thermoplastic resin is visually unnoticeable or barely visible through the scratch.

### Example 37. Panels Including Colorants and Paints

Following the injection molding procedure from Part I, panels are injection molded from each of the materials of Table 1 of Part I (A-N in Table 1, including PA66 Neat, PA66-GF30, PA6 Neat, PA66-PPE, PA66-6I/6T, PA66-IM-GF30, and PC). The panels have dimensions of 600 mm×600 mm×2 mm. The panels include no other components other than the materials of Table 1. For each of the materials of Table 1, three different panels are made: one with no colorant added to the thermoplastic resin during compounding and with diketo pyrrolo pyrrole-containing paint applied to the panel, and one with 1 wt % anthraquinone colorant that is free of metals and metal-containing compounds added during compounding and with the same diketo pyrrolo pyrrole-containing paint applied to the panel. The paint is sprayed onto the panels as a uniform coating that covers the entire surface of the panel.

Following the procedures described herein at Part I, the panels are tested for signal attenuation using radio frequencies at 3 GHz, 28 GHz, 30 GHz, 39 GHz, 40 GHz, 76 GHz, 81 GHz, 24-30 GHz, 3-40 GHz, 24-40 GHz, 36-40 GHz, and 0.5-6 GHz. The panels, the transmitter, and the receiver are arranged such that panels are the only non-radiopaque material between the transmitter and the receiver, and such that the radio waves impinging on the panels are normal to a surface of the panels. The painted panels that include the colorant and that are free of the colorant have a signal attenuation between 1 dB and 0 dB at all frequency ranges and specific frequencies tested. The panels formed from polyamide materials, including reinforced polyamide materials, show comparable or superior transmission loss and reflection properties compared to the panel formed from polycarbonate at all frequency ranges and specific frequencies tested. When the painted panels that include no colorant are scratched, the base color of the thermoplastic resin is clearly visible through the scratch. When the painted panels that include colorant are scratched, the base color of the thermoplastic resin is visually unnoticeable or barely visible through the scratch.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Listing of Aspects.

The following aspects are provided, the numbering of which is not to be construed as designating levels of importance:

Aspect 1 provides an article for transmitting and/or receiving radio waves therethrough having a frequency in the range of 0.5 GHz to 81 GHz, the article comprising:

a thermoplastic resin comprising
a first polyamide comprising
   nylon-6,
   nylon-6,6,
   a copolymer of nylon-6 or nylon-6,6 comprising at least one repeating unit that is
      poly(hexamethylene terephthalamide),
      poly(hexamethylene isophthalamide), or
      a copolymer of poly(hexamethylene terephthalamide) and poly(hexamethylene isophthalamide),
   a mixture thereof, or
   a copolymer thereof; and
a second polyamide, an additive, or a mixture thereof;

wherein
the article comprises a colorant dispersed in the thermoplastic resin, wherein the colorant is substantially free of metals and metal-containing compounds, or
the article comprises a paint, ink, colored coating, or a combination thereof, on an exterior thereof, wherein the paint, ink, and colored coating are substantially free of metals and metal-containing compounds, or
a combination thereof.

Aspect 2 provides the article of Aspect 1, wherein substantially all of the article is the thermoplastic resin.

Aspect 3 provides the article of any one of Aspects 1-2, wherein 100 wt % of the article is the thermoplastic resin.

Aspect 4 provides the article of any one of Aspects 1-3, wherein 0.001 wt % to 100 wt % of the article is the thermoplastic resin.

Aspect 5 provides the article of any one of Aspects 1-4, wherein 50 wt % to 100 wt % of the article is the thermoplastic resin.

Aspect 6 provides the article of any one of Aspects 1-5, wherein 90 wt % to 100 wt % of the article is the thermoplastic resin.

Aspect 7 provides the article of any one of Aspects 1-6, wherein 0.001 wt % to 49.9 wt % of the article is the thermoplastic resin.

Aspect 8 provides the article of any one of Aspects 1-7, wherein 0.001 wt % to 10 wt % of the article is the thermoplastic resin.

Aspect 9 provides the article of any one of Aspects 1-8, wherein 0 wt % of the article is a material that provides greater attenuation of radio waves in at least one region of the article comprising the material at one or more frequencies in the range of 0.5 GHz to 81 GHz as compared to the same region of the article without the material, or as compared to the same region of the thermoplastic resin without the material; or wherein the concentration of the material in the article is such that attenuation of radio waves by the at least one region of the article comprising the material does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the article without the material, or as compared to the same region of the thermoplastic resin without the material.

Aspect 10 provides the article of any one of Aspects 1-9, wherein 0 wt % of the article is metals or metal-containing compounds.

Aspect 11 provides the article of any one of Aspects 1-10, wherein the article is substantially free of a material that provides greater attenuation of radio waves in at least one region of the article comprising the material at one or more frequencies in the range of 0.5 GHz to 81 GHz as compared to the same region of the article without the material, or as compared to the same region of the thermoplastic resin without the material.

Aspect 12 provides the article of any one of Aspects 1-11, wherein the article is substantially free of metals and metal-containing compounds.

Aspect 13 provides the article of any one of Aspects 1-12, wherein the article comprises one or more portions that comprise the thermoplastic resin and one or more other portions that are substantially free of the thermoplastic resin.

Aspect 14 provides the article of any one of Aspects 1-13, wherein the article is for use with communication devices, electronics, and/or electric power systems.

Aspect 15 provides the article of any one of Aspects 1-14, wherein the article is a power cable termination component, an antenna enclosure, an antenna component, a cell phone casing, a cell phone casing component, an electronic component housing, a power transformer or power conditioner component or enclosure, an optical fiber component, a fiber termination box component or enclosure, a radio enclosure, a radio component, a diplexer/multiplexer component or enclosure, a coaxial cable component, a monocoque, a car unibody, or a combination thereof.

Aspect 16 provides the article of any one of Aspects 1-15, wherein the article is an automotive wall, a building wall, a panel, a wall plate, a structural frame, a radome, a radome cover, an aircraft fuselage or a component thereof, a drone or remote-controlled (RC) aircraft fuselage or a component thereof, a cell phone case or a component thereof, a cell phone protector or a component thereof, an exterior-mounted vehicular decorative or structural component, or a combination thereof.

Aspect 17 provides the article of any one of Aspects 1-16, wherein the article is an enclosure for electronic equipment.

Aspect 18 provides the article of any one of Aspects 1-17, wherein the article is a component of an enclosure for electronic equipment.

Aspect 19 provides the article of any one of Aspects 1-18, wherein the article is a panel or comprises a panel that comprises the thermoplastic resin.

Aspect 20 provides the article of any one of Aspects 1-19, wherein the article comprises the colorant.

Aspect 21 provides the article of any one of Aspects 1-20, wherein the colorant is homogeneously distributed in the thermoplastic resin.

Aspect 22 provides the article of any one of Aspects 1-21, wherein the colorant is 0.001 wt % to 10 wt % of the thermoplastic resin.

Aspect 23 provides the article of any one of Aspects 1-22, wherein the colorant is 0.001 wt % to 5 wt % of the thermoplastic resin.

Aspect 24 provides the article of any one of Aspects 1-23, wherein the colorant is a dye, a pigment, or a combination thereof.

Aspect 25 provides the article of any one of Aspects 1-24, wherein the colorant is substantially free of inorganic compounds.

Aspect 26 provides the article of any one of Aspects 1-25, wherein the colorant comprises an organic colorant, an inorganic colorant, or a colorant that comprises an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

Aspect 27 provides the article of any one of Aspects 1-26, wherein the colorant comprises an organic colorant.

Aspect 28 provides the article of any one of Aspects 1-27, wherein colorants that comprise a metal or metal-containing compound are 0 wt % to 0.001 wt % of the article.

Aspect 29 provides the article of any one of Aspects 1-28, wherein colorants that comprise a metal or metal-containing compound are 0 wt % of the article.

Aspect 30 provides the article of any one of Aspects 1-29, wherein the article is substantially free of colorants that increase attenuation of radio waves transmitted and/or received through the thermoplastic resin and having a frequency in the range of 0.5 GHz to 81 GHz.

Aspect 31 provides the article of any one of Aspects 1-30, wherein colorants that increase attenuation of radio waves having a frequency in the range of 0.5 GHz to 81 GHz transmitted and/or received through the thermoplastic resin are 0 wt % to 0.001 wt % of the article; or wherein the concentration of the colorant in the article is such that attenuation of radio waves by the at least one region of the article comprising the colorant does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the article without the colorant, or as compared to the same region of the thermoplastic resin without the colorant.

Aspect 32 provides the article of any one of Aspects 1-31, wherein colorants that increase attenuation of radio waves having a frequency in the range of 0.5 GHz to 81 GHz transmitted and/or received through the thermoplastic resin are 0 wt % of the article.

Aspect 33 provides the article of any one of Aspects 1-32, wherein the thermoplastic resin is substantially free of colorants that comprise a metal.

Aspect 34 provides the article of any one of Aspects 1-33, wherein the thermoplastic resin is substantially free of colorants that comprise a metal-containing compound.

Aspect 35 provides the article of any one of Aspects 1-34, wherein colorants that comprise a metal or metal-containing compound are 0 wt % to 0.001 wt % of the thermoplastic resin.

Aspect 36 provides the article of any one of Aspects 1-35, wherein colorants that comprise a metal or metal-containing compound are 0 wt % of the thermoplastic resin.

Aspect 37 provides the article of any one of Aspects 1-36, wherein the thermoplastic resin is substantially free of colorants that increase attenuation of radio waves transmitted and/or received through the thermoplastic resin and having a frequency in the range of 0.5 GHz to 81 GHz.

Aspect 38 provides the article of any one of Aspects 1-37, wherein colorants that increase attenuation of radio waves transmitted and/or received through the thermoplastic resin are 0 wt % to 0.001 wt % of the thermoplastic resin; or wherein the concentration of the colorant in the thermoplastic resin is such that attenuation of radio waves by the at least one region of the thermoplastic resin comprising the colorant does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the thermoplastic resin without the colorant.

Aspect 39 provides the article of any one of Aspects 1-38, wherein colorants that increase attenuation of radio waves transmitted and/or received through the thermoplastic resin are 0 wt % of the thermoplastic resin.

Aspect 40 provides the article of any one of Aspects 1-39, wherein the article comprises the ink.

Aspect 41 provides the article of any one of Aspects 1-40, wherein the ink is 0.0001 wt % to 10 wt % of the article.

Aspect 42 provides the article of any one of Aspects 1-41, wherein the ink is 0.0001 wt % to 3 wt % of the article.

Aspect 43 provides the article of any one of Aspects 1-42, wherein the ink comprises an ink colorant comprising a dye, pigment, or a combination thereof, wherein the ink colorant comprises an organic colorant, an inorganic colorant, or a colorant that comprises an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

Aspect 44 provides the article of Aspect 43, wherein the ink colorant is substantially free of metals and metal-containing compounds.

Aspect 45 provides the article of any one of Aspects 1-44, wherein the ink comprises an organic colorant.

Aspect 46 provides the article of any one of Aspects 1-45, wherein the article is substantially free of inks that comprise a metal.

Aspect 47 provides the article of any one of Aspects 1-46, wherein the article is substantially free of inks that comprise a metal-containing compound.

Aspect 48 provides the article of any one of Aspects 1-47, wherein inks that comprise a metal or metal-containing compound of 0 wt % to 0.001 wt % or the article.

Aspect 49 provides the article of any one of Aspects 1-48, wherein inks that comprise a metal or metal-containing compound are 0 wt % of the article.

Aspect 50 provides the article of any one of Aspects 1-49, wherein the article is substantially free of inks that increase attenuation of radio waves having a frequency in the range of 0.5 GHz to 81 GHz transmitted and/or received through the article.

Aspect 51 provides the article of any one of Aspects 1-50, wherein inks that increase attenuation of radio waves having a frequency in the range of 0.5 GHz to 81 GHz transmitted and/or received through the article are 0 wt % to 0.001 wt % of the article; or wherein the amount of the ink on the article is such that attenuation of radio waves by the at least one region of the article comprising the ink does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the article without the ink.

Aspect 52 provides the article of any one of Aspects 1-51, wherein inks that increase attenuation of radio waves having a frequency in the range of 0.5 GHz to 81 GHz transmitted and/or received through the article are 0 wt % of the article.

Aspect 53 provides the article of any one of Aspects 1-52, wherein the article comprises a solid continuous coating of the ink on a surface of the article.

Aspect 54 provides the article of any one of Aspects 1-53, wherein the ink comprises a pattern or image on a surface of the article.

Aspect 55 provides the article of any one of Aspects 1-54, wherein the article comprises a film on the exterior thereof, wherein the ink is between the film and the article.

Aspect 56 provides the article of any one of Aspects 1-55, wherein the ink is applied to the article using a method comprising sublimation printing, inkjet printing, pad printing, screen-printing, or a combination thereof.

Aspect 57 provides the article of any one of Aspects 1-56, wherein the article comprises the paint.

Aspect 58 provides the article of any one of Aspects 1-57, wherein the paint is 0.0001 wt % to 10 wt % of the article.

Aspect 59 provides the article of any one of Aspects 1-58, wherein the paint is 0.0001 wt % to 3 wt % of the article.

Aspect 60 provides the article of any one of Aspects 1-59, wherein the paint is substantially free of inorganic compounds.

Aspect 61 provides the article of any one of Aspects 1-60, wherein the paint comprises an oil-based paint or a water-based paint.

Aspect 62 provides the article of any one of Aspects 1-61, wherein the paint comprises a paint colorant comprising a dye, pigment, or a combination thereof, wherein the paint colorant comprises an organic colorant, an inorganic colorant, or a colorant that comprises an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

Aspect 63 provides the article of Aspect 62, wherein the paint colorant is substantially free of metals and metal-containing compounds.

Aspect 64 provides the article of any one of Aspects 1-63, wherein the paint comprises an organic colorant.

Aspect 65 provides the article of any one of Aspects 1-64, wherein the article is substantially free of paints that comprises a metal.

Aspect 66 provides the article of any one of Aspects 1-65, wherein the article is substantially free of paints that comprise a metal-containing compound.

Aspect 67 provides the article of any one of Aspects 1-66, wherein paints that comprise a metal or metal-containing compound are 0 wt % to 0.001 wt % or the article.

Aspect 68 provides the article of any one of Aspects 1-67, wherein paints that comprise a metal or metal-containing compound are 0 wt % of the article.

Aspect 69 provides the article of any one of Aspects 1-68, wherein the article is substantially free of paints that increase attenuation of radio waves having a frequency in the range of 0.5 GHz to 81 GHz transmitted and/or received through the article.

Aspect 70 provides the article of any one of Aspects 1-69, wherein paints that increase attenuation of radio waves having a frequency in the range of 0.5 GHz to 81 GHz transmitted and/or received through the article are 0 wt % to 0.001 wt % of the article; or wherein the amount of paint on the article is such that attenuation of radio waves by the at least one region of the article comprising the paint does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the article without the paint.

Aspect 71 provides the article of any one of Aspects 1-70, wherein paints that increase attenuation of radio waves having a frequency in the range of 0.5 GHz to 81 GHz transmitted and/or received through the article are 0 wt % of the article.

Aspect 72 provides the article of any one of Aspects 1-71, wherein the paint comprises a solid continuous coating on a surface of the article.

Aspect 73 provides the article of any one of Aspects 1-72, wherein the paint comprises a pattern or image on a surface of the article.

Aspect 74 provides the article of any one of Aspects 1-73, wherein the article comprises the paint, and wherein the article is substantially free of inks.

Aspect 75 provides the article of any one of Aspects 1-74, wherein the article comprises the ink, and wherein the article is substantially free of paints.

Aspect 76 provides the article of any one of Aspects 1-75, wherein the article comprises the colored coating.

Aspect 77 provides the article of any one of Aspects 1-76, wherein the colored coating is 0.0001 wt % to 10 wt % of the article.

Aspect 78 provides the article of any one of Aspects 1-77, wherein the colored coating is 0.0001 wt % to 3 wt % of the article.

Aspect 79 provides the article of any one of Aspects 1-78, wherein the colored coating is substantially free of inorganic compounds.

Aspect 80 provides the article of any one of Aspects 1-79, wherein the colored coating comprises pre-colored flexible film, a printed coating, a non-ink coating, a non-paint coating, a fabric, a polymer encasement (e.g., a polyurethane encasement, such as a rigid or flexible encasement), or a combination thereof.

Aspect 81 provides the article of any one of Aspects 1-80, wherein the colored coating comprises a colored coating colorant comprising a dye, pigment, or a combination thereof, wherein the colored coating colorant comprises an organic colorant, an inorganic colorant, or a colorant that comprises an arylamide, a napthol, a diketo-pyrrolo-pyrrole, an azo, a diazo, a beta-oxynaphthoic acid (BONA), a monoazo beta-oxynaphthoic acid, a quinacridone, an anthraquinone, a phthalocyanine, a perylene, an isoindolinone, a thioindigo, a benzimidazolone, a dioxazine, a fluorescent colorant, a photochromic colorant, a thermochromic colorant, a carbon black, a lampblack, a soot, an acetylene black, a carbonate, calcium carbonate, or a combination thereof.

Aspect 82 provides the article of Aspect 81, wherein the colored coating colorant is substantially free of metals and metal-containing compounds.

Aspect 83 provides the article of any one of Aspects 1-82, wherein the colored coating comprises an organic colorant.

Aspect 84 provides the article of any one of Aspects 1-83, wherein the article is substantially free of colored coatings that comprises a metal.

Aspect 85 provides the article of any one of Aspects 1-84, wherein the article is substantially free of colored coatings that comprise a metal-containing compound.

Aspect 86 provides the article of any one of Aspects 1-85, wherein colored coatings that comprise a metal or metal-containing compound are 0 wt % to 0.001 wt % or the article.

Aspect 87 provides the article of any one of Aspects 1-86, wherein colored coatings that comprise a metal or metal-containing compound are 0 wt % of the article.

Aspect 88 provides the article of any one of Aspects 1-87, wherein the article is substantially free of colored coatings that increase attenuation of radio waves having a frequency in the range of 0.5 GHz to 81 GHz transmitted and/or received through the article.

Aspect 89 provides the article of any one of Aspects 1-88, wherein colored coatings that increase attenuation of radio waves having a frequency in the range of 0.5 GHz to 81 GHz transmitted and/or received through the article are 0 wt % to 0.001 wt % of the article; or wherein the amount of colored coating on the article is such that attenuation of radio waves by the at least one region of the article comprising the colored coating does not increase by more than 0%, 0.001, 0.005, 0.01, 0.05, 0.1, 0.5, 1, 1.5, 2, 3, 4, 5, 6, 8, 10, 12, 14, 16, 18, or by more than 20%, as compared to the same region of the article without the colored coating.

Aspect 90 provides the article of any one of Aspects 1-89, wherein colored coatings that increase attenuation of radio waves having a frequency in the range of 0.5 GHz to 81 GHz transmitted and/or received through the article are 0 wt % of the article.

Aspect 91 provides the article of any one of Aspects 1-90, wherein the colored coating comprises a continuous coating on a surface of the article.

Aspect 92 provides the article of any one of Aspects 1-91, wherein the colored coating comprises a pattern or image on a surface of the article.

Aspect 93 provides the article of any one of Aspects 1-92, wherein the article comprises the colored coating, and wherein the article is substantially free of inks and paints.

Aspect 94 provides the article of any one of Aspects 1-93, wherein the article comprises:

the colorant; and

the ink, the paint, the colored coating, or a combination thereof.

Aspect 95 provides the article of Aspect 94, wherein a visual color of the article including the colorant prior to addition of the ink, paint, or colored coating is close to the visual color of the article including the colorant after the addition of the ink, paint, or colored coating.

Aspect 96 provides the article of any one of Aspects 94-95, wherein the colorant and the ink, paint, or colored coating have the same general class of color, wherein the general class of color comprises red, orange, yellow, green, blue, cyan, indigo, violet, or black.

Aspect 97 provides the article of any one of Aspects 1-96, wherein the article is an enclosure for protecting a radio antenna operating in the 0.5 GHz to 81 GHz frequency range.

Aspect 98 provides the article of Aspect 97, wherein the article fully encloses the radio antenna.

Aspect 99 provides the article of any one of Aspects 1-98, comprising a first plate of a first thickness and a second plate of a second thickness that each comprise the thermoplastic resin.

Aspect 100 provides the article of Aspect 99, wherein the first plate and the second plate differently attenuate electromagnetic signals.

Aspect 101 provides the article of any one of Aspects 1-100, wherein the article has a uniform thickness.

Aspect 102 provides the article of any one of Aspects 1-101, wherein the article is weather-resistant.

Aspect 103 provides the article of any one of Aspects 1-102, wherein the thermoplastic resin comprises

the first polyamide;

the second polyamide; and

the additive.

Aspect 104 provides the article of any one of Aspects 1-103, wherein the first polyamide comprises:

nylon-6 or nylon-6,6; and

a copolymer comprising nylon-6 or nylon-6,6, the copolymer comprising at least one repeating unit that is
poly(hexamethylene terephthalamide),
poly(hexamethylene isophthalamide), or
a copolymer of poly(hexamethylene terephthalamide) and poly(hexamethylene isophthalamide), wherein a molar ratio of the poly(hexamethylene terephthalamide) repeating unit to poly(hexamethylene isophthalamide) repeating unit is in a range of from about 60:40 to about 90:10.

Aspect 105 provides the article of any one of Aspects 1-104, wherein the first polyamide comprises:

nylon-6 or nylon-6,6; and

a copolymer comprising nylon-6 or nylon-6,6 and at least one repeating unit that is
poly(hexamethylene terephthalamide),
poly(hexamethylene isophthalamide), or
a copolymer of poly(hexamethylene terephthalamide) and poly(hexamethylene isophthalamide), wherein a molar ratio of the poly(hexamethylene terephthalamide) repeating unit to poly(hexamethylene isophthalamide) repeating unit is in a range of from about 70:30 to about 75:25.

Aspect 106 provides the article of any one of Aspects 1-105, wherein the first polyamide is at least one of nylon-6 and nylon-6,6.

Aspect 107 provides the article of any one of Aspects 1-106, wherein the thermoplastic resin comprises the additive and the additive is a reinforcing fiber that is up to 50 wt % of the thermoplastic resin.

Aspect 108 provides the article of Aspect 107, wherein the reinforcing fiber comprises glass fibers, silicon fibers, carbon fibers, polypropylene fibers, polyacrylonitrile fibers, basalt fibers, or mixtures thereof.

Aspect 109 provides the article of any one of Aspects 107-108, wherein the reinforcing fiber comprises a glass fiber.

Aspect 110 provides the article of any one of Aspects 1-109, wherein the thermoplastic resin comprises the additive and the additive is chosen from an ultraviolet resistance additive, a flame retardancy additive, an anti-static additive, an impact modifier, a colorant, a moisture repellant, or a combination thereof.

Aspect 111 provides the article of any one of Aspects 1-110, wherein the thermoplastic resin comprises the additive and the additive is in a range of from about 0.1 wt % to about 30 wt % of the thermoplastic resin.

Aspect 112 provides the article of any one of Aspects 1-111, wherein the thermoplastic resin comprises the additive and the additive is in a range of from about 10 wt % to about 30 wt % of the resin, wherein a transmittance loss of the thermoplastic resin is less than 2 decibels (dB) for a signal having a frequency between 500 MHz and 40 GHz.

Aspect 113 provides the article of any one of Aspects 1-112, wherein a transmittance loss of the thermoplastic resin within at least one of a 0.5 GHz to 6 GHz frequency range, a 24 GHz to 30 GHz frequency range, and a 36 GHz to 40 GHz range is less than 1 decibel (dB).

Aspect 114 provides the article of Aspect 113, wherein the transmittance loss of the thermoplastic resin within at least one of a 0.5 GHz to 6 GHz frequency range, a 24 GHz to 30 GHz frequency range, and a 36 GHz to 40 GHz range is less than 0.5 decibels (dB).

Aspect 115 provides the article of any one of Aspects 1-114, wherein a relative weight gain of the article due to moisture uptake is less than 4% upon equilibration in an atmosphere at 70° C. and 62% relative humidity.

Aspect 116 provides the article of any one of Aspects 1-115, wherein the thermoplastic resin comprises reinforcing glass fiber in up to 50 wt % level of the total composition mass; wherein the thermoplastic resin has:

a tensile strength in a range of from about 40 MPa to about 300 MPa;

a density in a range of from 0.7 g/cm³ to 5 g/cm³;

an impact resistance in a range of from 40 kJ/m² to 150 kJ/m²; and

a signal attenuation of at least one of the following, when a direction of a signal impinging on the thermoplastic resin is normal to a surface of the thermoplastic resin, and wherein a thickness of the thermoplastic resin is substantially uniform across an area where the signal impinges on the article:
from 1 dB to 0 dB for signal of frequency 500 MHz to 6 GHz when the thermoplastic resin thickness is from 0.5 mm to 6 mm;
from 1 dB to 0 dB for signal of frequency 24 GHz to 30 GHz when the thermoplastic resin thickness is from 0.5 mm to 4.5 mm;
from 1 dB to 0 dB for signal of frequency 36 GHz to 40 GHz when the thermoplastic resin thickness is from 0.5 mm to 4 mm; and
from 1 dB to 0 dB for signal of frequency 76 GHz to 81 GHz when the thermoplastic resin thickness is from 0.5 mm to 3.5 mm.

Aspect 117 provides the article of any one of Aspects 1-116, wherein a density of the thermoplastic resin is in a range selected from:

greater than or equal to 0.7 g/cm³ to less than or equal to 5 g/cm³;

greater than or equal to 0.8 g/cm³ to less than or equal to 4 g/cm³; and

greater than or equal to 0.85 to less than or greater than 3 g/cm³.

Aspect 118 provides the article of any one of Aspects 1-117, wherein glass fibers are 10 to 50 wt % of the thermoplastic resin.

Aspect 119 provides the article of any one of Aspects 1-118, wherein glass fibers are 12 to 50 wt % of the thermoplastic resin.

Aspect 120 provides the article of any one of Aspects 1-119, wherein glass fibers are 14 to 40 wt % of the thermoplastic resin.

Aspect 121 provides the article of Aspect 120, wherein the thermoplastic resin has a tensile strength in a range of 40 to 300 MPa.

Aspect 122 provides the article of any one of Aspects 1-121, having a substantially uniform signal attenuation of:

from 1 dB to 0 dB for signal of frequency 500 MHz to 6 GHz when a thickness of the thermoplastic resin is from 1.5 mm to 4 mm;

from 1 dB to 0 dB for signal of frequency 24 GHz to 30 GHz when the thermoplastic resin thickness is from 2.5 mm to 4 mm;

from 1 dB to 0 dB for signal of frequency 36 GHz to 40 GHz when the thermoplastic resin thickness is from 1.75 mm to 2.75 mm; or from 1 dB to 0 dB for signal of frequency 76 GHz to 81 GHz when the thermoplastic resin thickness is from 1.75 mm to 2.75 mm.

Aspect 123 provides the article of any one of Aspects 1-122, wherein the thermoplastic resin comprises up to 20% of a flame-retardancy additive.

Aspect 124 provides the article of any one of Aspects 1-123, wherein the article comprises a flame-retardancy coating.

Aspect 125 provides the article of any one of Aspects 1-124, wherein the article and/or thermoplastic resin has a UL-94 test rating of V-0.

Aspect 126 provides the article of any one of Aspects 1-125, wherein the thermoplastic resin comprises PA66:DI (85:15 to 96:4 wt:wt), glass fiber in a range of about 5 to about 20 wt %, a flame-retardant additive in a range of up to about 20 wt %, a UV additive in a range of up to about 3 wt %, a heat stabilizer additive in a range of up to about 2 wt %, and a colorant additive in a range of up to about 3 wt %.

Aspect 127 provides the article of any one of Aspects 1-126, wherein the article is formed by one of injection molding, thermoforming, compression molding, or extrusion.

Aspect 128 provides the article of any one of Aspects 1-127, wherein the article is free of portions and windows for transmission of an electromagnetic signal having a frequency range of 0.5 GHz to 81 GHz and that are free of the thermoplastic resin.

Aspect 129 provides an article for transmitting and/or receiving radio waves therethrough having a frequency in the range of 0.5 GHz to 81 GHz, the article comprising:

a thermoplastic resin comprising
a first polyamide comprising
   nylon-6,
   nylon-6,6,
   a copolymer of nylon-6 or nylon-6,6 comprising at least one repeating unit that is
      poly(hexamethylene terephthalamide),
      poly(hexamethylene isophthalamide), or
      a copolymer of poly(hexamethylene terephthalamide) and poly(hexamethylene isophthalamide),
   a mixture thereof, or
   a copolymer thereof; and
a second polyamide, an additive, or a mixture thereof;

wherein the article comprises a colorant dispersed in the thermoplastic resin, wherein metals and metal-containing compounds are 0 wt % to 0.001 wt % of the colorant.

Aspect 130 provides an article for transmitting and/or receiving radio waves therethrough having a frequency in the range of 0.5 GHz to 81 GHz, the article comprising:

a thermoplastic resin comprising
a first polyamide comprising
   nylon-6,
   nylon-6,6,
   a copolymer of nylon-6 or nylon-6,6 comprising at least one repeating unit that is
      poly(hexamethylene terephthalamide),
      poly(hexamethylene isophthalamide), or
      a copolymer of poly(hexamethylene terephthalamide) and poly(hexamethylene isophthalamide),
   a mixture thereof, or
   a copolymer thereof; and
a second polyamide, an additive, or a mixture thereof;

wherein the article comprises a paint, ink, a colored coating, or a combination thereof, on an exterior thereof, wherein metals and metal-containing compounds are 0 wt % to 0.001 wt % of the paint, ink, or colored coating.

Aspect 131 provides the article of Aspect 130, wherein the article comprises the ink, wherein the ink is sublimation-printed ink.

Aspect 132 provides an article for transmitting and/or receiving radio waves therethrough having a frequency in the range of 0.5 GHz to 81 GHz, the article comprising:

a thermoplastic resin comprising
a first polyamide comprising
   nylon-6,
   nylon-6,6,
   a copolymer of nylon-6 or nylon-6,6 comprising at least one repeating unit that is
      poly(hexamethylene terephthalamide),
      poly(hexamethylene isophthalamide), or
      a copolymer of poly(hexamethylene terephthalamide) and poly(hexamethylene isophthalamide),
   a mixture thereof, or
   a copolymer thereof; and
a second polyamide, an additive, or a mixture thereof;

wherein
the article comprises a colorant dispersed in the thermoplastic resin, wherein the colorant is substantially free of metals and metal-containing compounds,
the article comprises a paint, ink, a colored coating, or a combination thereof, on an exterior thereof, wherein the paint, ink, and colored coating are substantially free of metals and metal-containing compounds, and
the colorant and the ink, paint, and colored coating have the same general class of color, wherein the general class of color comprises red, orange, yellow, green, blue, cyan, indigo, violet, or black.

Aspect 133 provides a system comprising:

the article of any one of Aspects 1-132; and

an antenna for transmitting and/or receiving radio waves having a frequency in the range of 0.5 GHz to 81 GHz.

Aspect 134 provides a method of making the article of any one of Aspects 1-132, the method comprising:

injection molding, thermoforming, compression molding, or extruding the thermoplastic resin to form the article or one or more components thereof.

Aspect 135 provides the method of Aspect 134, further comprising compounding the thermoplastic resin and the colorant together prior to the injection molding, thermoforming, compression molding, or extruding of the thermoplastic resin to form the article or one or more components thereof.

Aspect 136 provides the method of any one of Aspects 134-135, the method comprising:

applying the ink onto, and/or applying the paint onto, and/or applying the colored coating onto, the injection molded, thermoformed, compression molded, or extruded thermoplastic resin, to form the article of any one of Aspects 1-114 or a component thereof.

Aspect 137 provides the method of Aspect 136, wherein applying the ink comprises sublimation printing, inkjet printing, pad printing, screen-printing, or a combination thereof.

Aspect 138 provides the method of any one of Aspects 136-137, wherein applying the ink comprises ink sublimation.

Aspect 139 provides the method of any one of Aspects 136-138, wherein the applying the ink comprises printing the ink on a film and applying the film to the exterior of the article.

Aspect 140 provides a method comprising:

transmitting and/or receiving radio waves having a frequency in the range of 0.5 GHz to 81 GHz through the article of any one of Aspects 1-132.

What is claimed is:

1. An article for transmitting and/or receiving radio waves therethrough having a frequency in the range of 0.5 GHz to 81 GHz, the article comprising:
a thermoplastic resin comprising
a first polyamide comprising
nylon-6,
nylon-6,6,
a copolymer of nylon-6 or nylon-6,6 comprising at least one repeating unit that is
poly(hexamethylene terephthalamide),
poly(hexamethylene isophthalamide), or
a copolymer of poly(hexamethylene terephthalamide) and poly(hexamethylene isophthalamide),
a mixture thereof, or
a copolymer thereof; and
a second polyamide, an additive, or a mixture thereof,
wherein
the article comprises a colorant dispersed in the thermoplastic resin, wherein metals and metal-containing compounds are 0 wt % to 0.001 wt % of the thermoplastic resin, or
the article comprises a paint, ink, colored coating, or a combination thereof, on an exterior thereof, wherein metals and metal-containing compounds are 0 wt % to 0.001 wt % of the paint, ink, and the colored coating, or
a combination thereof.

2. The article of claim 1, wherein metals and metal-containing compounds are 0 wt % to 0.001 wt % of the thermoplastic resin.

3. The article of claim 1, wherein the article comprises a panel that comprises the thermoplastic resin, and/or wherein the article is a panel, an enclosure for electronic equipment, a component of an enclosure for electronic equipment, a power cable termination component, an antenna enclosure, an antenna component, a cell phone casing, a cell phone casing component, an electronic component housing, a power transformer or power conditioner component or enclosure, an optical fiber component, a fiber termination box component or enclosure, a radio enclosure, a radio component, a diplexer/multiplexer component or enclosure, a coaxial cable component, a monocoque, a car unibody, an automotive wall, a building wall, a panel, a wall plate, a structural frame, a radome, a radome cover, an aircraft fuselage or a component thereof, a drone or remote-controlled (RC) aircraft fuselage or a component thereof, a cell phone case or a component thereof, a cell phone protector or a component thereof, an exterior-mounted vehicular decorative or structural component, or a combination thereof.

4. The article of claim 1, wherein the colorant, an ink colorant in the ink, and/or a paint colorant in the paint, and/or a colored coating colorant in the colored coating, comprises an organic colorant.

5. The article of claim 1, wherein colorants that increase attenuation of radio waves having a frequency in the range of 0.5 GHz to 81 GHz transmitted and/or received through the thermoplastic resin are 0 wt % to 0.001 wt % of the thermoplastic resin.

6. The article of claim 1, wherein the article comprises the colorant, wherein the colorant is 0.001 wt % to 10 wt % of the thermoplastic resin.

7. The article of claim 1, wherein the article comprises the ink, the paint, or a combination thereof, wherein the ink and paint are independently 0.0001 wt % to 10 wt % of the article.

8. The article of claim 1, wherein the article comprises the colored coating, wherein the colored coating is 0.0001 wt % to 10 wt % of the article.

9. The article of claim 1, wherein the article comprises:
the colorant; and
the ink, the paint, the colored coating, or a combination thereof.

10. The article of claim 9, wherein
a visual color of the article including the colorant prior to addition of the ink or paint is close to the visual color of the article including the colorant after the addition of the ink, paint, or colored coating, or
the colorant and the ink, paint, or colored coating have the same general class of color, wherein the general class of color comprises red, orange, yellow, green, blue, cyan, indigo, violet, or black, or
a combination thereof.

11. The article of claim 1, wherein the first polyamide comprises:
nylon-6 or nylon-6,6; and
a copolymer comprising nylon-6 or nylon-6,6, the copolymer comprising at least one repeating unit that is
poly(hexamethylene terephthalamide),
poly(hexamethylene isophthalamide), or
a copolymer of poly(hexamethylene terephthalamide) and poly(hexamethylene isophthalamide), wherein a molar ratio of the poly(hexamethylene terephthalamide) repeating unit to poly(hexamethylene isophthalamide) repeating unit is in a range of from about 60:40 to about 90:10.

12. The article of claim 1, wherein the first polyamide is at least one of nylon-6 and nylon-6,6.

13. The article of claim 1, wherein glass fibers are 10 to 50 wt % of the thermoplastic resin.

14. The article of claim 1, wherein a signal attenuation of the thermoplastic resin within at least one of a 0.5 GHz to 6 GHz frequency range, a 24 GHz to 30 GHz frequency range, a 36 GHz to 40 GHz frequency range, and a 76 GHz to 81 GHz frequency range, when a direction of a signal impinging on the article is normal to a surface of the article, and wherein an article thickness is substantially uniform across an area where the signal impinges on the article, is less than 1 decibel (dB).

15. The article of claim 1, wherein the thermoplastic resin has a tensile strength in a range of from 40 to 300 MPa and an impact resistance in a range of from 40 kJ/m² to 150 kJ/m².

16. An article for transmitting and/or receiving radio waves therethrough having a frequency in the range of 0.5 GHz to 81 GHz, the article comprising:
a thermoplastic resin comprising
a first polyamide comprising
nylon-6,
nylon-6,6,
a copolymer of nylon-6 or nylon-6,6 comprising at least one repeating unit that is
poly(hexamethylene terephthalamide),
poly(hexamethylene isophthalamide), or
a copolymer of poly(hexamethylene terephthalamide) and poly(hexamethylene isophthalamide),
a mixture thereof, or
a copolymer thereof; and
a second polyamide, an additive, or a mixture thereof;
wherein
the article comprises a colorant dispersed in the thermoplastic resin, wherein metals and metal-containing compounds are 0 wt % to 0.001 wt % of the colorant, or
the article comprises a paint, ink, colored coating, or a combination thereof, on an exterior thereof, wherein metals and metal-containing compounds are 0 wt % to 0.001 wt % of the paint, ink, and colored coating.

17. An article for transmitting and/or receiving radio waves therethrough having a frequency in the range of 0.5 GHz to 81 GHz, the article comprising:
a thermoplastic resin comprising
a first polyamide comprising
nylon-6,
nylon-6,6,
a copolymer of nylon-6 or nylon-6,6 comprising at least one repeating unit that is
poly(hexamethylene terephthalamide),
poly(hexamethylene isophthalamide), or
a copolymer of poly(hexamethylene terephthalamide) and poly(hexamethylene isophthalamide),
a mixture thereof, or
a copolymer thereof; and
a second polyamide, an additive, or a mixture thereof,
wherein
the article comprises a colorant dispersed in the thermoplastic resin, wherein the colorant is substantially free of metals and metal-containing compounds,
the article comprises a paint, ink, colored coating, or a combination thereof, on an exterior thereof, wherein the paint, ink, and colored coating are substantially free of metals and metal-containing compounds, and
the colorant and the ink, paint, or colored coating have the same general class of color, wherein the general class of color comprises red, orange, yellow, green, blue, cyan, indigo, violet, or black.

18. A system comprising:
the article of claim 1; and
an antenna for transmitting and/or receiving radio waves having a frequency in the range of 0.5 GHz to 81 GHz.

19. A method of making the article of claim 1, the method comprising:
injection molding, thermoforming, compression molding, or extruding the thermoplastic resin to form the article or one or more components thereof.

20. A method comprising:
transmitting and/or receiving radio waves having a frequency in the range of 0.5 GHz to 81 GHz through the article of claim 1.
